(19) United States
(12) Patent Application Publication
(10) Pub. No.: US 2020/0089221 A1
(43) Pub. Date: Mar. 19, 2020

(54) INTEGRATED METHOD AND SYSTEM FOR CENTRALIZED REMOTE FLEET MANAGEMENT TO ASSIGN VEHICLES, CHARGERS, SENSORS, PILOTS AND VISUAL OBSERVERS TO A FLEET AND OPERATE IN CONCERT WITH EACH OTHER TO COMPLETE A COMMON MISSION

(71) Applicant: Aeronyde Corporation, Melborne, FL (US)

(72) Inventors: Alexander Bilous, Citrus Springs, FL (US); Donald Bittar, Palm Bay, FL (US); Daeheum Chung, Lake Mary, FL (US); Edgar Munoz, Orlando, FL (US); Trevor Ragno, Longwood, FL (US); Guy Newman, St. Petersburg, FL (US)

(21) Appl. No.: 16/578,874

(22) Filed: Sep. 23, 2019

Related U.S. Application Data
(60) Provisional application No. 62/702,179, filed on Jul. 23, 2018.
(60) Provisional application No. 62/702,542, filed on Jul. 24, 2018.
(60) Provisional application No. 62/702,592, filed on Jul. 24, 2018.
(60) Provisional application No. 62/711,844, filed on Jul. 30, 2018.
(60) Provisional application No. 62/712,328, filed on Jul. 31, 2018.
(60) Provisional application No. 62/713,676, filed on Aug. 2, 2018.
(60) Provisional application No. 62/713,682, filed on Aug. 2, 2018.
(60) Provisional application No. 62/713,723, filed on Aug. 2, 2018.
(60) Provisional application No. 62/714,302, filed on Aug. 3, 2018.
(60) Provisional application No. 62/714,835, filed on Aug. 6, 2018.
(60) Provisional application No. 62/702,542, filed on Jul. 24, 2018.
(60) Provisional application No. 62/713,687, filed on Aug. 2, 2018.
(60) Provisional application No. 62/713,682, filed on Aug. 2, 2018.
(60) Provisional application No. 62/712,328, filed on Jul. 31, 2018.
(60) Provisional application No. 62/714,302, filed on Aug. 3, 2018.
(60) Provisional application No. 62/702,552.
(60) Provisional application No. 62/702,576, filed on Jul. 24, 2018.
(60) Provisional application No. 62/713,649, filed on Aug. 2, 2018.
(60) Provisional application No. 62/713,656, filed on Aug. 2, 2018.
(60) Provisional application No. 62/713,733, filed on Aug. 2, 2018.
(60) Provisional application No. 62/714,348, filed on Aug. 3, 2018.
(60) Provisional application No. 62/702,564, filed on Jul. 24, 2018.
(60) Provisional application No. 62/711,780, filed on Jul. 30, 2018.
(60) Provisional application No. 62/713,645, filed on Aug. 2, 2018.
(60) Provisional application No. 62/712,297, filed on Jul. 31, 2018.
(60) Provisional application No. 62/711,789, filed on Jul. 30, 2018.
(60) Provisional application No. 62/712,340, filed on Jul. 31, 2018.
(60) Provisional application No. 62/713,662, filed on Aug. 2, 2018.
(60) Provisional application No. 62/711,815, filed on Jul. 30, 2018.
(60) Provisional application No. 62/713,700, filed on Aug. 2, 2018.
(60) Provisional application No. 62/701,790, filed on Jul. 22, 2018.
(60) Provisional application No. 62/714,316, filed on Aug. 3, 2018.
(60) Provisional application No. 62/714,322, filed on Aug. 3, 2018.
(60) Provisional application No. 62/714,364, filed on Aug. 3, 2018.
(60) Provisional application No. 62/714,370, filed on Aug. 3, 2018.
(60) Provisional application No. 62/702,568, filed on Jul. 24, 2018.
(60) Provisional application No. 62/701,788, filed on Jul. 22, 2018.
(60) Provisional application No. 62/713,607, filed on Aug. 2, 2018.
(60) Provisional application No. 62/714,335, filed on Aug. 3, 2018.
(60) Provisional application No. 62/714,355, filed on Aug. 3, 2018.
(60) Provisional application No. 62/711,770, filed on Jul. 30, 2018.
(60) Provisional application No. 62/712,358, filed on Jul. 31, 2018.
(60) Provisional application No. 62/712,453, filed on Jul. 31, 2018.
(60) Provisional application No. 62/702,160, filed on Jul. 23, 2018.
(60) Provisional application No. 62/712,294, filed on Jul. 31, 2018.
(60) Provisional application No. 62/712,472, filed on Jul. 31, 2018.
(60) Provisional application No. 62/702,522, filed on Jul. 24, 2018.
(60) Provisional application No. 62/715,984, filed on Aug. 8, 2018.
(60) Provisional application No. 62/713,763, filed on Aug. 2, 2018.
(60) Provisional application No. 62/711,818, filed on Jul. 30, 2018.
(60) Provisional application No. 62/713,714, filed on Aug. 2, 2018.
(60) Provisional application No. 62/714,355, filed on Aug. 3, 2018.
(60) Provisional application No. 62/712,301, filed on Jul. 31, 2018.
(60) Provisional application No. 62/712,433, filed on Jul. 31, 2018.
(60) Provisional application No. 62/713,739, filed on Aug. 2, 2018.
(60) Provisional application No. 62/715,969, filed on Aug. 8, 2018.
(60) Provisional application No. 62/712,346, filed on Jul. 31, 2018.
(60) Provisional application No. 62/701,782, filed on Jul. 22, 2018.
(60) Provisional application No. 62/700,361, filed on Jul. 19, 2018.
(60) Provisional application No. 62/714,400, filed on Aug. 3, 2018.
(60) Provisional application No. 62/712,334, filed on Jul. 31, 2018.
(60) Provisional application No. 62/702,600, filed on Jul. 24, 2018.
(60) Provisional application No. 62/701,974, filed on Jul. 23, 2018.
(60) Provisional application No. 62/714,833, filed on Aug. 6, 2018.
(60) Provisional application No. 62/702,065, filed on Jul. 23, 2018.
(60) Provisional application No. 62/714,381, filed on Aug. 3, 2018.

(51) Int. Cl. G05D 1/00; G08G 5/00; B64C 39/02

(52) U.S. Cl. CPC G05D 1/0027; G08G 5/003; G05D 1/0033; B64C 2201/12; G05D 1/0088; B64C 39/024; G08G 5/0021

(57) ABSTRACT

An integrated method and system for centralized remote Fleet management to assign Vehicles, Chargers, Sensors, Pilots and Visual Observers to a Fleet and operate in concert with each other to complete a common Mission Set.

### REFERENCES CITED, U.S. PATENT DOCUMENTS

This application claims priority from U.S. provisional applications No. 62/701,974 filed Jul. 23, 2018, No. 62/702,023 filed Jul. 23, 2018, No. 62/702,044 filed Jul. 23, 2018, No. 62/702,065 filed Jul. 23, 2018, No. 62/702,075 filed Jul. 23, 2018, No. 62/702,160 filed Jul. 23, 2018, No. 62/702,179 filed Jul. 23, 2018, No. 62/701,619 filed Jul. 24, 2018, No. 62/702,522 filed Jul. 24, 2018, No. 62/702,552 filed Jul. 24, 2018, No. 62/702,564 filed Jul. 24, 2018, No. 62/702,568 filed Jul. 24, 2018, No. 62/702,576 filed Jul. 24, 2018, No. 62/702,583 filed Jul. 24, 2018, No. 62/702,592 filed Jul. 24, 2018, No. 62/702,600 filed 07/24/2018, No. 62/700,361 filed Jul. 19, 2018, No. 62/712,263 filed Jul. 31, 2018, No. 62/711,764 filed Jul. 30, 2018, No. 62/711,780 filed Jul. 30, 2018, No. 62/713,638 filed Jul. 21, 2018, No. 62/713,645 filed Aug. 2, 2018, No. 62/713,649 filed Aug. 2, 2018, No. 62/713,656 filed Aug. 2, 2018, No. 62/712,297 filed Jul. 31, 2018, No. 62/712,301 filed Jul. 31, 2018, No. 62/712,314 filed Jul. 31, 2018, No. 62/711,828 filed Jul. 30, 2018, No. 62/711,789 filed Jul. 30, 2018, No. 62/711,798 filed Jul. 31, 2018, No. 62/712,346 filed Jul. 31, 2018, No. 62/712,352 filed Aug. 6, 2018, No. 62/712,358 filed Jul. 31, 2018, No. 62/712,433 filed Jul. 31, 2018, No. 62/712,443 filed Jul. 31, 2018, No. 62/712,453 filed Jul. 31, 2018, No. 62/712,460 filed Jul. 31, 2018, No. 62/712,472 filed Jul. 31, 2018, No. 62/711,807 filed Jul. 30, 2018, No. 62/713,607 filed Aug. 2, 2018, No. 62/713,662 filed Aug. 2, 2018, No. 62/713,676 filed Aug. 2, 2018, No. 62/713,682 filed Aug. 2, 2018, No. 62/711,815 filed Jul. 30, 2018, No. 62/713,687 filed Aug. 2, 2018, No. 62/713,700 filed Aug. 2, 2018, No. 62/713,705 filed Aug. 2, 2018, No. 62/713,714 filed Aug. 2, 2018, No. 62/713,723 filed Aug. 2, 2018, No. 62/713,733 filed Aug. 2, 2018, No. 62/713,739 filed Aug. 2, 2018, No. 62/711,836 filed Jul. 30, 2018, No. 62/713,750 filed Aug. 6, 2018, No. 62/713,763 filed Aug. 2, 2018, No. 62/714,316 filed Aug. 3, 2018, No. 62/714,335 filed Aug. 3, 2018, No. 62/714,381 filed Aug. 3, 2018, No. 62/714,400 filed Aug. 3, 2018, No. 62/714,830 filed Aug. 6, 2018, No. 62/714,833 filed Aug. 6, 2018, No. 62/701,782 filed Jul. 22, 2018, No. 62/715,317 filed Aug. 6, 2018, No. 62/715,969 filed Aug. 8, 2018, No. 62/714,322 filed Aug. 3, 2018, No. 62/714,348 filed Aug. 3, 2018, No. 62/714,355 filed Aug. 3, 2018, No. 62/714,364 filed Aug. 3, 2018 which are incorporated herein by reference in its entirety.

### BACKGROUND OF THE RELATED ART

One problem in using remotely operated unmanned Vehicles together as a Fleet is that no Integrated methods and systems existed, until Aeronyde Corporation was founded, for operating a plurality or multiple of said Vehicles from a centralized Fleet command center (herein referred to as a “Fleet Management Center”) located anywhere in the world and beyond a visual line of sight.

A Fleet of Unmanned Vehicles operating in concert with each other, has many commercial applications. Some of the applications include surveillance, imaging, video recording, and environmental data collection. A major use for a Fleet of centrally remotely controlled and monitored Vehicles is the inspection of outdoor infrastructure, structures, equipment, facilities, agricultural crops, and other assets. Another major use for a Fleet of centrally remotely controlled and monitored Vehicles is improving the delivery of emergency public services.

A Fleet of Unmanned Vehicles offers a more effective and timely method than manual inspections for inspecting outdoor infrastructure, structures, equipment, facilities, agricultural crops, and other assets. Human inspection of large, outdoor assets is far more time consuming than unmanned aerial system surveillance. Additionally, the quantity, quality, and variety of data that can be captured with each human inspection is generally less comprehensive than inspections by a Fleet of Unmanned Vehicles. Furthermore, the large, outdoor assets are often in remote, hazardous, or relatively inaccessible locations, environments in which an aerial Vehicle is more appropriate. In addition to agriculture, there are valuable, efficient, and cost-effective applications of unmanned Vehicles in the fields of power and telecommunications, fossil fuel exploration and production, transportation infrastructure (including railroads, commuter trainlines, waterways, dams, highways, bridges, construction), public safety, and natural disaster response.

Using a single pilot to operate and control an individual unmanned Vehicle is costly, slow, and causes potential operational and safety hazards for pilots, users, and the public welfare. This method of Vehicle control is difficult to scale operationally due to its high operating cost and issues with standardization. The standardization of operating practices and procedures with this method is also difficult to manage and insure, which creates a variance in the quality of data collection between pilots; the incertitude of this data quality creates risk to users and, by extension, public welfare.

### BRIEF DESCRIPTION OF THE DRAWINGS

The present invention can be more easily understood and the advantages and uses thereof more readily apparent when the detailed description of the present invention is read in conjunction with the figures wherein:

FIG. 1 illustrates an exemplary fleet management control center process of creating a fleet consisting of a plurality of unmanned vehicles and the related processes of assigning a fleet identification number to a customer and assigning the customer's identification number (‘Enterprise’) to a Fleet; the related process of assigning a plurality of unmanned vehicles to a fleet (‘Fleet’); the related process of assigning a repair depot identification number to a Fleet; the process of assigning a plurality of licensed FAA part 107 Pilots to a Fleet; and the process of assigning a plurality of certified FAA visual observers to a Fleet; and the process of assigning a plurality of unmanned vehicle power charging stations and systems (‘Charger’) to a Fleet of the present invention.

FIG. 2 illustrates an exemplary Fleet management control center process of assigning a mission set to a Fleet consisting of a plurality of unmanned vehicles and the related processes of assigning the Fleet to the highest priority mission set of a plurality of mission sets related to an enterprise identification; the related process of assigning a plurality of chargers to a mission set assigned to the Fleet; the related process of assigning a plurality of unmanned vehicles to the mission set assigned to the Fleet; the related process of assigning a plurality of licensed FAA Part 107 Pilots to the mission set assigned to the Fleet; and the related process of assigning a plurality of certified FAA Visual Observers to the mission set assigned to the Fleet of the present invention.

FIG. 3 illustrates an exemplary Fleet management control center process confirming a Fleet, consisting of a plurality of unmanned vehicles and the related processes of confirming the Fleet is ready to execute a mission set related to a Fleet identification number and the related process of confirming a plurality of FAA LAANC flight plans have been approved, by the FAA, for the plurality of unmanned vehicles assigned to the Fleet and ready to execute the mission set assigned to the Fleet; the related process of confirming that a plurality of FAA Flight Plan Waivers (‘Waivers’) for a flight plan have been approved, by the FAA, for the plurality of unmanned vehicles assigned to the Fleet to execute the mission set assigned to the Fleet; the related process of confirming a plurality of the unmanned vehicles assigned to the Fleet are ready to execute the mission set assigned to the Fleet; the related process of confirming a plurality of licensed FAA Part 107 pilots assigned to the Fleet are ready to execute the mission set assigned to the Fleet; the related process of confirming a plurality of certified FAA Visual Observers assigned to the Fleet are ready to execute the mission set assigned to the Fleet; and the related process of confirming a plurality of chargers assigned to the Fleet are ready to execute the mission set assigned to the Fleet.

FIG. 4 illustrates an exemplary Fleet management control center process confirming a Fleet, consisting of a plurality of unmanned vehicles and the related processes of confirming the Enterprise has approved the execution of the mission set assigned to the Fleet assigned to the Enterprise; the related process of confirming the completion of the Mission Checklist for the mission set assigned to the Fleet; the related process of confirming an Enterprise has approved the execution of the mission set assigned to the Fleet assigned to the Enterprise; and the related process of confirming an Enterprise has approved the execution of the reconfigured mission set assigned to the Fleet assigned to the Enterprise of the present invention.

FIG. 5A and FIG. 5B illustrate an exemplary Fleet management center radio frequency signal transmission system and related the processes to interface with the Fleet management center control system of the present invention, converting digital data into analog radio signals, using new communication methods and transmitting analog radio signals.

FIG. 6 illustrates an exemplary Fleet management center radio frequency signal receiving system and related processes to receive analog radio signals, convert the analog radio signals into digital data, using new communication methods and interfacing with the Fleet management center control system of the present invention.

FIGS. 7.1-7.72 illustrate exemplary Snaps as communication methods used in the present invention to connect Vehicles, Chargers, Vehicle Components, Company Personnel and Enterprises to each other with data.

FIG. 7.1 illustrates an onboard Snap for communicating between an accessory device and the Vehicle CPU using the Universal Device Coupler and the Vehicle to CPU interface. Also included in Vehicle Operating System. Includes Start of Message communication method. Includes End of Message communication method.

FIG. 7.2 illustrates a Communications Method between any device or entity in a network and any other device or entity in a network using a single or multiple packets comprising a message. Also included in Vehicle Operating System. Includes Start of Message communication method. Includes End of Message communication method.

FIG. 7.3 illustrates a Snap for communicating between the vehicle and the electrical charger for connecting and disconnecting the charger and the vehicle. Also included in Vehicle Operating System. Includes Start of Message communication method. Includes End of Message communication method.

FIG. 7.4 illustrates a start of Message Communication Method Also included in Vehicle Operating System. Includes Start of Message communication method. Includes End of Message communication method.

FIG. 7.5 illustrates a Snap for remoting connecting and disconnecting the electrical connection between the vehicle and the recharging station. Also included in Vehicle Operating System. Includes Start of Message communication method. Includes End of Message communication method.

FIG. 7.6 illustrates a Snap for transmitting sensor data. Also included in Vehicle Operating System. Includes Start of Message communication method. Includes End of Message communication method.

FIG. 7.7 illustrates and of Message Communication Method. Also included in Vehicle Operating System. Includes Start of Message communication method. Includes End of Message communication method.

FIG. 7.8 illustrates a Snap for communicating the AeroDS data from the autonomous aircraft and the data storage facility. Also included in Vehicle Operating System. Includes Start of Message communication method. Includes End of Message communication method.

FIG. 7.9 illustrates a Snap for the Vehicle to transmit a ‘ready to send images’ status Message and an ‘end of images sent’ status Message. Also included in Vehicle Operating System. Includes Start of Message communication method. Includes End of Message communication method.

FIG. 7.10 illustrates a Snap for transmitting identification information about an autonomous vehicle from one vehicle or component of the vehicle to another vehicle or component of the vehicle. For the exchange of component status information on a vehicle. Also, used to transmit information about a vehicle to a charging station. RID, SID, DID Also included in Vehicle Operating System. Includes Start of Message communication method. Includes End of Message communication method.

FIG. 7.11 illustrates a Snap for an autonomous vehicle to communicate with the correct recharging station. The protocol is used by and included in the vehicle operating system. Also included in Vehicle Operating System. Includes Start of Message communication method. Includes End of Message communication method.

FIG. 7.12 illustrates a Snap for the vehicle to communicate its identification to the Management Center. Also included in Vehicle Operating System. Includes Start of Message communication method. Includes End of Message communication method.

FIG. 7.13 illustrates a Snap for marrying an autonomous or unmanned vehicle with an autonomous single aircraft acting as part of an integral part of a swarm of vehicles. Also included in Vehicle Operating System. Includes Start of Message communication method. Includes End of Message communication method.

FIG. 7.14 illustrates a Snap for the Management Center to communicate an authorization for the vehicle to operate in the geographic area. Also included in Vehicle Operating System. Includes Start of Message communication method. Includes End of Message communication method.

FIG. 7.15 illustrates a Snap for transmitting a copy of any message from an enterprise, vehicle or vehicle component to any other entity with a network Device ID. Also included in Vehicle Operating System. Includes Start of Message communication method. Includes End of Message communication method.

FIG. 7.16 illustrates a Snap for marrying an autonomous or unmanned vehicle with an autonomous single independent aircraft. Also included in Vehicle Operating System. Includes Start of Message communication method. Includes End of Message communication method.

FIG. 7.17 illustrates a Snap for communicating to the autonomous aircraft to resend the images. Also included in Vehicle Operating System. Includes Start of Message communication method. Includes End of Message communication method.

FIG. 7.18 illustrates a communication Snap from Management Center to an operator approving a flight plan. Also included in Vehicle Operating System. Includes Start of Message communication method. Includes End of Message communication method.

FIG. 7.19 illustrates a Snap for transmitting the creating the layered, 4-dimensional, virtual recreation of an environment from a 180-degree, variable altitude perspective. Also included in Vehicle Operating System. Includes Start of Message communication method. Includes End of Message communication method.

FIG. 7.20 illustrates a Snap for communicating to the autonomous aircraft the requirement to perform a full system component test. Also included in Vehicle Operating System. Includes Start of Message communication method. Includes End of Message communication method.

FIG. 7.21 illustrates a communication Snap from the Management Center to the aircraft for requesting the type and frequency of the data which the aircraft will collect and transmit. Also included in Vehicle Operating System. Includes Start of Message communication method. Includes End of Message communication method.

FIG. 7.22 illustrates a Snap for communicating the results of a full system component test from a vehicle to the repair depot. Also included in Vehicle Operating System. Includes Start of Message communication method. Includes End of Message communication method.

FIG. 7.23 illustrates a Snap from the Management Center to the aircraft communicating the L/Z area defining the authorized geographic area. Also included in Vehicle Operating System. Includes Start of Message communication method. Includes End of Message communication method.

FIG. 7.24 illustrates a Snap between a Vehicle and a Charger with an electrical and communications connector. Also included in Vehicle Operating System. Includes Start of Message communication method. Includes End of Message communication method.

FIG. 7.25 illustrates a communication Snap from the Management Center to the aircraft specifying the LAANC authorization number which the vehicle will apply to the flight and mission data Also included in Vehicle Operating System. Includes Start of Message communication method. Includes End of Message communication method.

FIG. 7.26 illustrates a communication Snap from an operator for submitting a flight plan to Management Center. Also included in Vehicle Operating System. Includes Start of Message communication method. Includes End of Message communication method.

FIG. 7.27 illustrates a Snap from the Management Center communicating to the aircraft the specifying the amount of flight time the aircraft has been in an authorized geographic area. Also included in Vehicle Operating System. Includes Start of Message communication method. Includes End of Message communication method.

FIG. 7.28 illustrates a communication Snap from the aircraft to the Management Center for each type of data the aircraft will send to the Management Center. Also included in Vehicle Operating System. Includes Start of Message communication method. Includes End of Message communication method.

FIG. 7.29 illustrates a Snap from the Management Center communicating to the autonomous aerial vehicle aircraft it must terminate operations and exit the geographic area. Also included in Vehicle Operating System. Includes Start of Message communication method. Includes End of Message communication method.

FIG. 7.30 illustrates a Snap from one Management Center communicating to an adjacent Management Center identifying and authorizing the autonomous aircraft to fly into the adjacent geographic area. Also included in Vehicle Operating System. Includes Start of Message communication method. Includes End of Message communication method.

FIG. 7.31 illustrates a communication Snap from Management Center to an operator defining the limits of the flight plan. Also included in Vehicle Operating System. Includes Start of Message communication method. Includes End of Message communication method.

FIG. 7.32 illustrates a Snap from the Management Center communicating to the autonomous aircraft it is not authorized to operate (locked out) in geographic area. Also included in Vehicle Operating System. Includes Start of Message communication method. Includes End of Message communication method.

FIG. 7.33 illustrates a Snap for communicating to the autonomous aircraft to resend the images. Also included in Vehicle Operating System. Includes Start of Message communication method. Includes End of Message communication method.

FIG. 7.34 illustrates a Snap for the repair depot to communicate to the autonomous aircraft that the aircraft has been grounded. Also included in Vehicle Operating System. Includes Start of Message communication method. Includes End of Message communication method.

FIG. 7.35 illustrates a Snap for the repair depot to communicate to the autonomous aircraft that the aircraft grounded status has been removed. Also included in Vehicle Operating System. Includes Start of Message communication method. Includes End of Message communication method.

FIG. 7.36 illustrates a Snap for the repair depot to communicate to the autonomous aircraft that the aircraft has been placed in active service. Also included in Vehicle Operating System. Includes Start of Message communication method. Includes End of Message communication method.

FIG. 7.37 illustrates a Snap for communicating to the autonomous aircraft confirmation the images were received and the number of images which were received. Also included in Vehicle Operating System. Includes Start of Message communication method. Includes End of Message communication method.

FIG. 7.38 illustrates a Snap for communicating to the autonomous aircraft the identification of the repair depot to which the aircraft has been assigned. Also included in Vehicle Operating System. Includes Start of Message communication method. Includes End of Message communication method.

FIG. 7.39 illustrates a Snap for connecting elements of a network to each other based on the identification of an Enterprise. Also included in Vehicle Operating System. Includes Start of Message communication method. Includes End of Message communication method.

FIG. 7.40 illustrates a Snap for connecting elements of a network to each other based on the identification of a Fleet and an Enterprise. Also included in Vehicle Operating System. Includes Start of Message communication method. Includes End of Message communication method.

FIG. 7.41 illustrates a Snap for connecting elements of a Fleet to a licensed FAA Part 107 Pilot based on the identification of a Pilot or on the identification of a Fleet Also included in Vehicle Operating System. Includes Start of Message communication method. Includes End of Message communication method.

FIG. 7.42 illustrates a Snap for connecting a Vehicle and its components to a licensed FAA Part 107 Pilot based on the identification of a Pilot or on the identification of a Vehicle Also included in Vehicle Operating System. Includes Start of Message communication method. Includes End of Message communication method.

FIG. 7.43 illustrates a Snap for connecting elements of a Fleet to a Certified FAA Visual Observer based on the identification of a Certified Visual Observer or on the identification of a Fleet Also included in Vehicle Operating System. Includes Start of Message communication method. Includes End of Message communication method.

FIG. 7.44 illustrates a Snap for connecting a Vehicle and its components to a Certified FAA Visual Observer based on the identification of a Visual Observer or on the identification of the Vehicle Also included in Vehicle Operating System. Includes Start of Message communication method. Includes End of Message communication method.

FIG. 7.45 illustrates a Snap for connecting a Fleet and its components to a Mission Set based on the identification of a Mission Set or on the identification of a Fleet Also included in Vehicle Operating System. Includes Start of Message communication method. Includes End of Message communication method.

FIG. 7.46 illustrates a Snap for connecting a Mission Set identification number to any component in a network. Also included in Vehicle Operating System. Includes Start of Message communication method. Includes End of Message communication method.

FIG. 7.47 illustrates a Snap for connecting a Fleet and its components to a Project Set based on the identification of a Project Set or on the identification of a Fleet Also included in Vehicle Operating System. Includes Start of Message communication method. Includes End of Message communication method.

FIG. 7.48 illustrates a Snap for connecting a Charger and its components to a Fleet and its components based on the identification of a Charger or on the identification of a Fleet Also included in Vehicle Operating System. Includes Start of Message communication method. Includes End of Message communication method.

FIG. 7.49 illustrates a Snap for connecting elements of a network to each other based on the identification of a Charger. Also included in Vehicle Operating System. Includes Start of Message communication method. Includes End of Message communication method.

FIG. 7.50 illustrates a Snap for connecting elements of a network to each other based on the identification of a Certified Visual Observer. Also included in Vehicle Operating System. Includes Start of Message communication method. Includes End of Message communication method.

FIG. 7.51 illustrates a Snap for connecting elements of a network to each other based on the identification of a Licensed FAA 107 Pilot. Also included in Vehicle Operating System. Includes Start of Message communication method. Includes End of Message communication method.

FIG. 7.52 illustrates a Snap for connecting a Licensed FAA Part 107 Pilot to a Mission Set and its components based on the identification of a Licensed FAA Part 107 Pilot or on the identification of a Mission Set Also included in Vehicle Operating System. Includes Start of Message communication method. Includes End of Message communication method.

FIG. 7.53 illustrates a Snap for connecting a Certified FAA Visual Observer to a Mission Set and its components based on the identification of a Certified FAA Visual Observer or on the identification of a Mission Set Also included in Vehicle Operating System. Includes Start of Message communication method. Includes End of Message communication method.

FIG. 7.54 illustrates a Snap connecting the Pilot with the Vehicle assigning the Vehicle the next priority Mission Set Also included in Vehicle Operating System. Includes Start of Message communication method. Includes End of Message communication method.

FIG. 7.55 illustrates a Snap for connection the Pilot to the Fight Log data store allowing the Pilot to enter a descriptive comment for each event experience by the Vehicle, sensors chargers, transporters, Pilots and Visual Observers assigned to a Mission Set flight. Also included in Vehicle Operating System. Includes Start of Message communication method. Includes End of Message communication method.

FIG. 7.56 illustrates a Snap for connecting a Fleet and its components, ready to execute a Mission, to a Mission Set and its components based on the identification of a Certified FAA Visual Observer or on the identification of a Mission Set Also included in Vehicle Operating System. Includes Start of Message communication method. Includes End of Message communication method.

FIG. 7.57 illustrates a Snap for connecting a Mission Set and its components to aa FAA Approved Waiver based on the identification of a Mission Set or on the identification of an FAA Approved Waiver Also included in Vehicle Operating System. Includes Start of Message communication method. Includes End of Message communication method.

FIG. 7.58 illustrates a Snap for connecting elements of a network to each other based on the identification of an FAA Waiver. Also included in Vehicle Operating System. Includes Start of Message communication method. Includes End of Message communication method.

FIG. 7.59 illustrates a Snap for connecting a Vehicle and its components, ready to execute a Mission, to a Mission Set and its components based on the identification of a Vehicle or on the identification of a Mission Set Also included in Vehicle Operating System. Includes Start of Message communication method. Includes End of Message communication method.

FIG. 7.60 illustrates a Snap for connecting a Licensed FAA Part 107 Pilot ready to execute a Mission, to a Mission Set and its components based on the identification of a Licensed FAA Part 107 Pilot or on the identification of a Mission Set Also included in Vehicle Operating System. Includes Start of Message communication method. Includes End of Message communication method.

FIG. 7.61 illustrates a Snap for connecting a Certified FAA Visual Observer, ready to execute a Mission, to a Mission Set and its components based on the identification of a Certified FAA Visual Observer or on the identification of a Mission Set Also included in Vehicle Operating System. Includes Start of Message communication method. Includes End of Message communication method.

FIG. 7.62 illustrates a Snap for connecting elements of a network to each other based on the identification of an FAA Waiver. Also included in Vehicle Operating System. Includes Start of Message communication method. Includes End of Message communication method.

FIG. 7.63 illustrates a Snap for connecting elements of a network to each other based on the identification of an Enterprise Also included in Vehicle Operating System. Includes Start of Message communication method. Includes End of Message communication method.

FIG. 7.64 illustrates a Snap for connecting elements of a network to each other based on the identification of a Fleet Also included in Vehicle Operating System. Includes Start of Message communication method. Includes End of Message communication method.

FIG. 7.65 illustrates a Snap for connecting elements of a network to each other based on the identification of a Repair Depot Also included in Vehicle Operating System. Includes Start of Message communication method. Includes End of Message communication method.

FIG. 7.66 illustrates a Snap for connecting elements of a network to each other based on the identification of a Geographic Area Also included in Vehicle Operating System. Includes Start of Message communication method. Includes End of Message communication method.

FIG. 7.67 illustrates a Snap for connecting the Fleet Management Center to a Vehicle and its components, ready to execute a Mission Set in a Geographic Area based on the identification of a Vehicle or on the identification of a Geographic Area Also included in Vehicle Operating System. Includes Start of Message communication method. Includes End of Message communication method.

FIG. 7.68 illustrates a Snap identifying the radio frequency for transmitting and receiving to be used for connecting the Fleet Management Center to a Vehicle and its components, ready to execute a Mission Set in a Geographic Area based on the identification of a Vehicle or on the identification of a Geographic Area. Also included in Vehicle Operating System. Includes Start of Message communication method. Includes End of Message communication method.

FIG. 7.69 illustrates a Snap identifying the antenna radio frequency used for transmitting and receiving and used for connecting the Fleet Management Center to a Vehicle and its components, ready to execute a Mission Set in a Geographic Area based on the identification of a Vehicle or on the identification of a Geographic Area. Also included in Vehicle Operating System. Includes Start of Message communication method. Includes End of Message communication method.

FIG. 7.70 illustrates a Snap used by the Fleet Management Center to send a radio frequency ping to radio transceiver in a Geographic Area. Also included in Vehicle Operating System. Includes Start of Message communication method. Includes End of Message communication method.

FIG. 7.71 illustrates a snap used by the Fleet Management Center to request a Charger, associated with a Fleet which is associated with a Mission Set, to perform a full system component test. Also included in Vehicle Operating System. Includes Start of Message communication method. Includes End of Message communication method.

FIG. 7.72 illustrates a snap used by the Fleet Management Center to request a Charger, associated with a Fleet which is associated with a Mission Set, to communicate the results of full system component test. Also included in Vehicle Operating System. Includes Start of Message communication method. Includes End of Message communication method.

FIGS. 8.1-8.41 illustrate an exemplary data architecture for the present invention and include the following data tables for the data captured from Vehicles, Chargers, Vehicle Components, Company Personnel and Enterprises.

FIG. 8.2 illustrates a Battery Profile Table consisting of a plurality of data fields containing alphabetic, numeric and symbolic characters to define a plurality of Battery Profiles.

FIG. 8.3 illustrates a Cargo Profile Table consisting of a plurality of data fields containing alphabetic, numeric and symbolic characters to define a plurality of Cargo Profiles.

FIG. 8.4 illustrates a Certification Profile Table consisting of a plurality of data fields containing alphabetic, numeric and symbolic characters to define a plurality of Certification Profiles.

FIG. 8.5 illustrates a Charger Table consisting of a plurality of data fields containing alphabetic, numeric and symbolic characters to define a plurality of Chargers.

FIG. 8.6 illustrates a Charger Type Table consisting of a plurality of data fields containing alphabetic, numeric and symbolic characters to define a plurality of Charger Types.

FIG. 8.7 illustrates a Data Priority Profile Table consisting of a plurality of data fields containing alphabetic, numeric and symbolic characters to define a plurality of Data Priority Profiles.

FIG. 8.8 illustrates a Enterprise Table consisting of a plurality of data fields containing alphabetic, numeric and symbolic characters to define a plurality of Enterprises.

FIG. 8.9 illustrates a Event Table consisting of a plurality of data fields containing alphabetic, numeric and symbolic characters to define a plurality of Events.

FIG. 8.10 illustrates a Event Profile Table consisting of a plurality of data fields containing alphabetic, numeric and symbolic characters to define a plurality of Event Profiles.

FIG. 8.11 illustrates a FAA License Table consisting of a plurality of data fields containing alphabetic, numeric and symbolic characters to define a plurality of FAA License s.

FIG. 8.12 illustrates a Flight Plan Table consisting of a plurality of data fields containing alphabetic, numeric and symbolic characters to define a plurality of Flight Plans.

FIG. 8.13 illustrates a Geographic Area Table consisting of a plurality of data fields containing alphabetic, numeric and symbolic characters to define a plurality of Geographic Areas.

FIG. 8.14 illustrates a Job Table consisting of a plurality of data fields containing alphabetic, numeric and symbolic characters to define a plurality of Jobs.

FIG. 8.15 illustrates a Mission Set Table consisting of a plurality of data fields containing alphabetic, numeric and symbolic characters to define a plurality of Mission Sets.

FIG. 8.16 illustrates a Mission Set Profile Table consisting of a plurality of data fields containing alphabetic, numeric and symbolic characters to define a plurality of Mission Set Profiles.

FIG. 8.17 illustrates a Mission Status Table consisting of a plurality of data fields containing alphabetic, numeric and symbolic characters to define a plurality of Mission Statuss.

FIG. 8.18 illustrates a Mission Journal Table consisting of a plurality of data fields containing alphabetic, numeric and symbolic characters to define a plurality of Mission Journals.

FIG. 8.19 illustrates a Operator Table consisting of a plurality of data fields containing alphabetic, numeric and symbolic characters to define a plurality of Operators.

FIG. 8.20 illustrates a Operator Profile Table consisting of a plurality of data fields containing alphabetic, numeric and symbolic characters to define a plurality of Operator Profiles.

FIG. 8.21 illustrates a Project Set Table consisting of a plurality of data fields containing alphabetic, numeric and symbolic characters to define a plurality of Project Sets.

FIG. 8.22 illustrates a Project Set Data Priority Table consisting of a plurality of data fields containing alphabetic, numeric and symbolic characters to define a plurality of Project Set Data Prioritys.

FIG. 8.23 illustrates a Radio Frequency Table consisting of a plurality of data fields containing alphabetic, numeric and symbolic characters to define a plurality of Radio Frequencies.

FIG. 8.24 illustrates a Sensor Table consisting of a plurality of data fields containing alphabetic, numeric and symbolic characters to define a plurality of Sensors.

FIG. 8.25 illustrates a Sensor Profile Table consisting of a plurality of data fields containing alphabetic, numeric and symbolic characters to define a plurality of Sensor Profiles.

FIG. 8.26 illustrates a Status Table consisting of a plurality of data fields containing alphabetic, numeric and symbolic characters to define a plurality of Status.

FIG. 8.27 illustrates a Status Profile Table consisting of a plurality of data fields containing alphabetic, numeric and symbolic characters to define a plurality of Status Profiles.

FIG. 8.28 illustrates a Sub-Enterprise Table consisting of a plurality of data fields containing alphabetic, numeric and symbolic characters to define a plurality of Sub-Enterprises.

FIG. 8.29 illustrates a Vehicle Table consisting of a plurality of data fields containing alphabetic, numeric and symbolic characters to define a plurality of Vehicles.

FIG. 8.30 illustrates a Vehicle Profile Table consisting of a plurality of data fields containing alphabetic, numeric and symbolic characters to define a plurality of Vehicle Profiles.

FIG. 8.31 illustrates a Waypoint Table consisting of a plurality of data fields containing alphabetic, numeric and symbolic characters to define a plurality of Waypoints.

FIG. 8.32 illustrates a What3Words Table consisting of a plurality of data fields containing alphabetic, numeric and symbolic characters to define a plurality of What3Wordss.

FIG. 8.33 illustrates a Pre-Flight Charger Checklist Table consisting of a plurality of data fields containing alphabetic, numeric and symbolic characters to define a plurality of Pre-Flight Charger Checklists.

FIG. 8.34 illustrates a Fleet Table consisting of a plurality of data fields containing alphabetic, numeric and symbolic characters to define a plurality of Fleets.

FIG. 8.35 illustrates a Pilot Table consisting of a plurality of data fields containing alphabetic, numeric and symbolic characters to define a plurality of Pilots.

FIG. 8.36 illustrates a Visual Observer Table consisting of a plurality of data fields containing alphabetic, numeric and symbolic characters to define a plurality of Visual Observers.

FIG. 8.37 illustrates a Repair Depot Table consisting of a plurality of data fields containing alphabetic, numeric and symbolic characters to define a plurality of Repair Depots.

FIG. 8.38 illustrates a Mission Set Checklist Table consisting of a plurality of data fields containing alphabetic, numeric and symbolic characters to define a plurality of Mission Set Checklists.

FIG. 8.39 illustrates a FAA Waiver Table consisting of a plurality of data fields containing alphabetic, numeric and symbolic characters to define a plurality of FAA Waivers.

FIG. 8.40 illustrates a LAANC Table consisting of a plurality of data fields containing alphabetic, numeric and symbolic characters to define a plurality of LAANCs.

FIG. 8.41 illustrates a Encryption Table consisting of a plurality of data fields containing alphabetic, numeric and symbolic characters to define a plurality of Encryptions.

FIG. 9 illustrates the symbols used in the other figures.

In accordance with common practice, the various described features are not drawn to scale, but are drawn to emphasize specific features relevant to the invention. Like reference characters denote like elements throughout the figures and text.

### DETAILED DESCRIPTION OF THE PRESENT INVENTION

The following are definitions of terms used in the description of the invention.

1. A “Fleet Management Center” is a subset of the Management Center. The Fleet Management Center is located within the Management Center, which is at a central location remote from the unmanned Vehicles, housing licensed FAA Part 107 Pilots responsible for creating and operating a Fleet of unmanned vehicles.

2. A Licensed Pilot or licensed FAA Part 107 Pilot (“Pilot”), is a remote pilot in command of the unmanned Vehicle. The Pilot is an individual licensed by the Federal Aviation Administration (FAA) to remotely operate and control an unmanned Vehicle under Part 107 of the FAA Rules and regulations, as amended.

3. A “Visual Observer” (“VO”) is an individual, required under Part 107 of the FAA Rules and Regulations to coordinate the remote operation of an unmanned Vehicle with a Pilot. The Visual Observer is situated at the site of the unmanned aircraft and scans the airspace where the unmanned aircraft is operating for any potential collision hazard; and maintains awareness of the position of the unmanned aircraft through direct visual observation.

4. A “Charger” is an aerial, surface, maritime, sub-maritime system, which provides electricity, propane, fuel, or another energy generating material to an unmanned Vehicle. It can be fixed or mobile, automated, semi-automated or manually operated. The Charger includes a telecommunications connection to the plurality of unmanned Vehicles in a Fleet or not assigned to a Fleet. It is capable of remotely contacting and then connecting to an unmanned Vehicle and replenishing the Vehicle with the energy-generating material as required by the Vehicle.

5. A “Vehicle” is an unmanned remotely operated aerial, surface, sub-surface, maritime or sub-marine device or system used for transporting people, goods, or other objects.

6. A “Mission Set” includes a collection of rules, instructions, locations, and operating instructions used to perform a task or series of tasks at a specific time and location. It is a collection of one or more Project Sets.

7. A “Project Set” is a subset of a Mission Set. The Project Set includes a collection of rules, instructions, locations, events, and operating instructions used to perform a specific event task at a specific time and location. It includes a Flight Plan, start time, location of the Project Set, and an end time. It also includes a plurality of project Way Points.

8. A “Way Point” is a subset of a Project Set. The Way Point includes a collection of rules, instructions, a specific location and altitude, events, and operating instructions used at a specific location, altitude, and time.

9. A “Geographic Area” or “Geo Area” is a demarcated area of the Earth or any celestial body, and is defined by a longitude and latitude for each significant boundary point of the area. The surface of the earth is divided into an established grid, bounded by longitude and latitude lines. Each cell of the grid defines a specific geographic area.

10. A ‘Full System Test” is a test of a complete and fully integrated unmanned Vehicle, Charger or Sensor. A Full System Test includes a series of different sub-tests, the sole purpose of which is to exercise individual components of the unmanned Vehicle, Charger or Sensor. The hardware, software and firmware are tested individually and together. The Full System Test evaluates the test results and compares those results against a set of desired results.

11. A “Modem” is a device for modulation and demodulation of radio frequency signals. It converts digital data to be transmitted into an analog signal. It converts a received analog radio signal into digital data.

12. A “Multiplexor”, (“MUX”) is a device allowing one or more analog or digital input signals to be selected, combined and transmitted at a higher speed on a single shared medium or within a single shared device. Thus, when multiplexed, several signals may share a single device or transmission conductor, such as a radio frequency transmitter.

13. A “Snap” is a connection between two or more entities in a network. It virtually affixes two or more entities to each other within the network.

14. A “Filter” is a device which excludes predefined radio frequencies from being input to a radio receiver.

15. “Uvionics” is a commercial name of an onboard, Vehicle operating and control system, that allows licensed Pilots to remotely operate multiple Vehicles, concurrently and efficiently. Such a Vehicle Control System is commercially referred to as a Uvionics System, available from the Aeronyde Corporation of Melbourne, Fla.

16. A “Fleet” is plurality of unmanned Vehicles operating in concert.

17. “LAANC” is the FAA Low Altitude Authorization and Notification Capability. It directly supports Unmanned Aerial Systems integration into the controlled airspace. LAANC automates the application and approval process for airspace authorizations. Through automated applications developed by an FAA Approved Unmanned Aerial Systems Service Suppliers (USS) pilots apply for an airspace authorization to operate an unmanned vehicle, in accordance with Public Law 112-95, § 333 and its implementing regulations at 14 CFR Part 107 and under 49 U.S.C. § 44809(a) as amended.

18. The terms “drones”, “unmanned vehicle”, unmanned aerial vehicle”, “autonomous vehicle”, “autonomous aerial vehicle”, unmanned aerial systems ,and “UAS” are all used interchangeably.

19. An “Enterprise” is the name of the customer financially and operationally responsible for a Vehicle, Charger, Fleet and Mission Sets.

20. A “System” is an interconnected, integrated, coordinated, functioning operation of Vehicles, or Fleets, or Chargers, or equipment, or hardware, or software, or humans, or procedures, or objects.

21. A “Ping” is a process to test to determine if a particular host is reachable. It is a diagnostic that checks if the transmitting entity is connected to another entity. A ping sends a data packet to an entity, and if it received by the entity, the entity sends a data packet back.

22. A “Communication Method” is a process by which data elements are standardized, organized, and formatted in a specific order and sequence.

These and other features and advantages of this invention are described in, or are apparent from, the following detailed description of various exemplary embodiments.

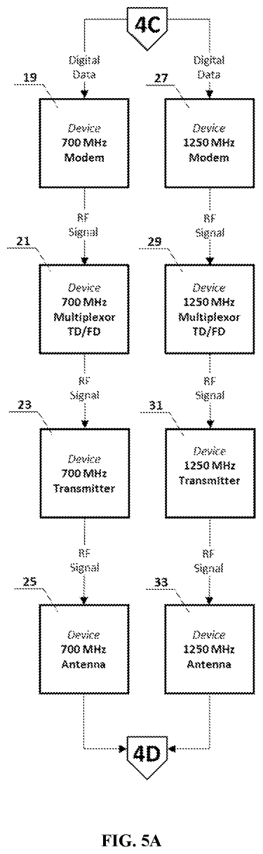

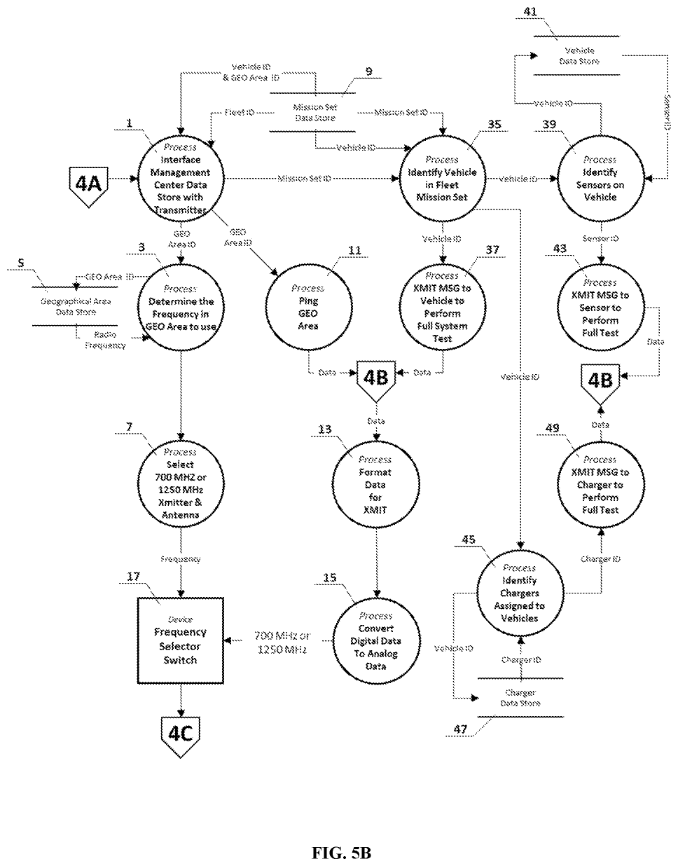

A reference to ‘(5A.X)’ in the following description refers to FIG. 5A of the drawings and element number ‘X’ included in the FIG. 5A.

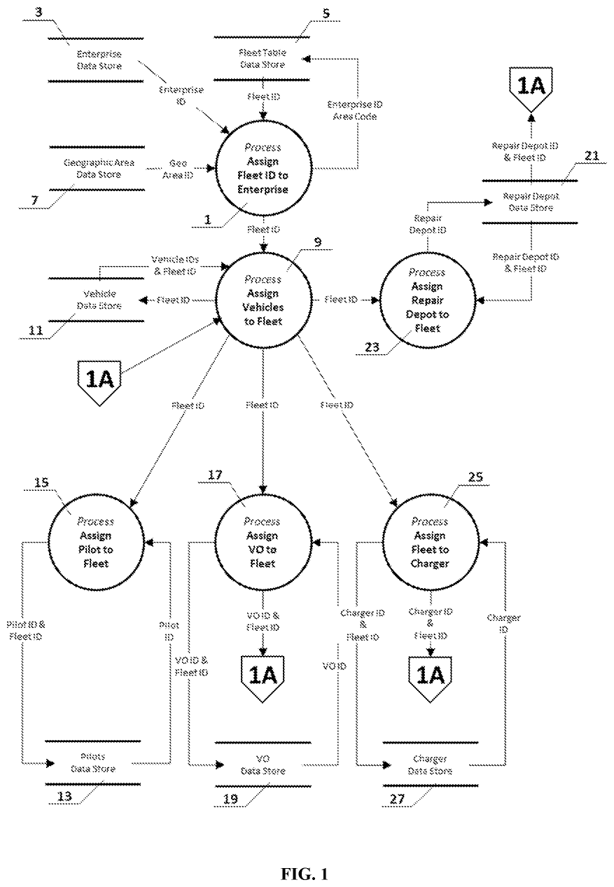

FIG. 1 illustrates an exemplary Fleet Management System to create a Fleet and the related processes of the present invention.

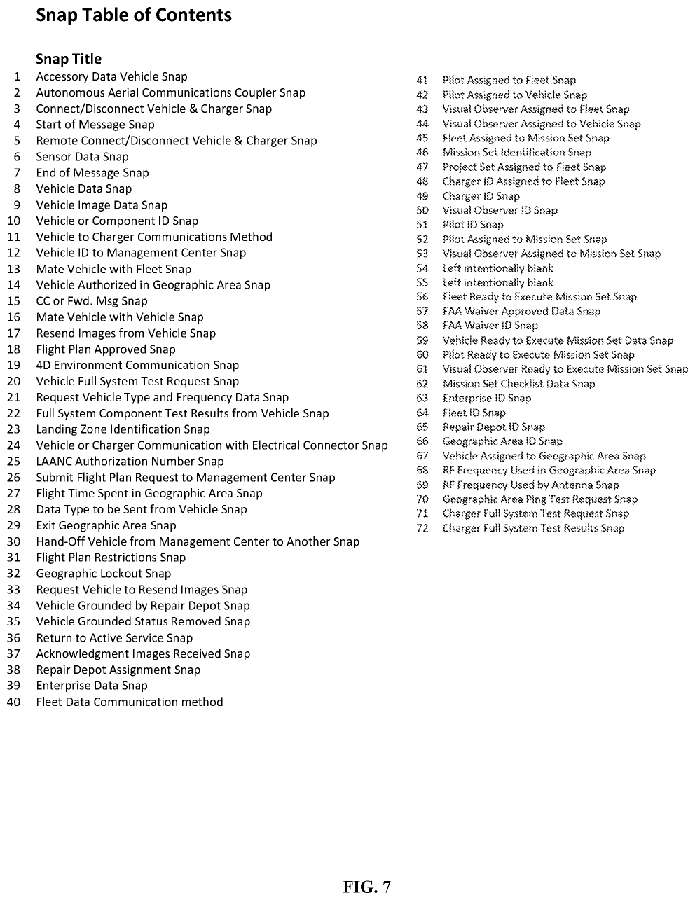

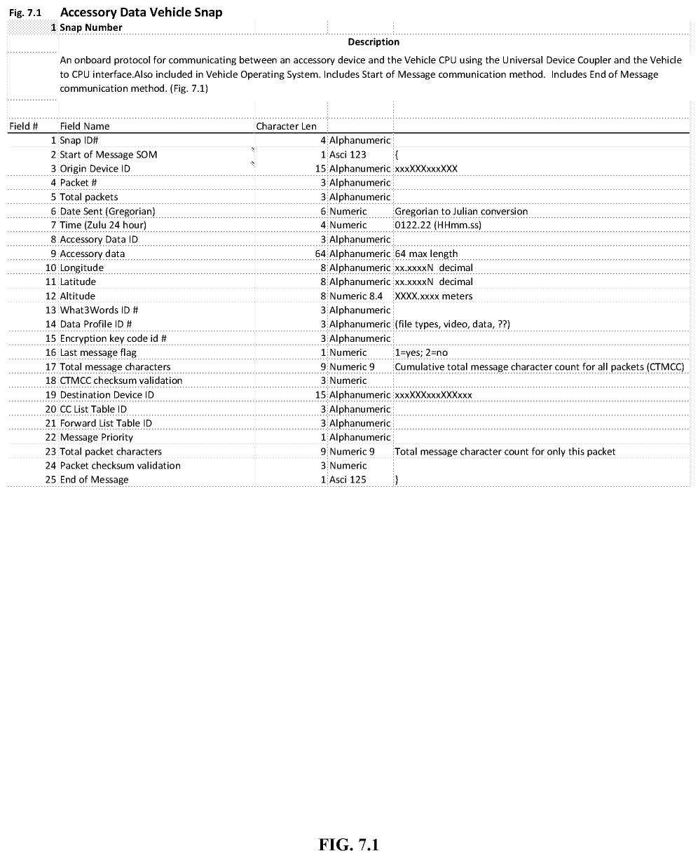

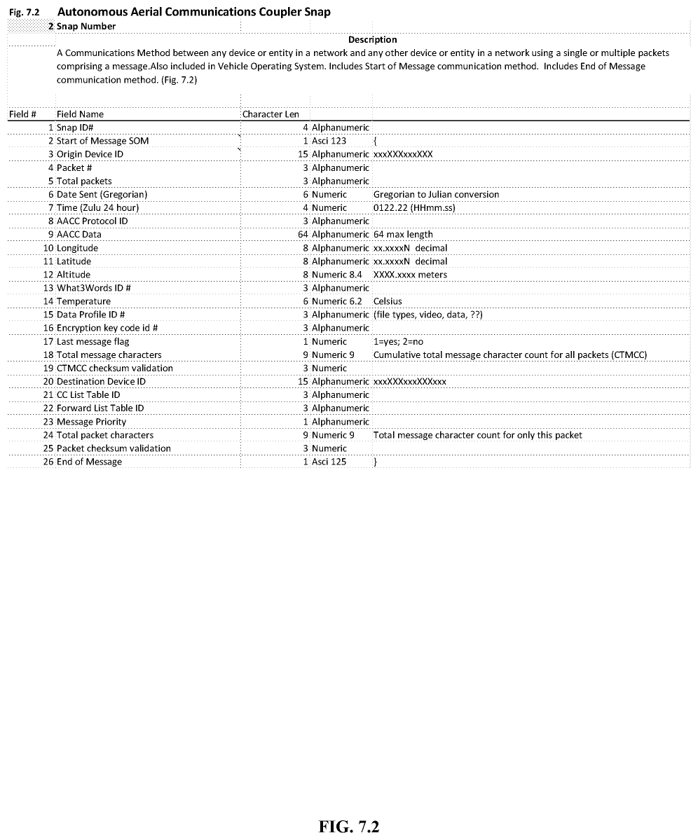

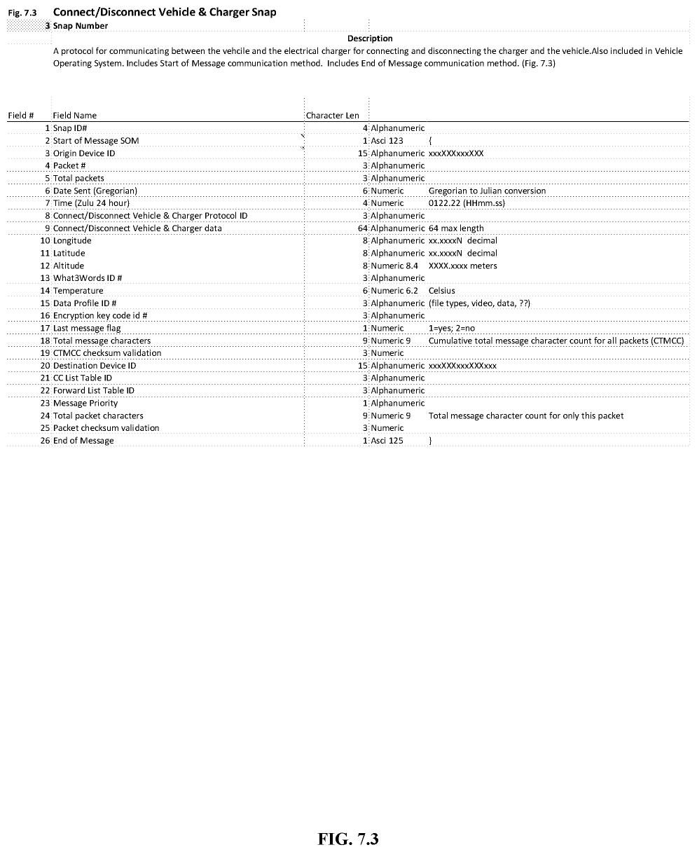

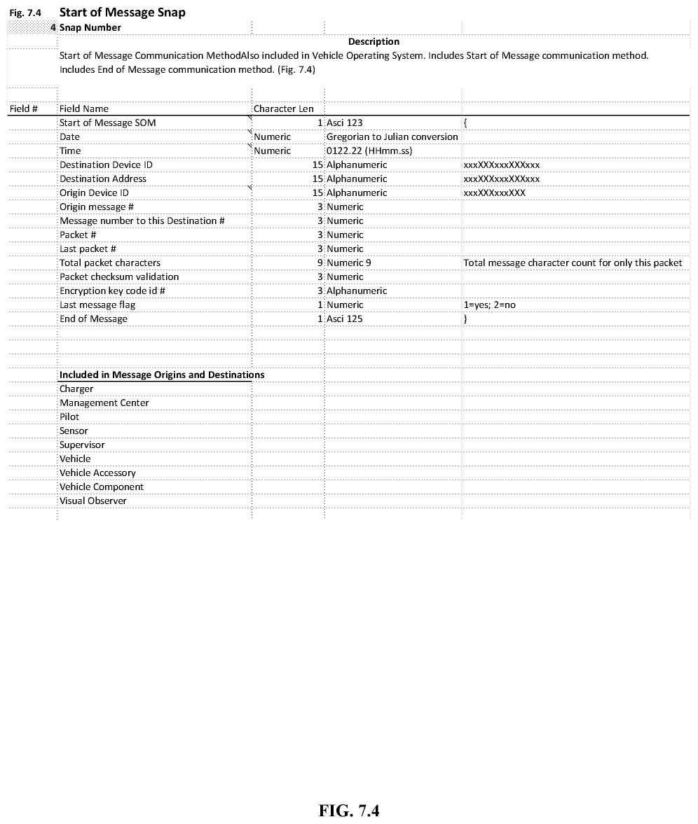

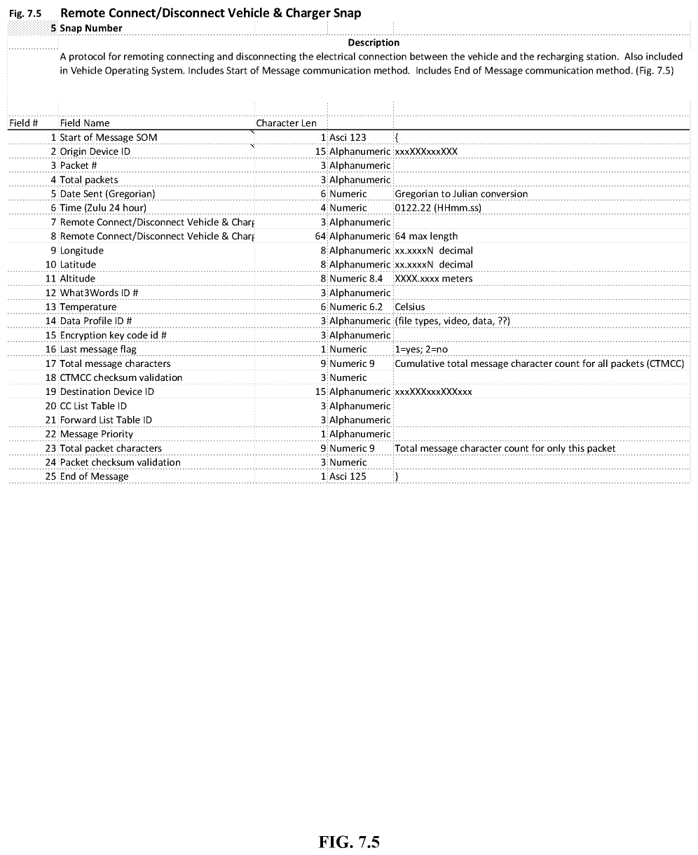

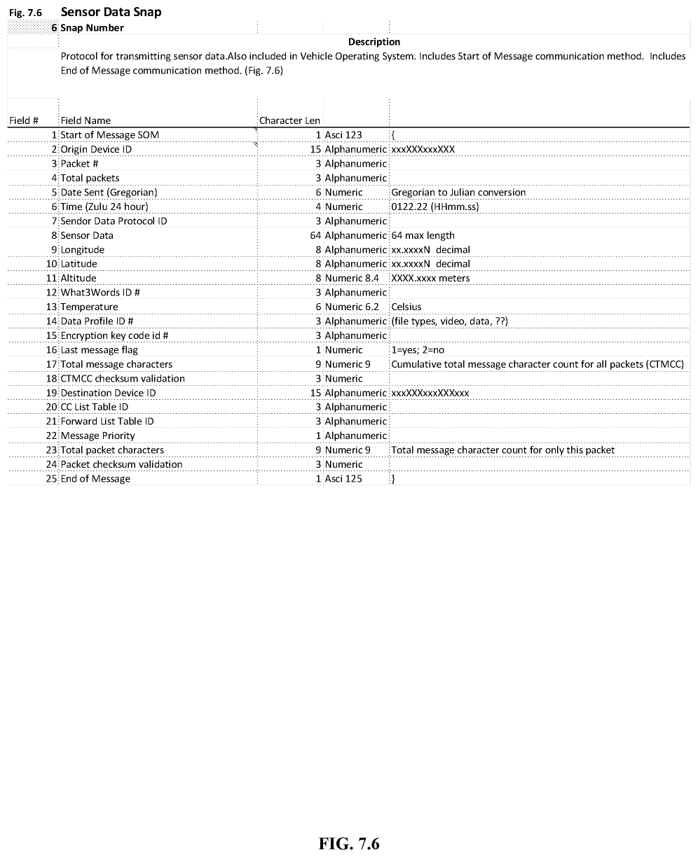

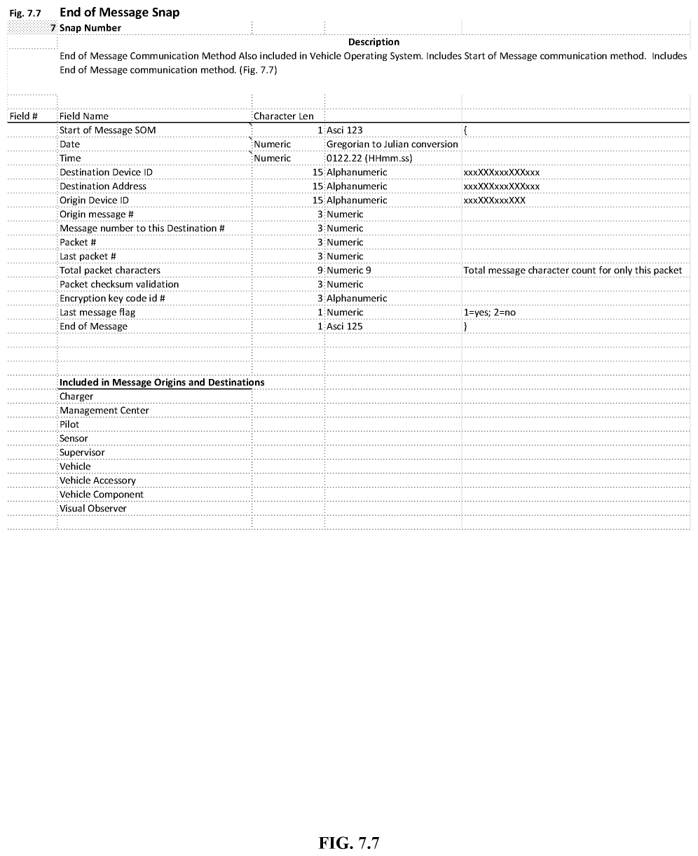

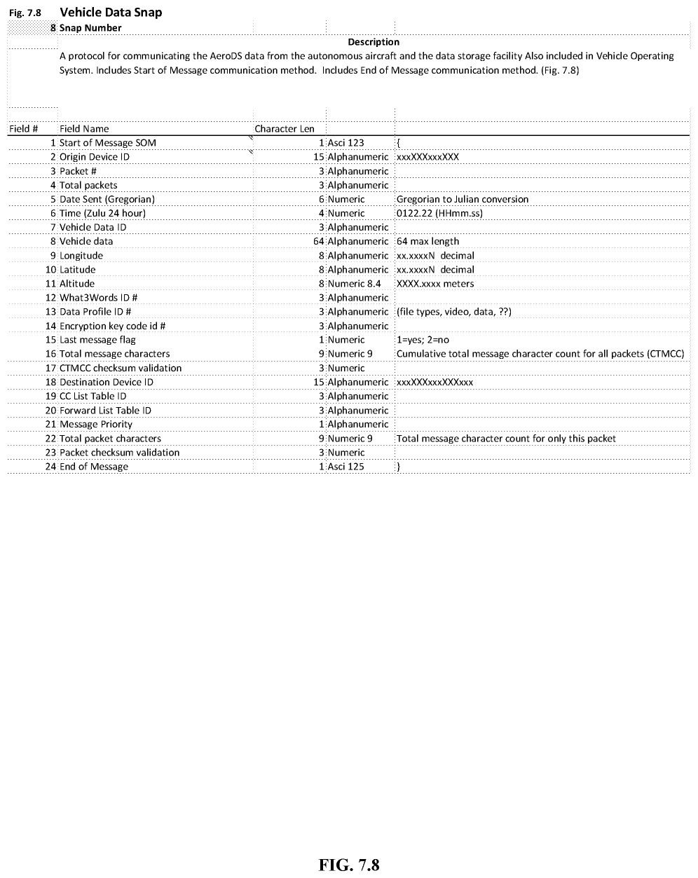

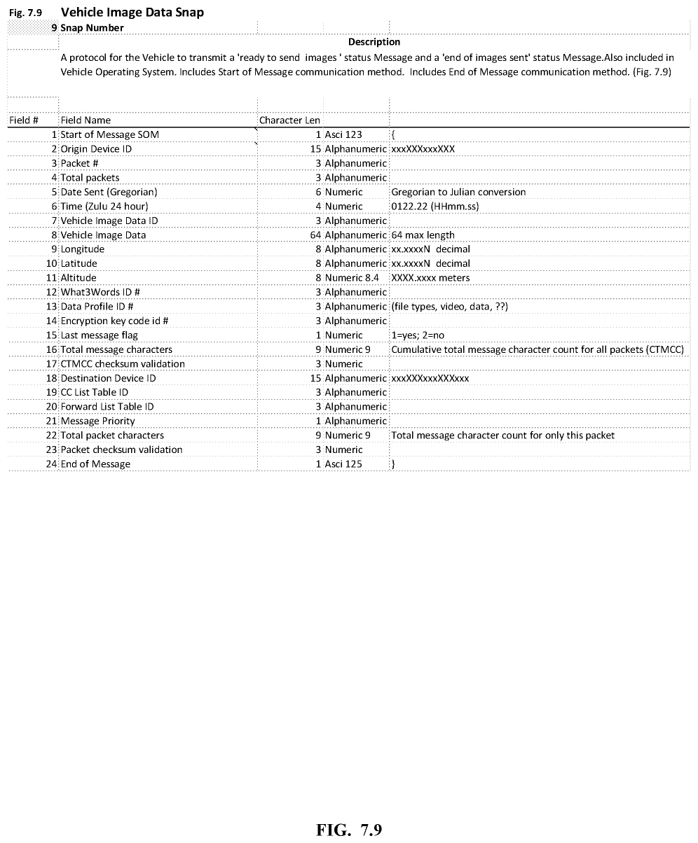

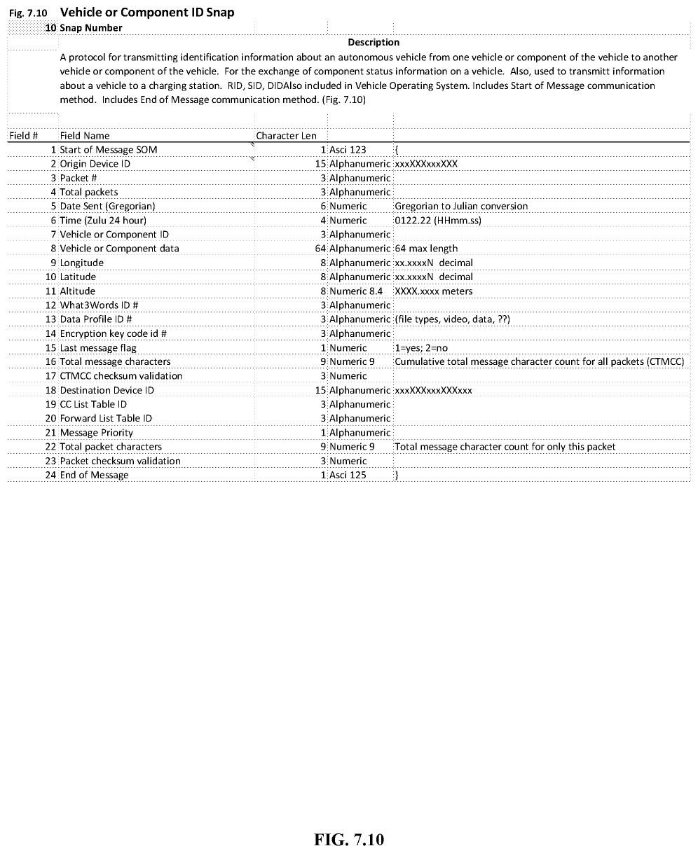

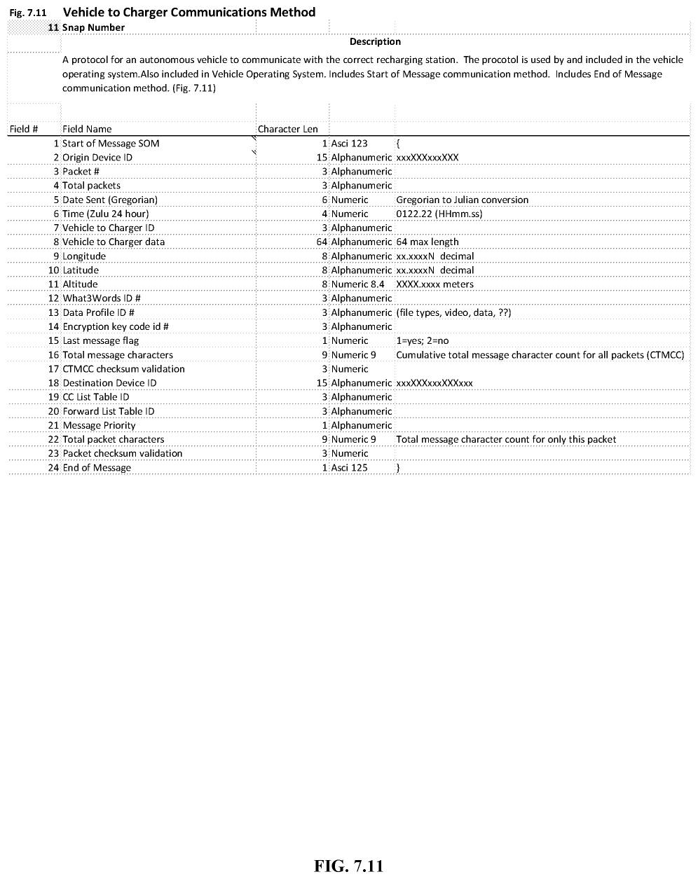

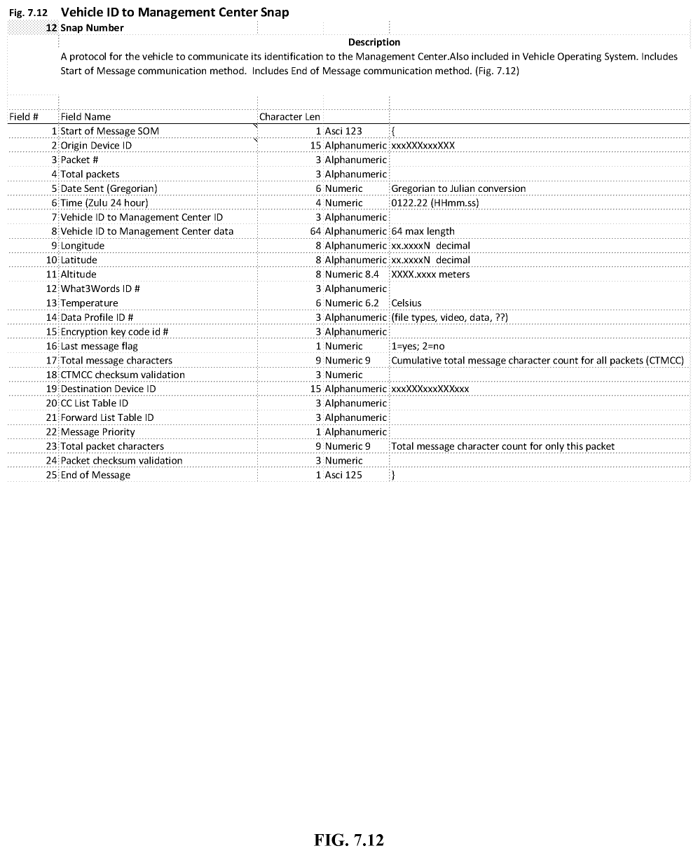

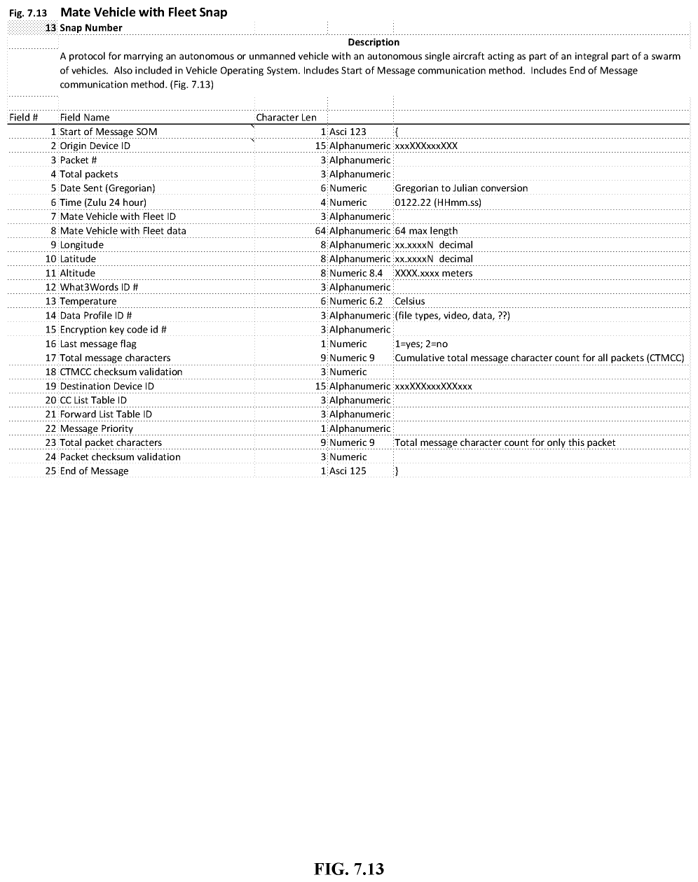

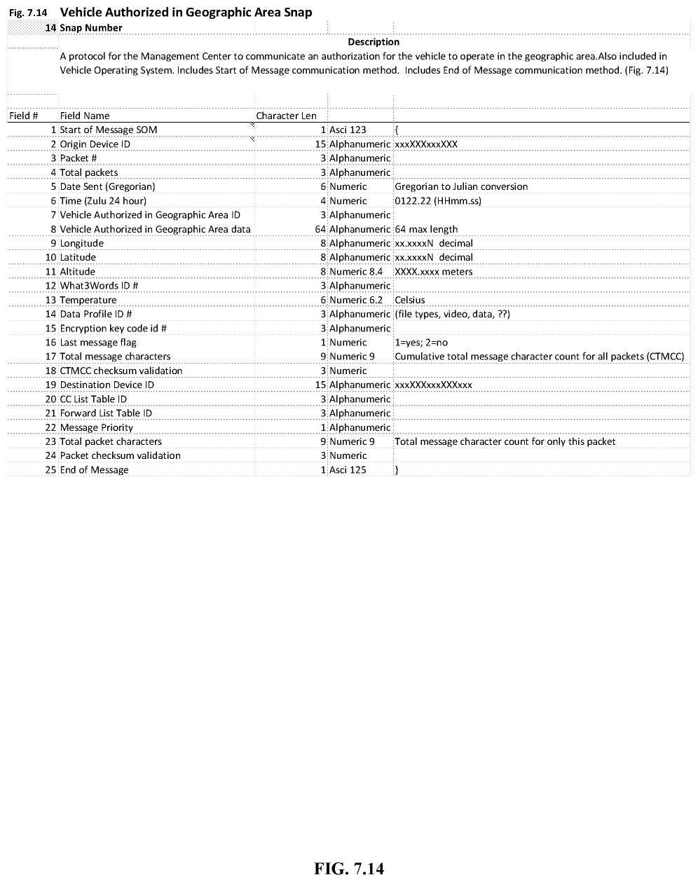

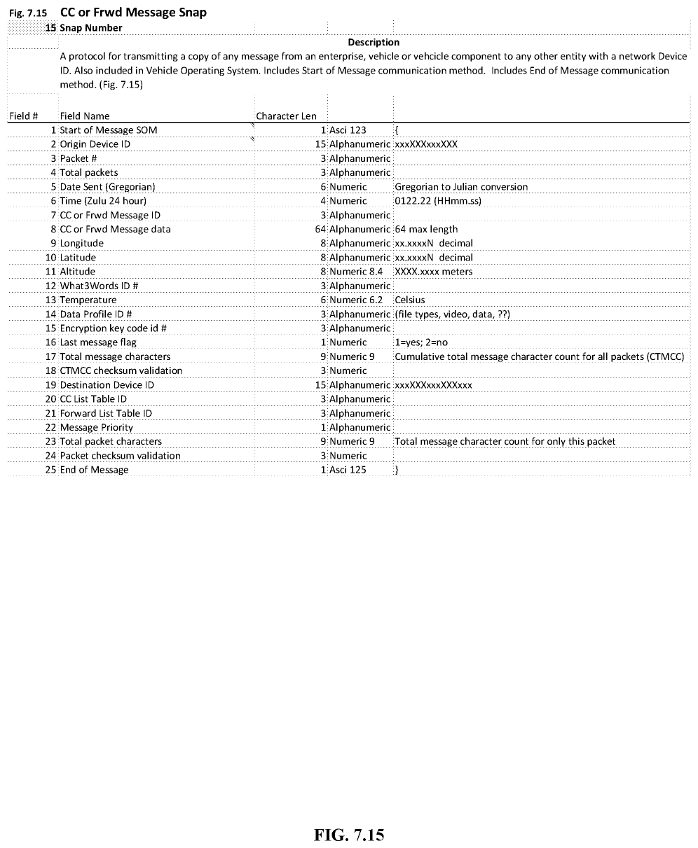

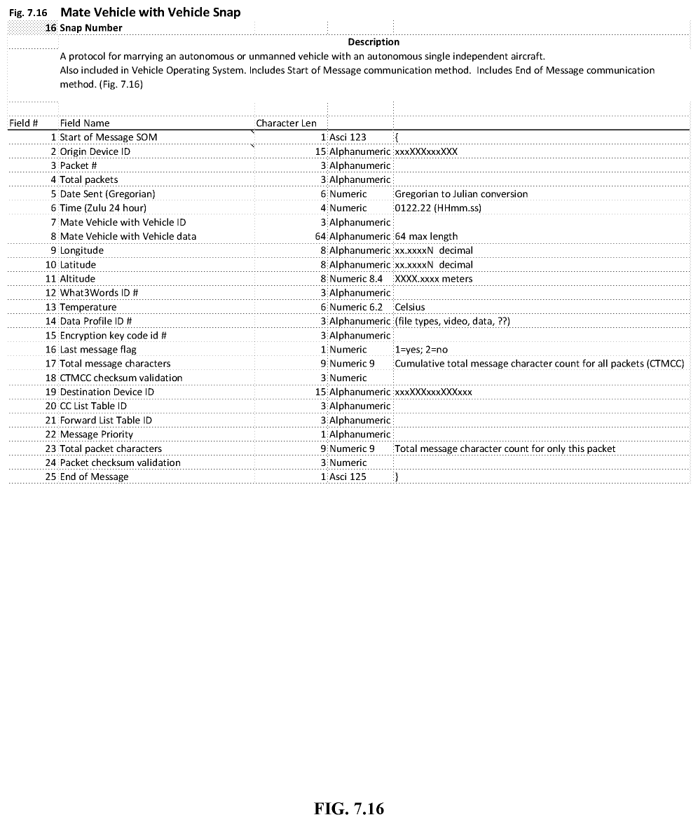

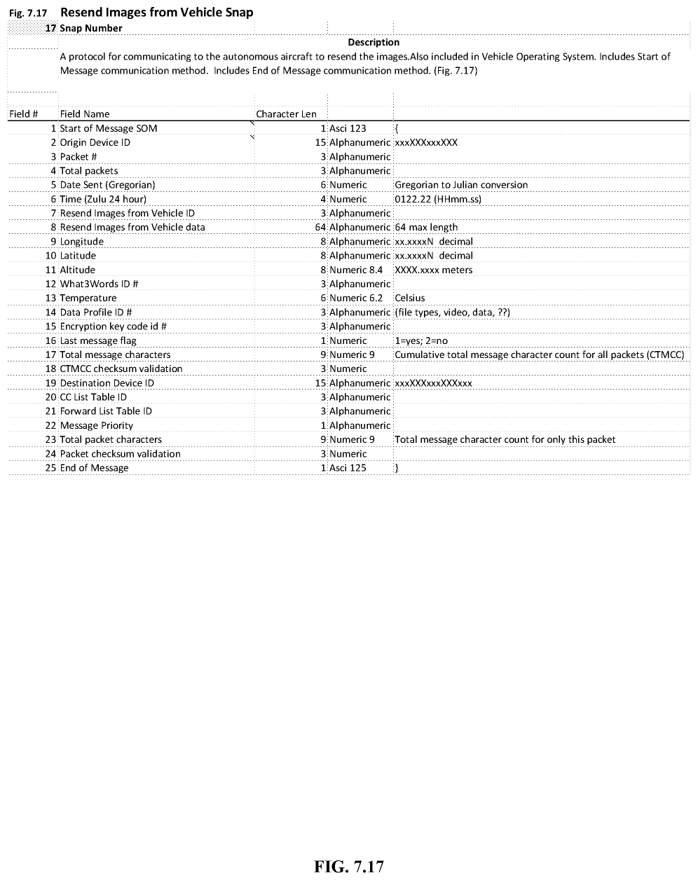

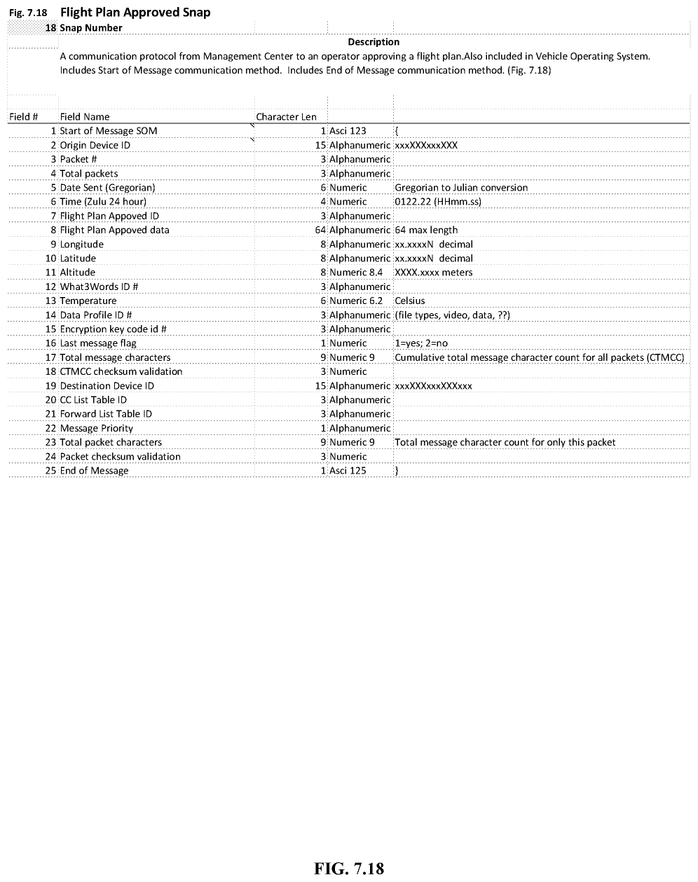

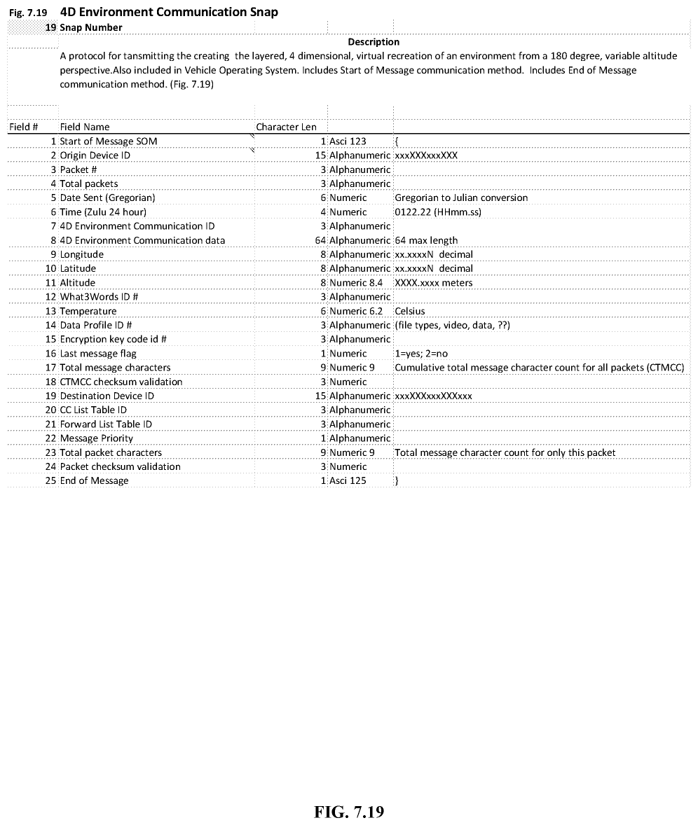

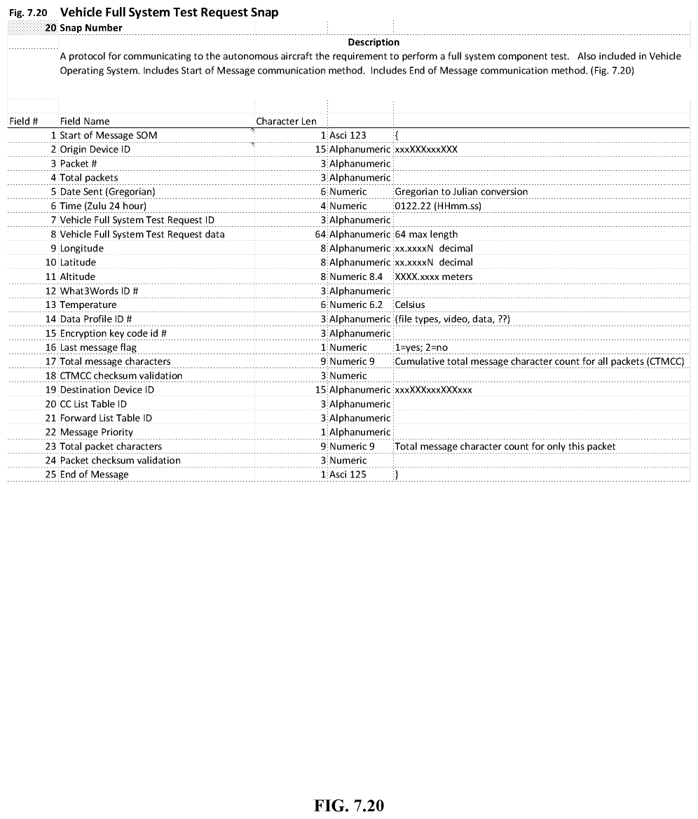

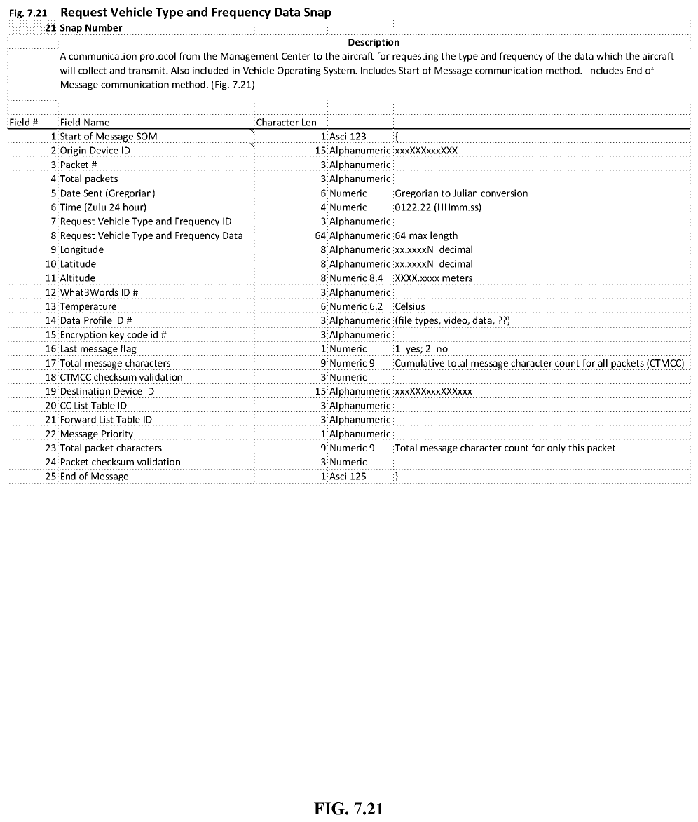

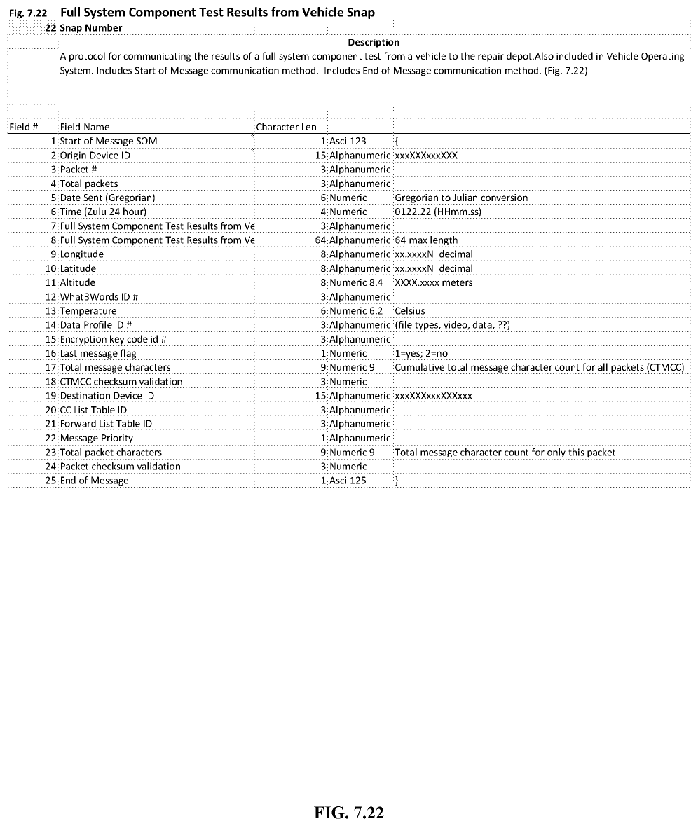

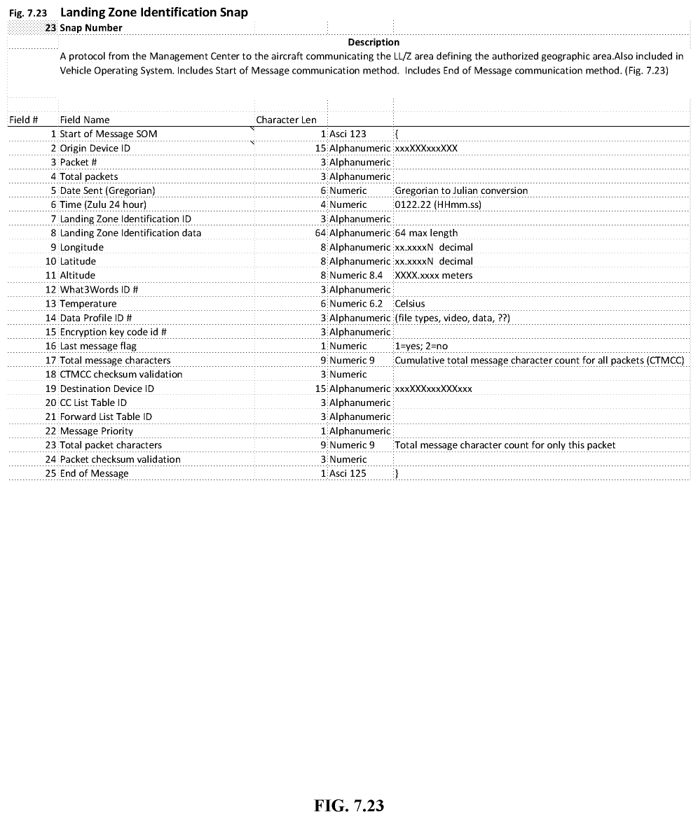

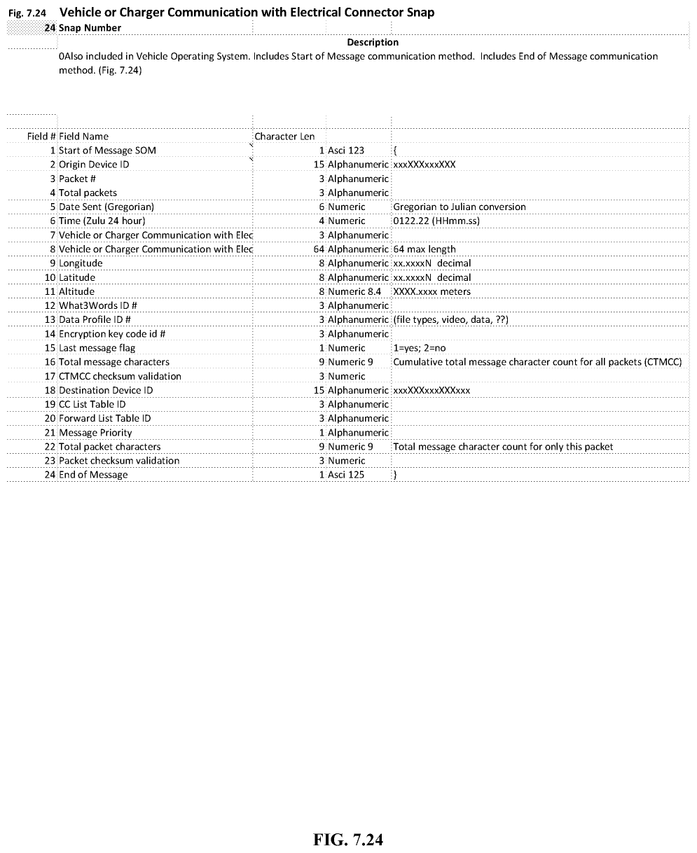

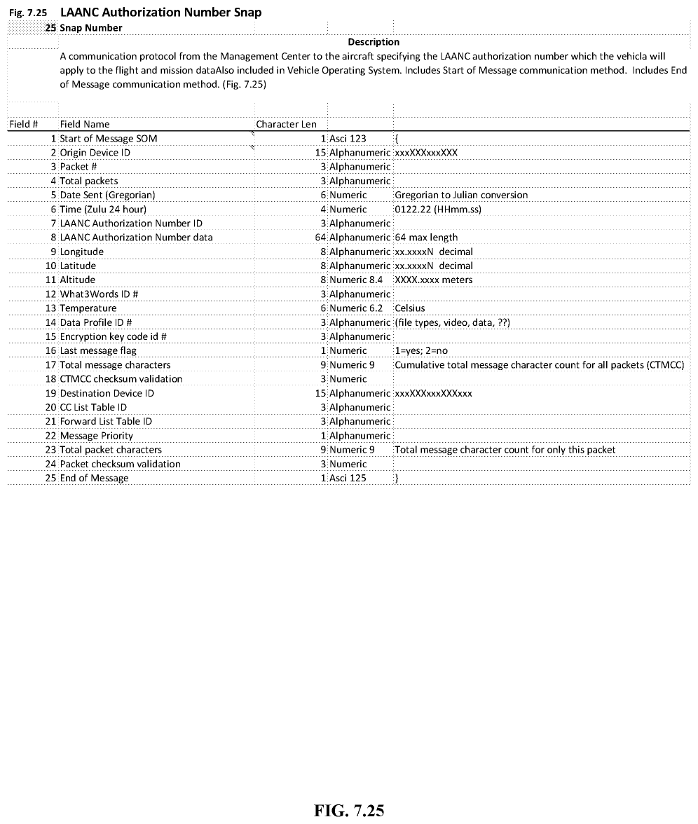

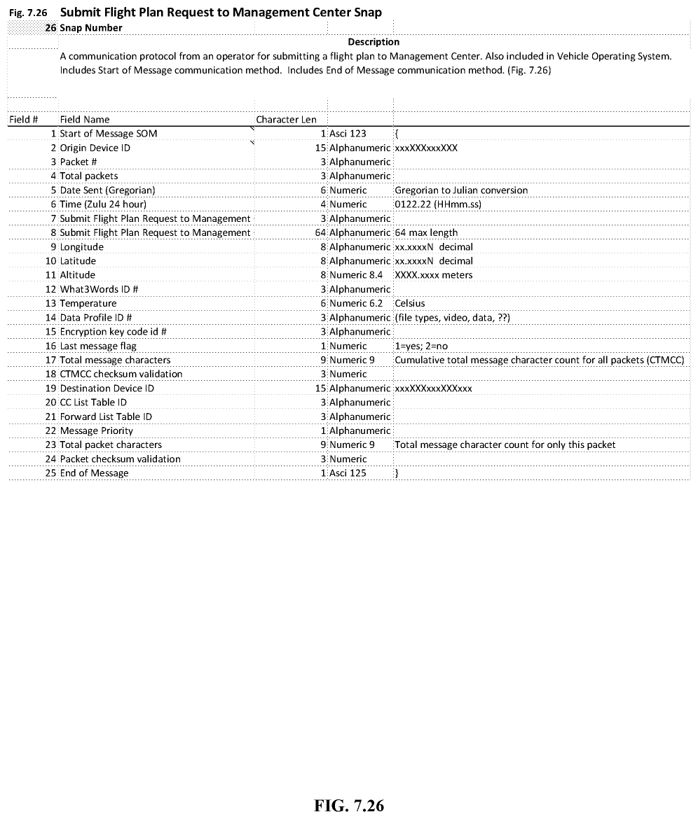

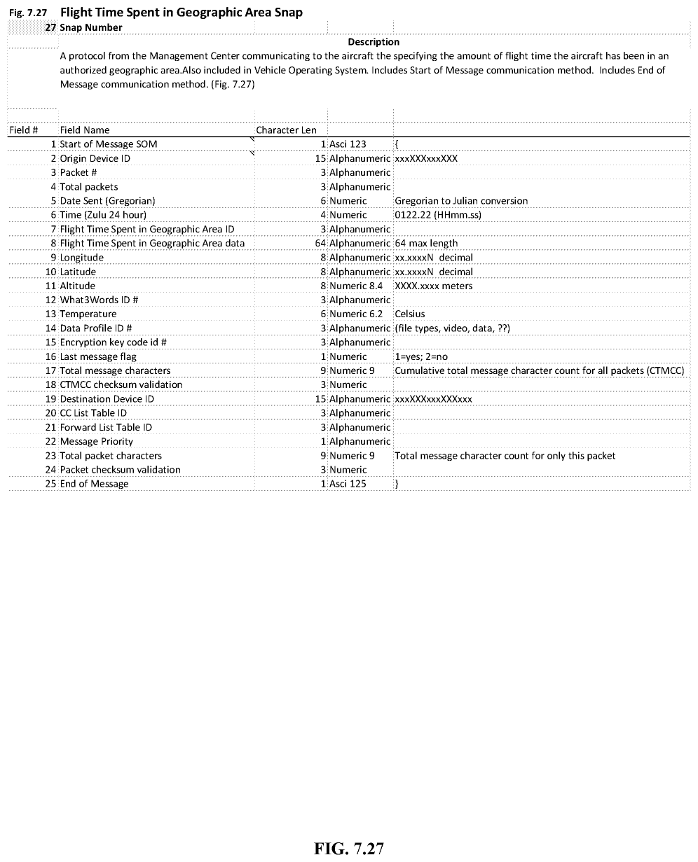

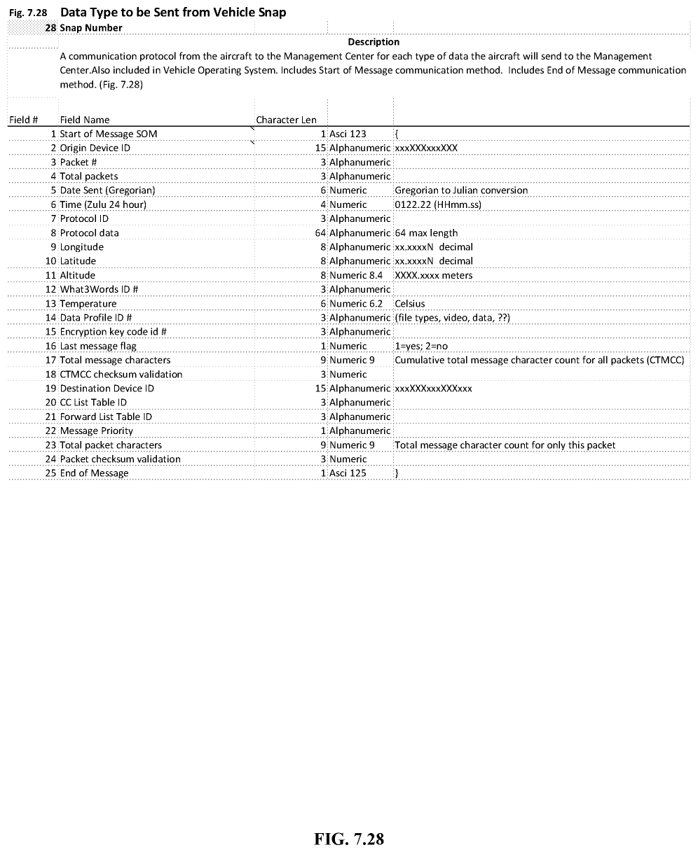

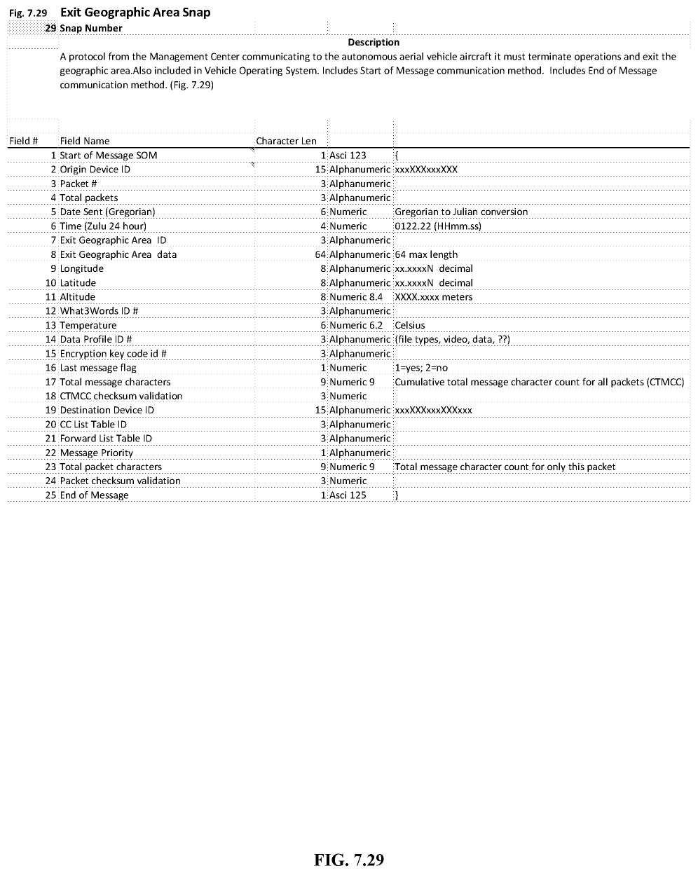

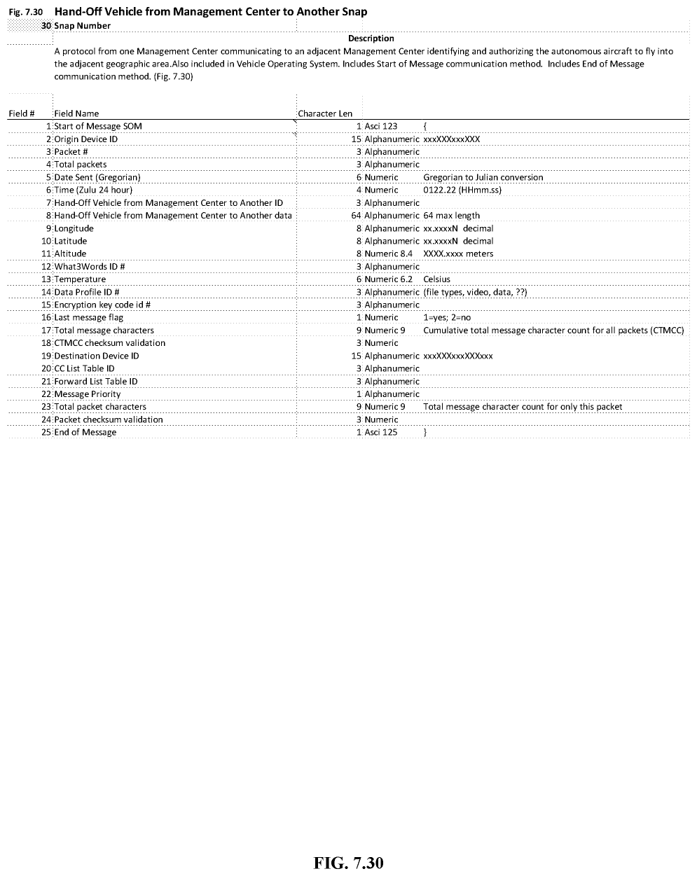

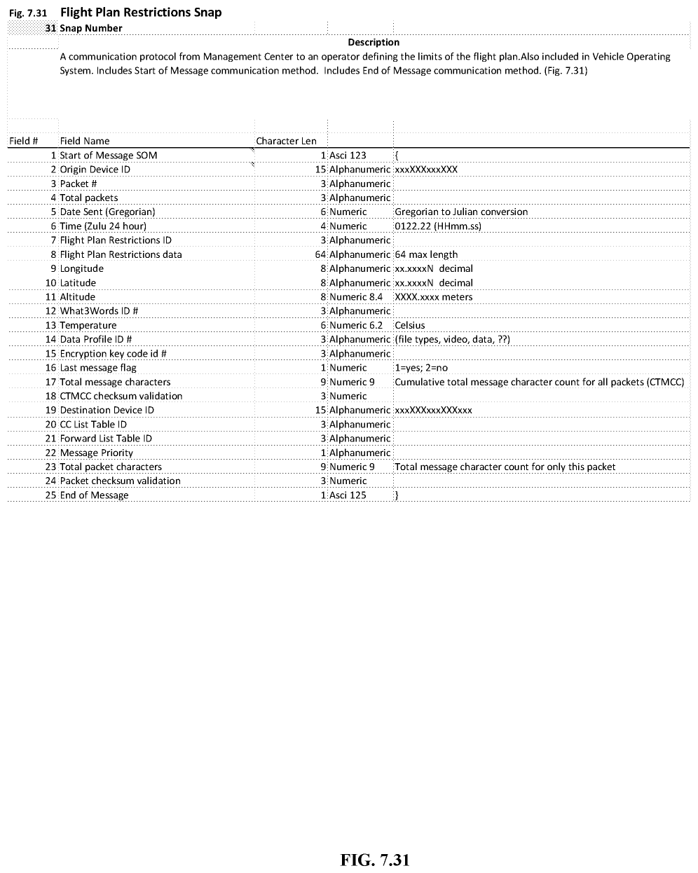

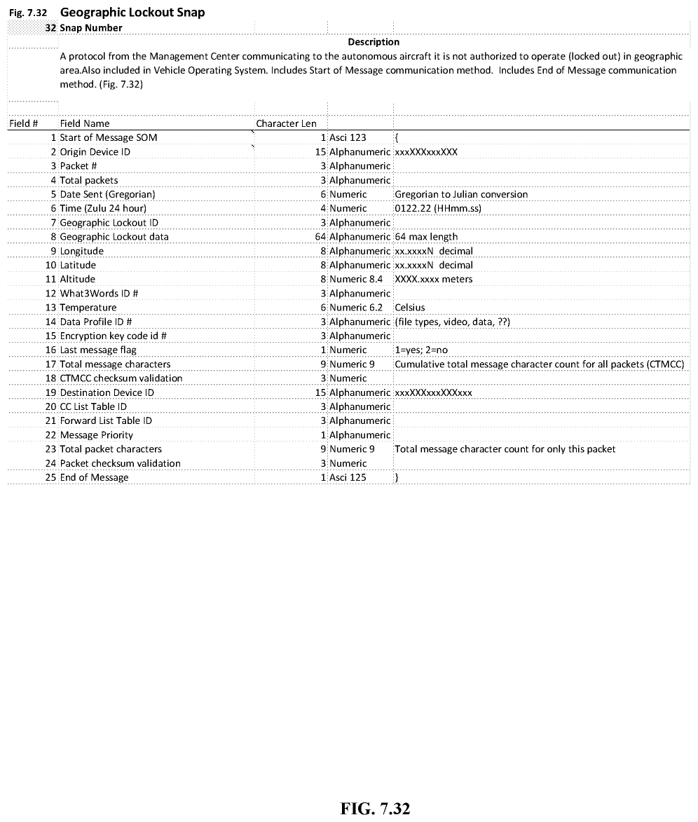

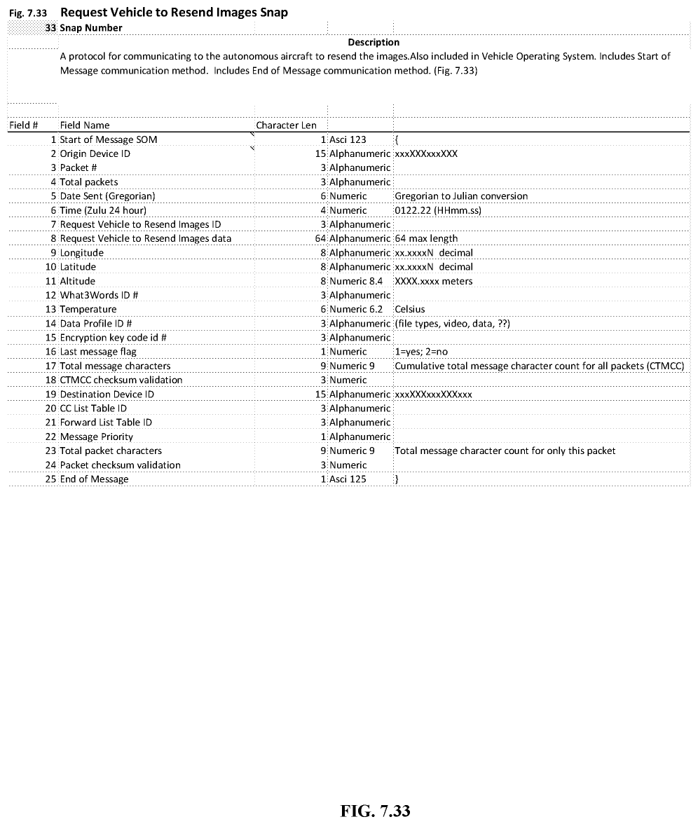

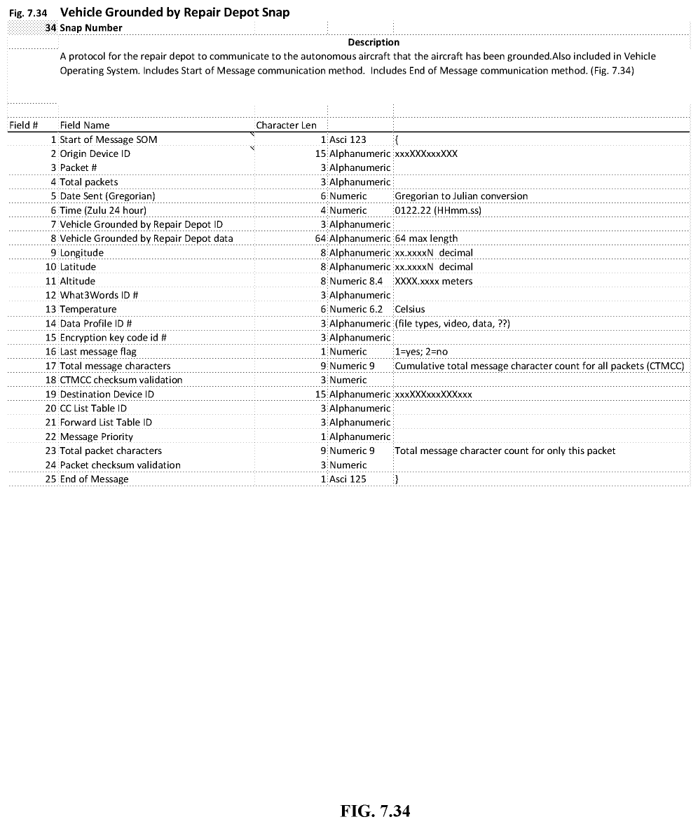

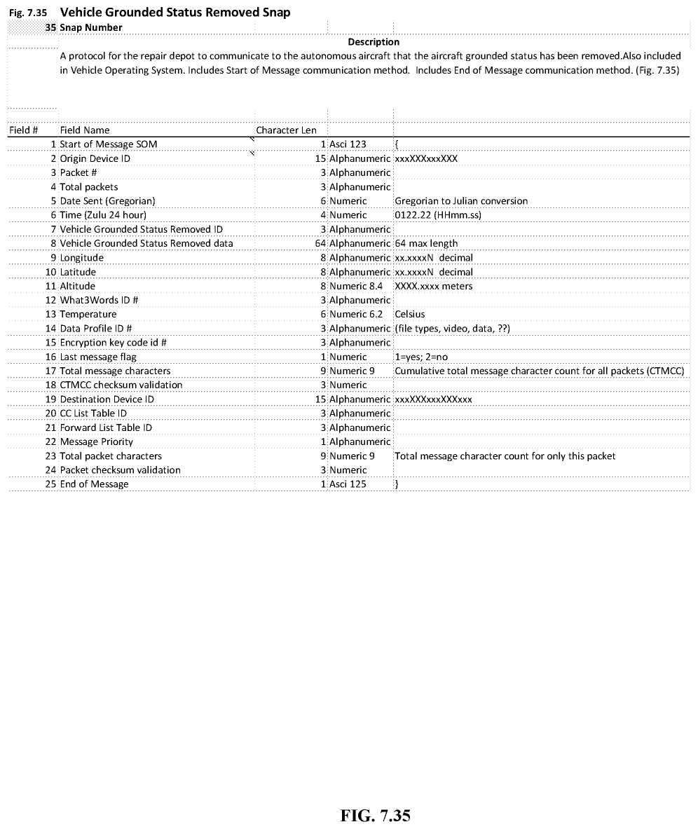

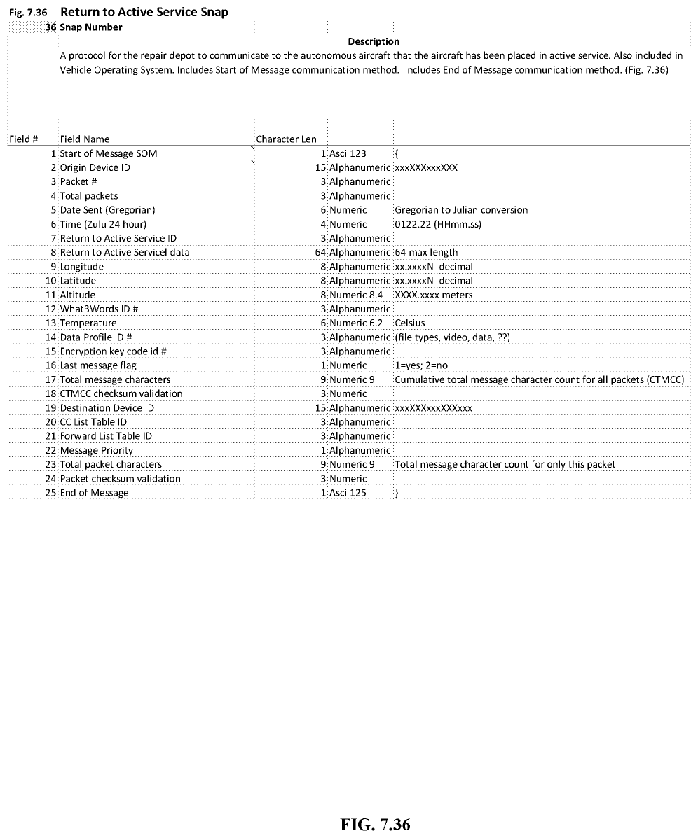

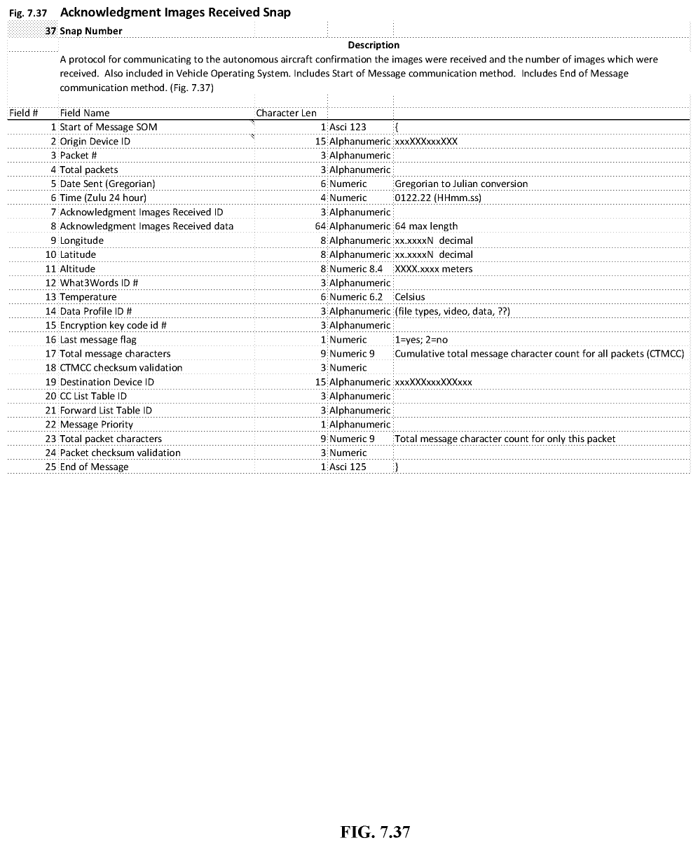

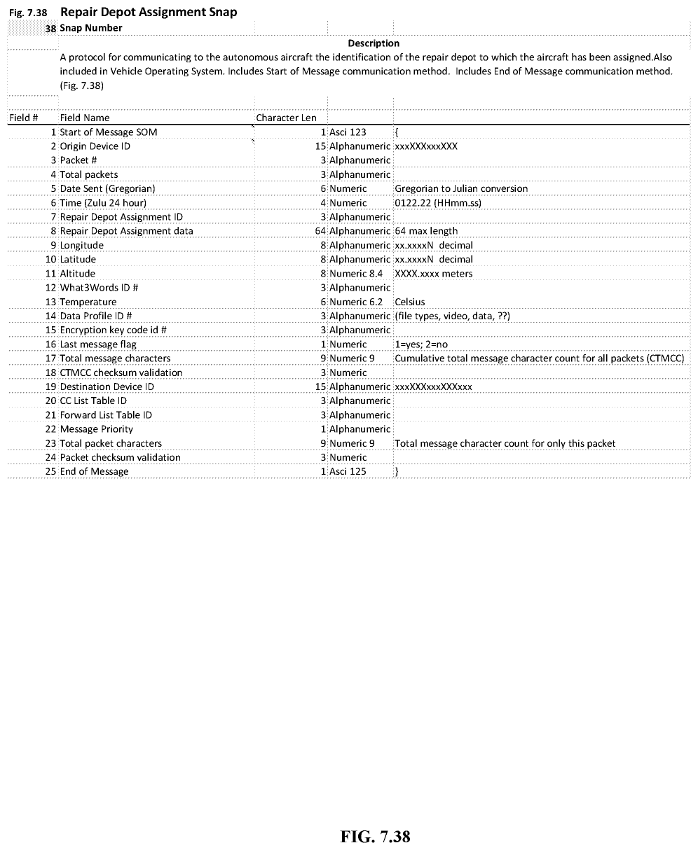

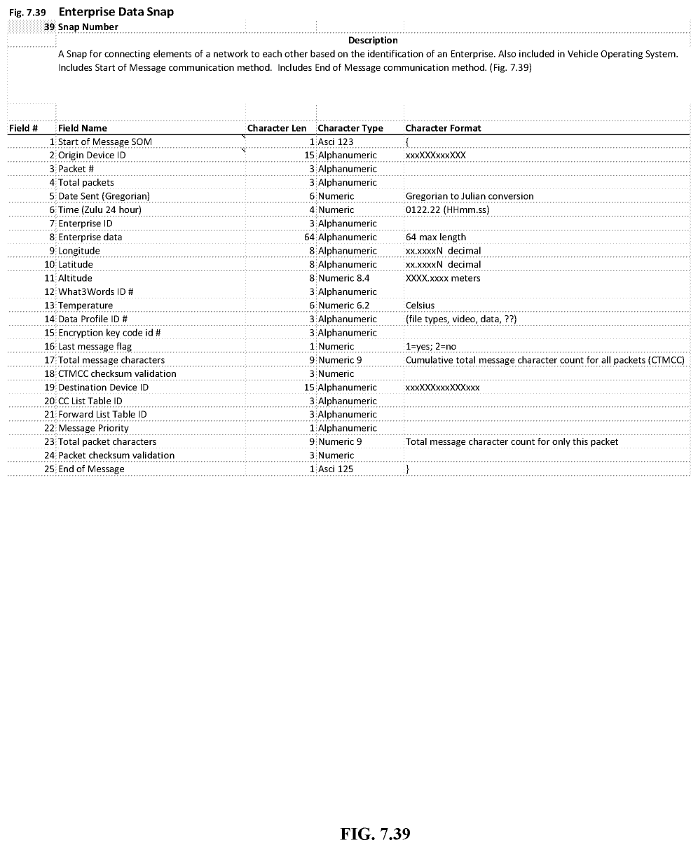

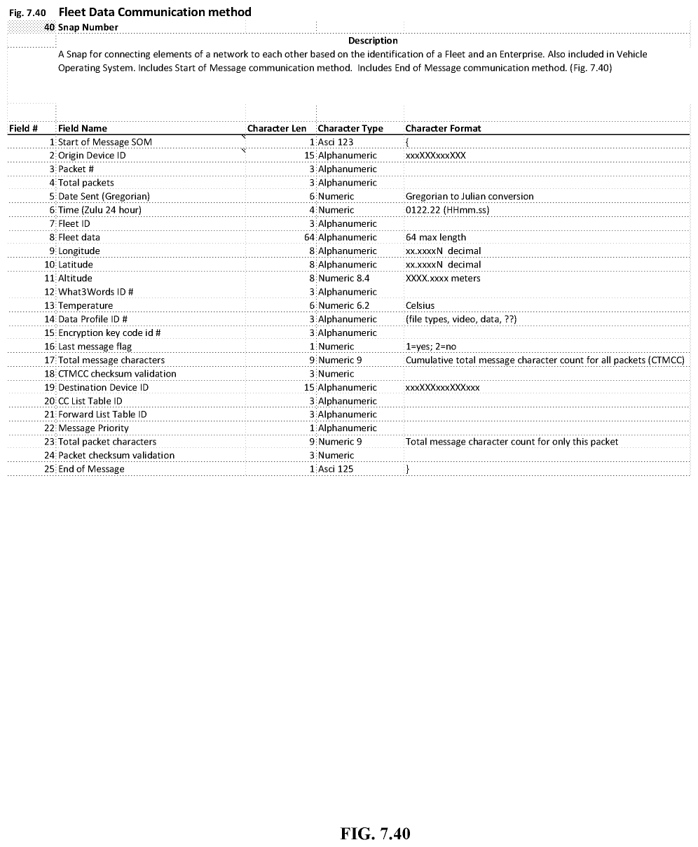

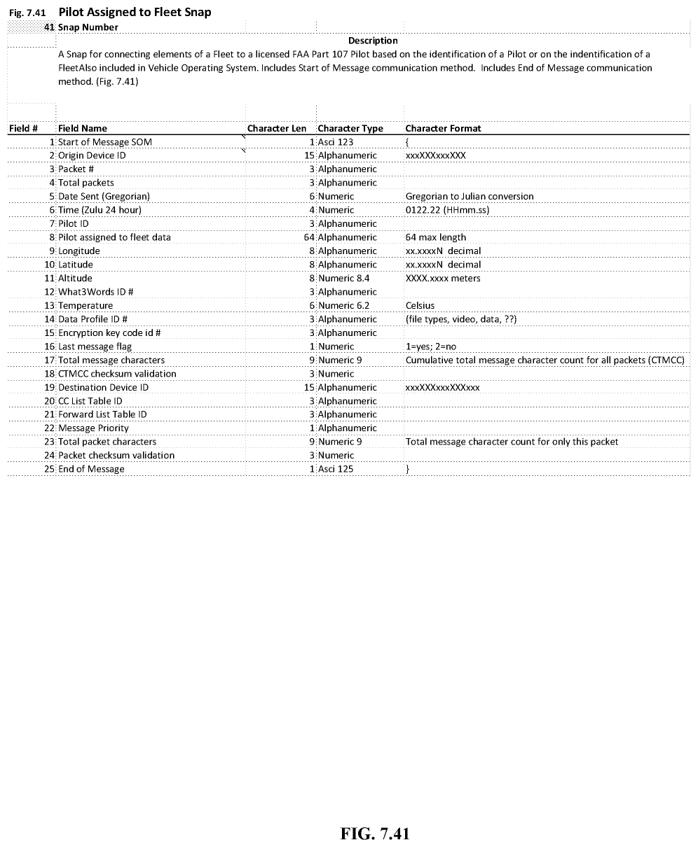

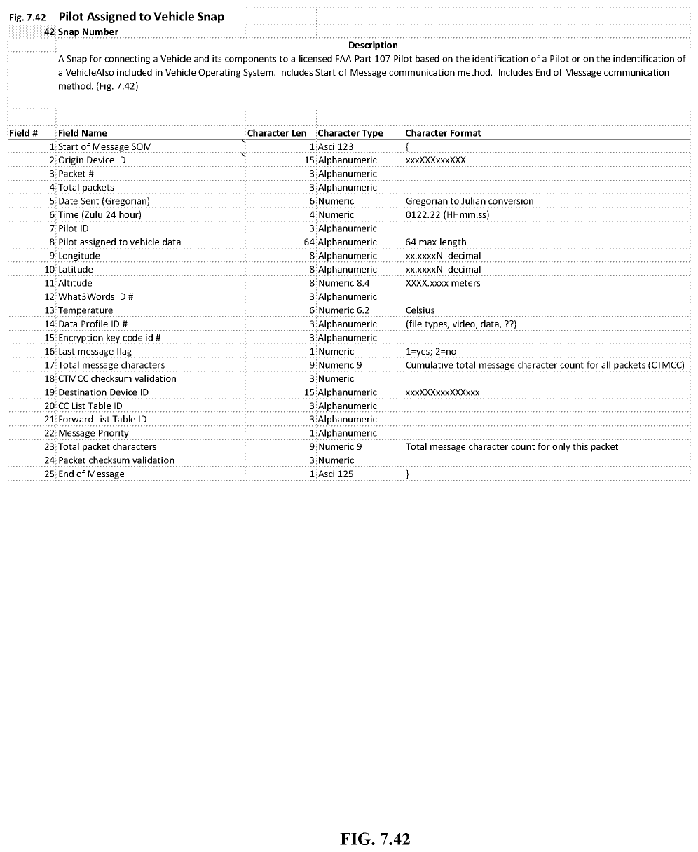

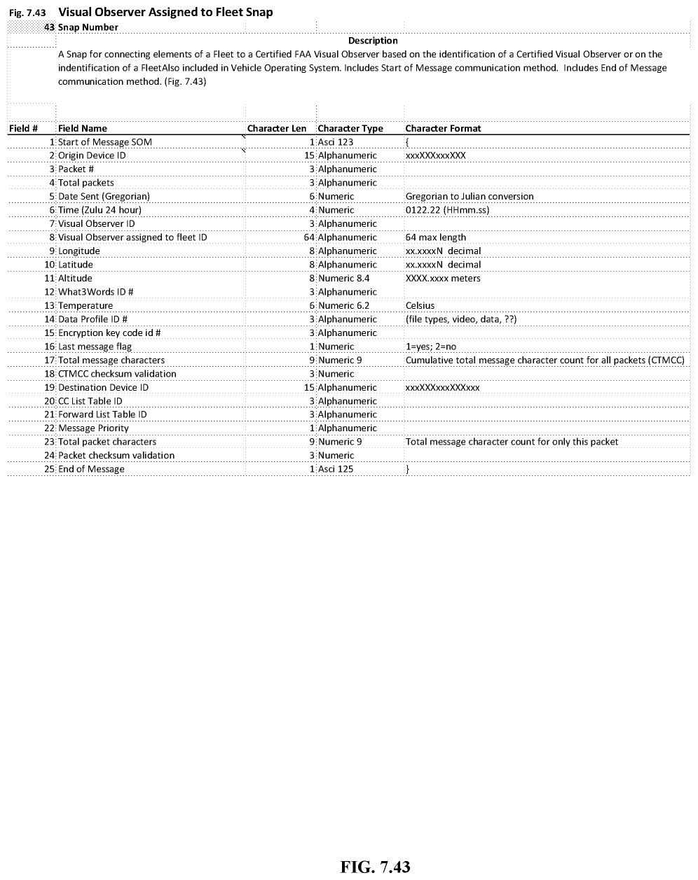

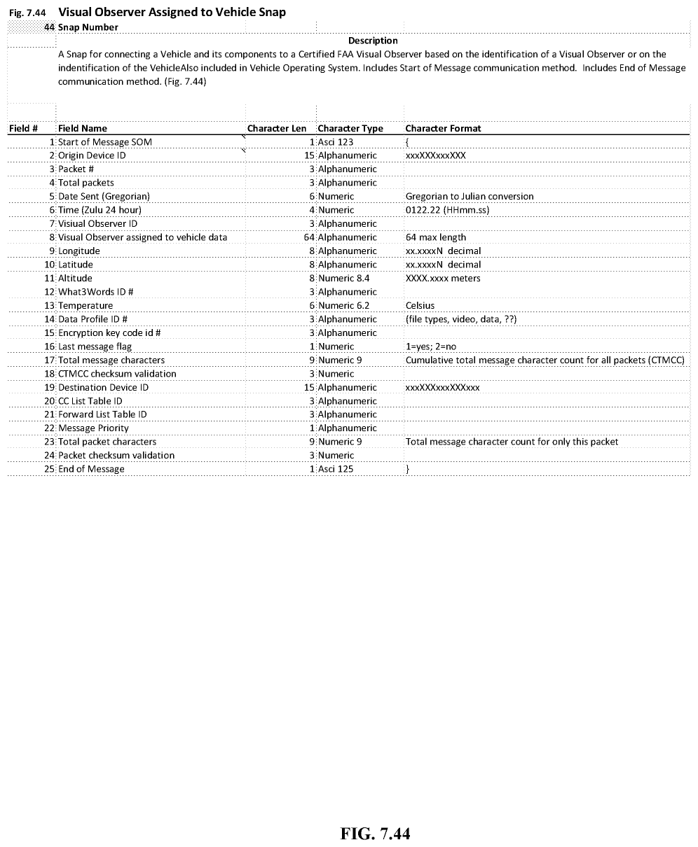

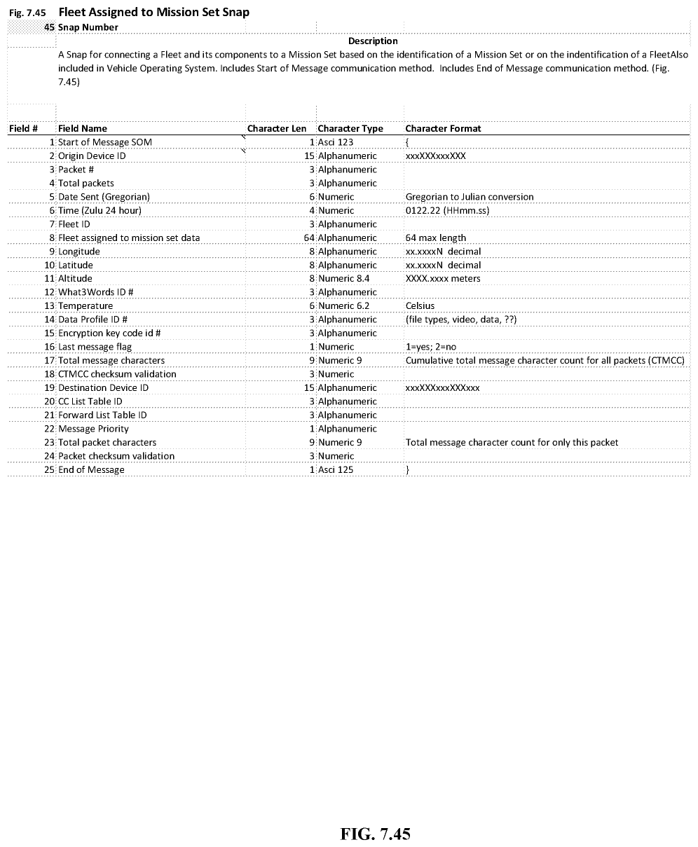

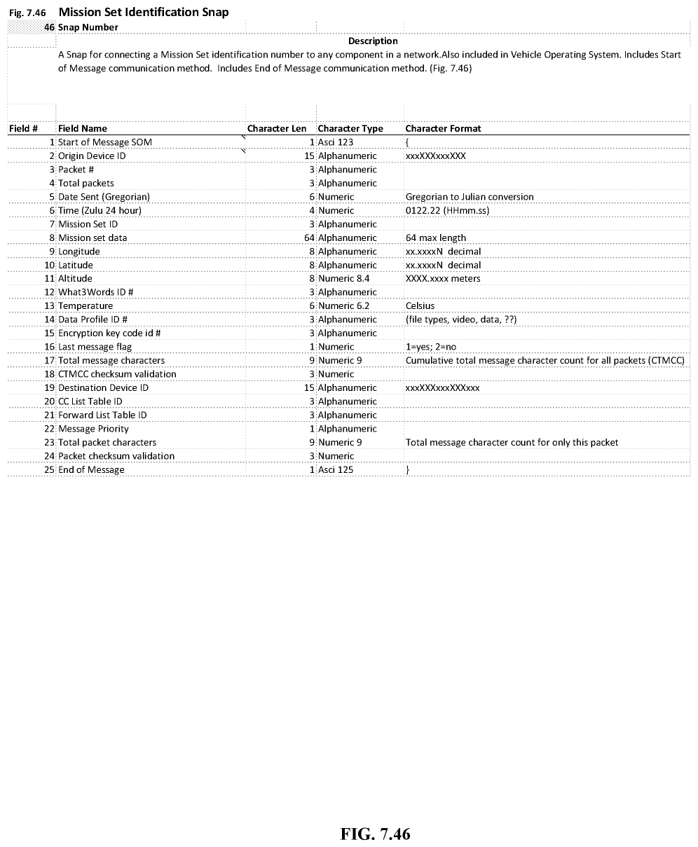

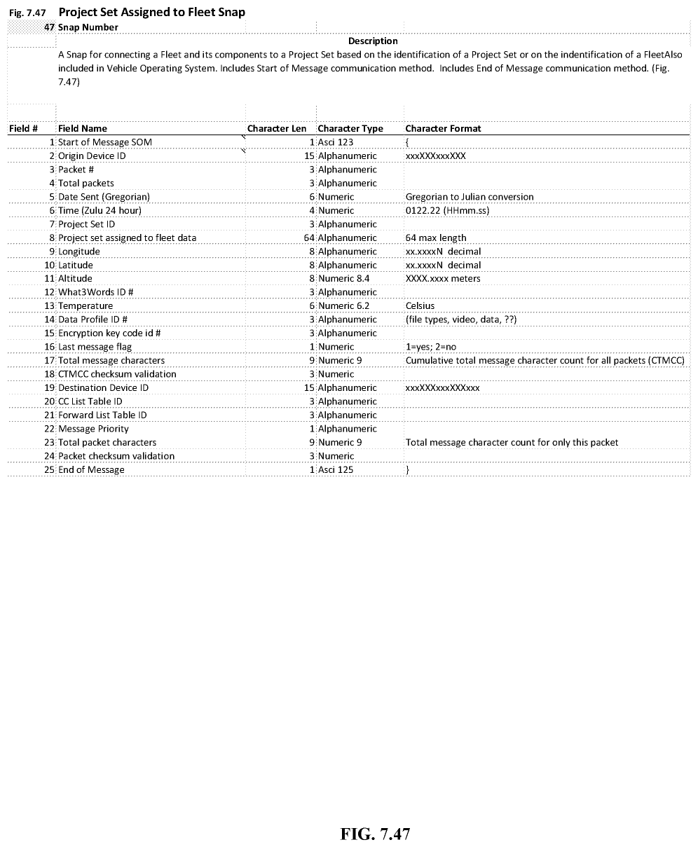

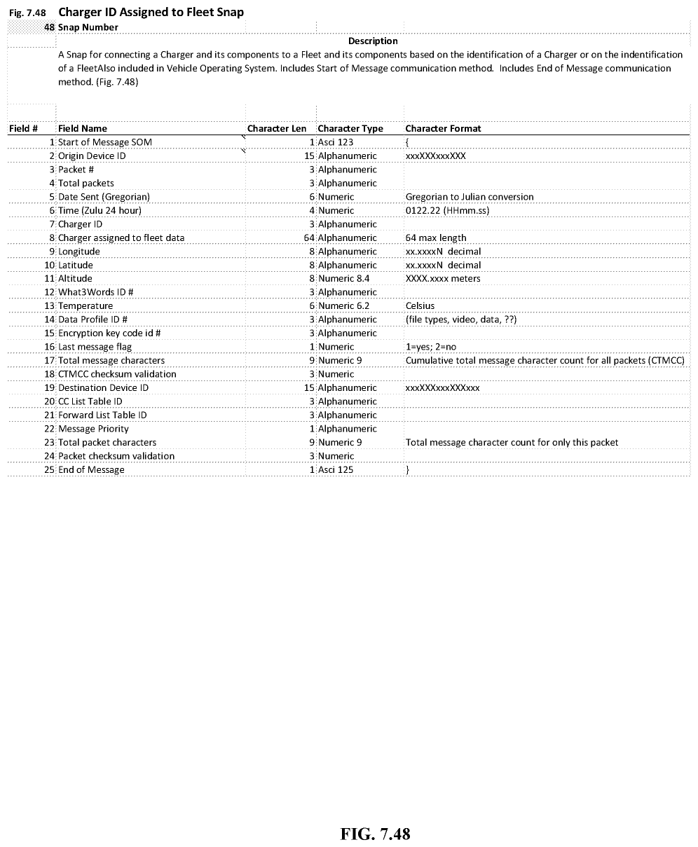

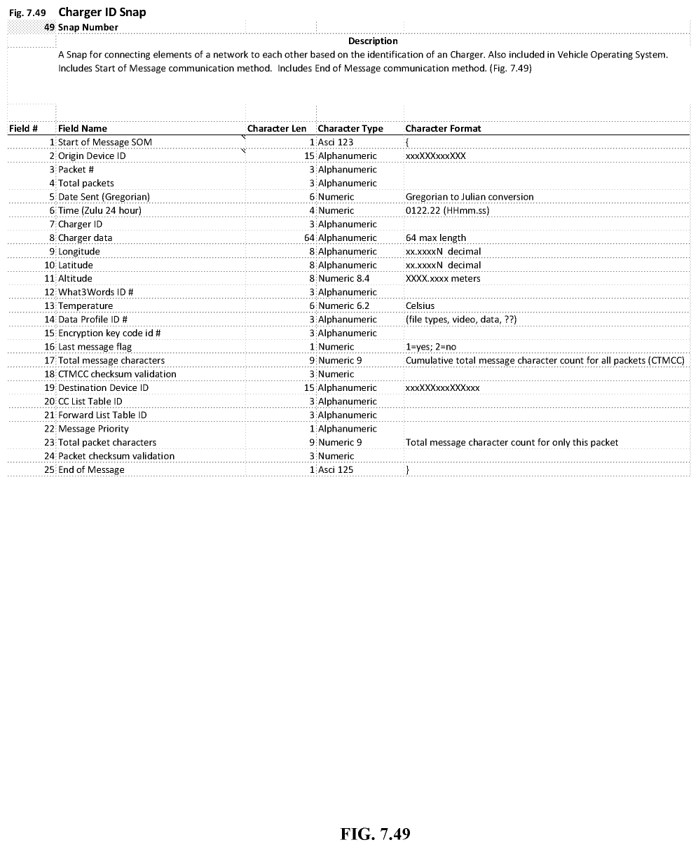

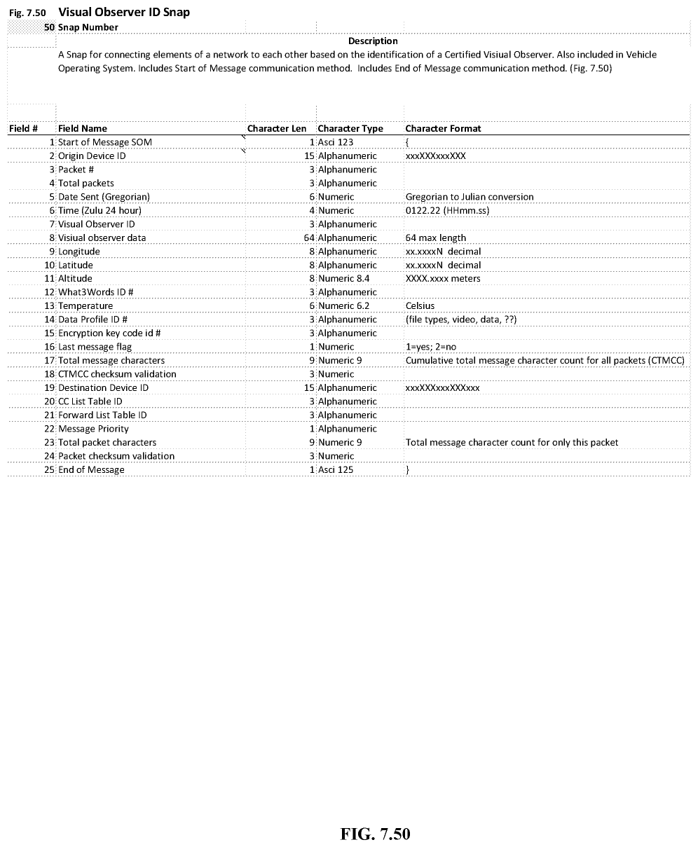

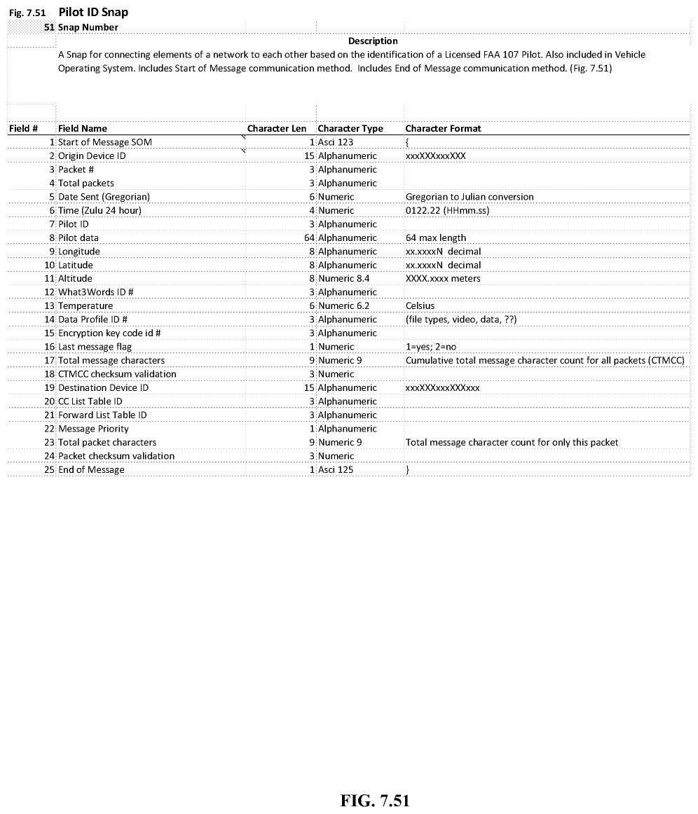

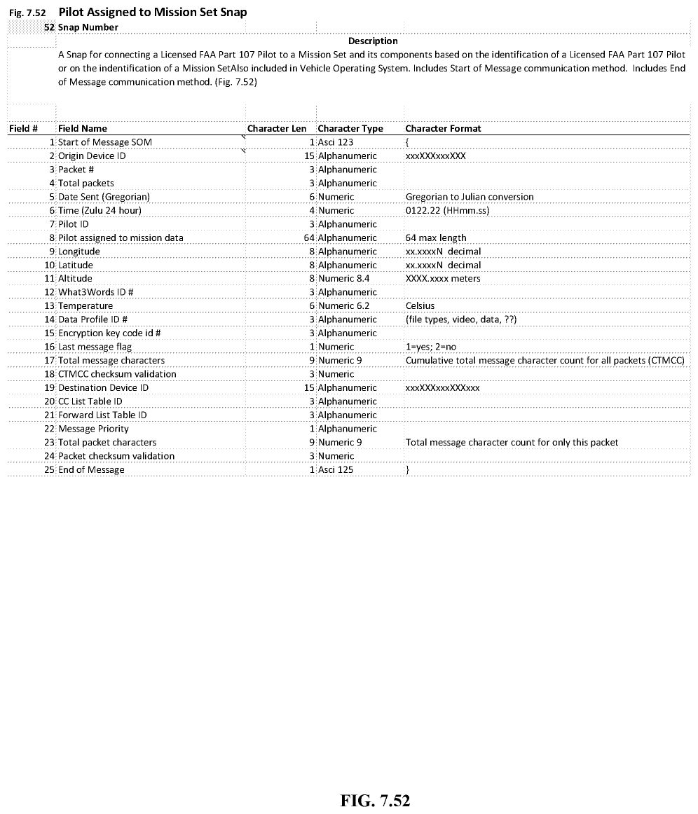

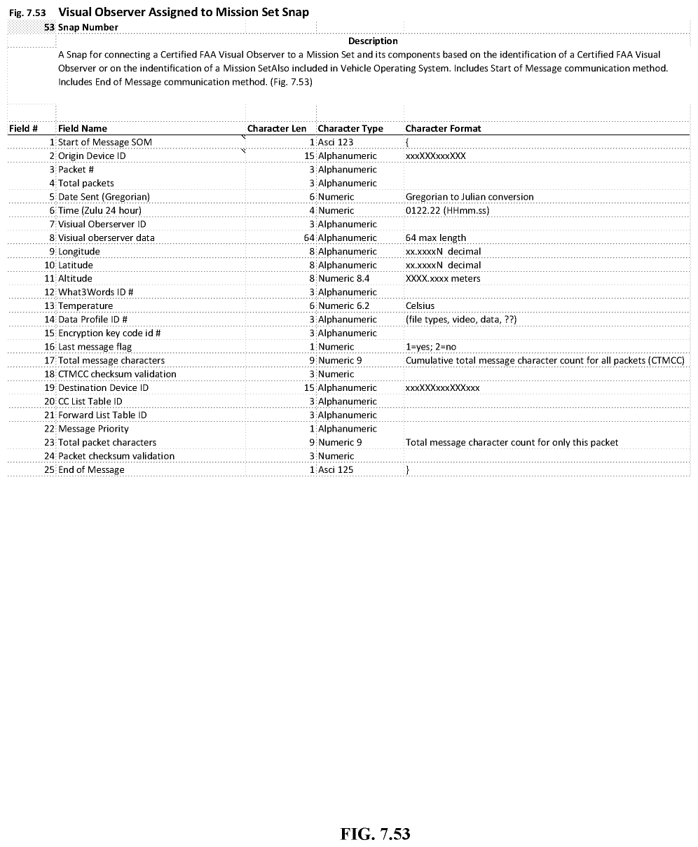

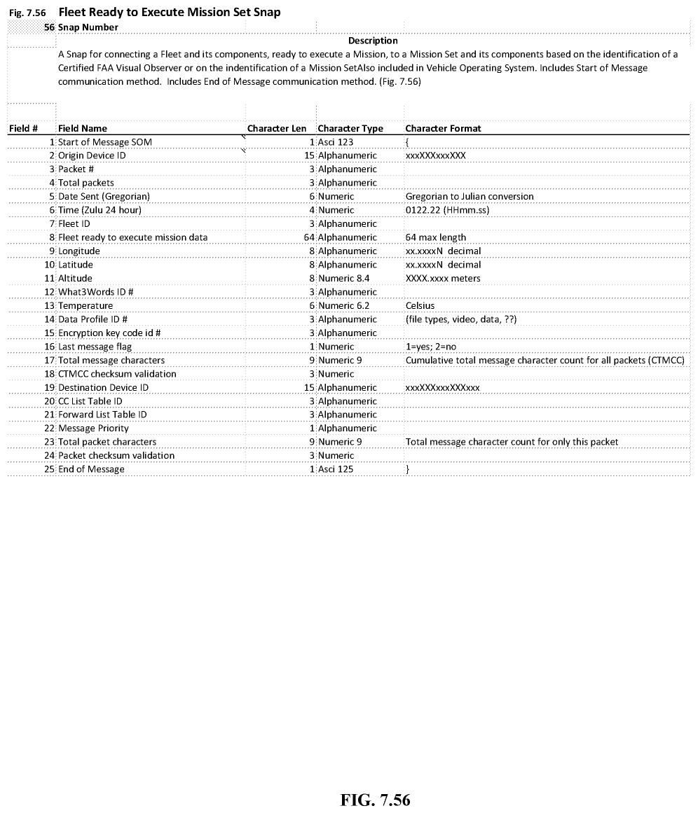

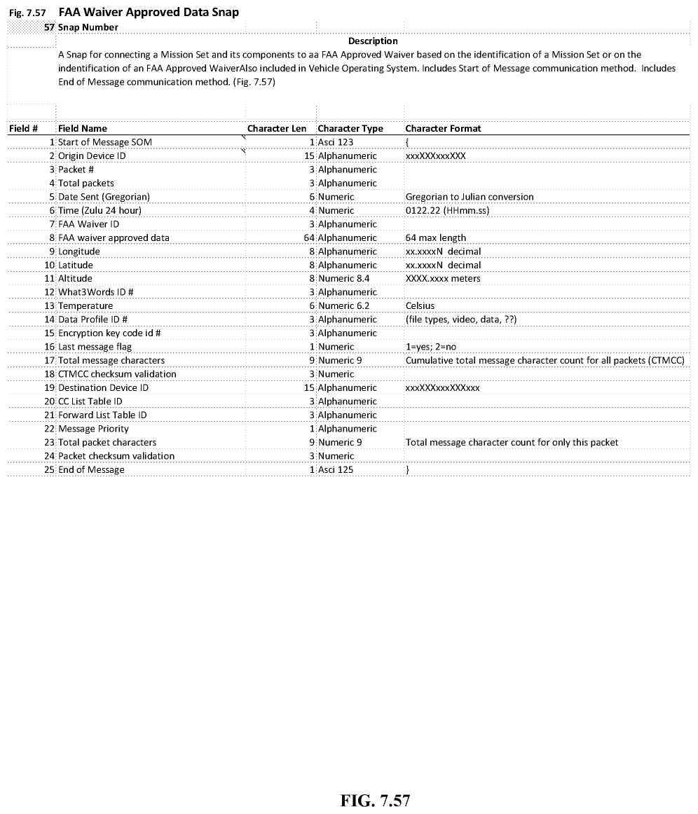

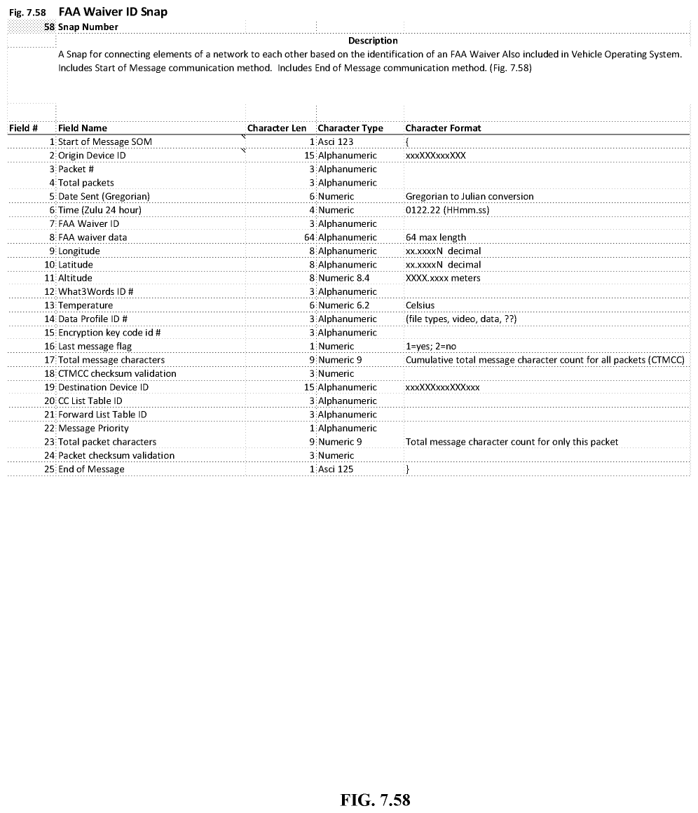

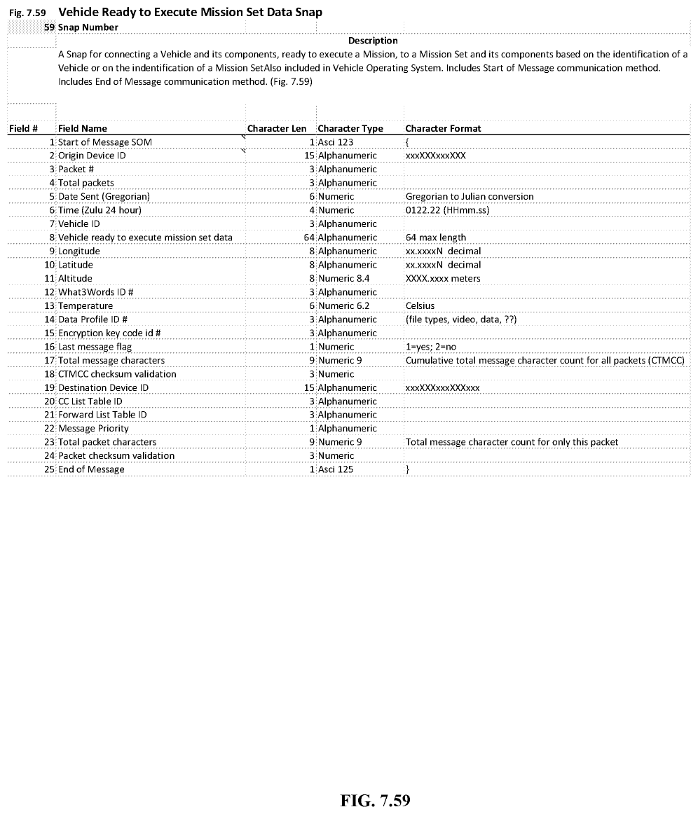

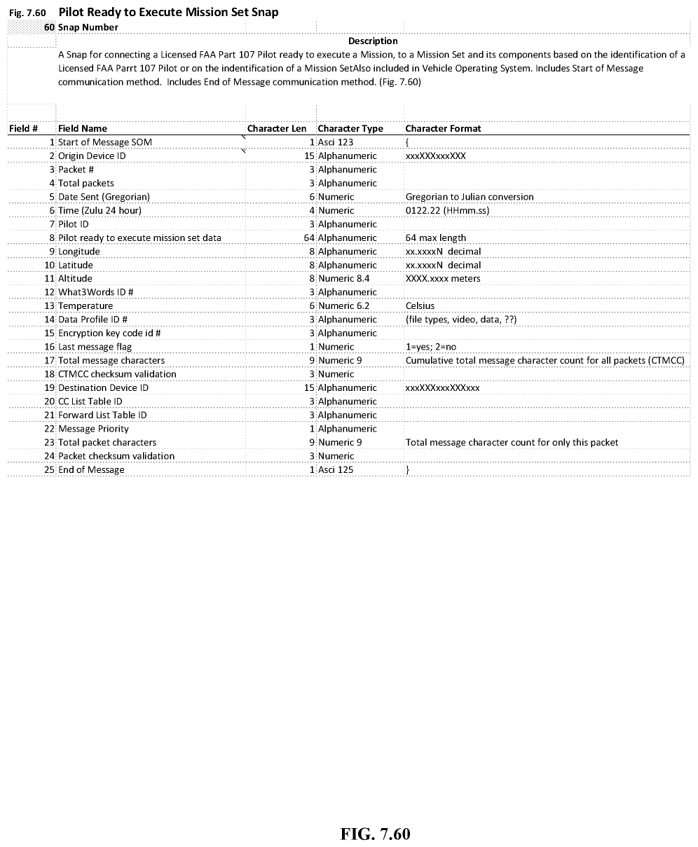

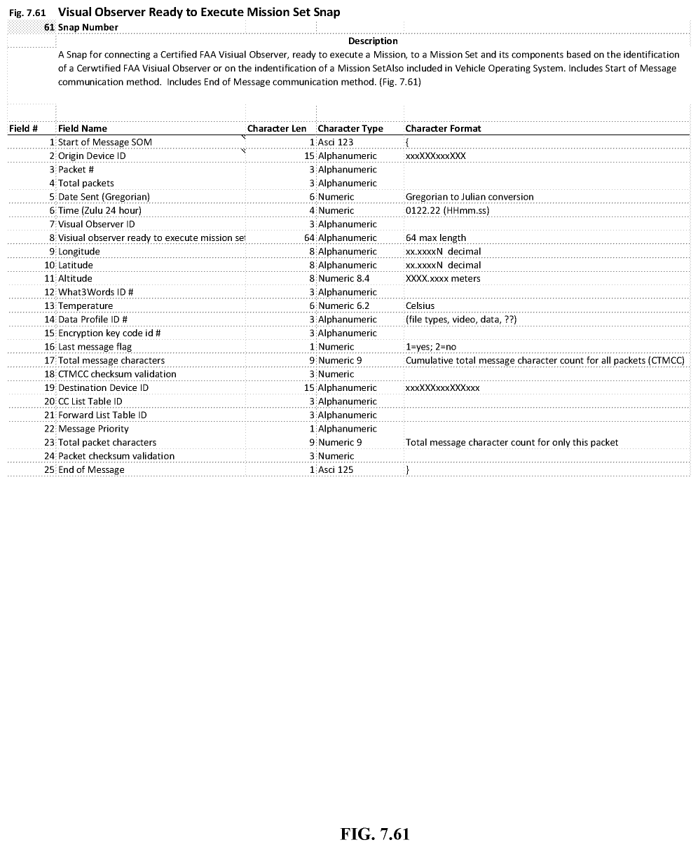

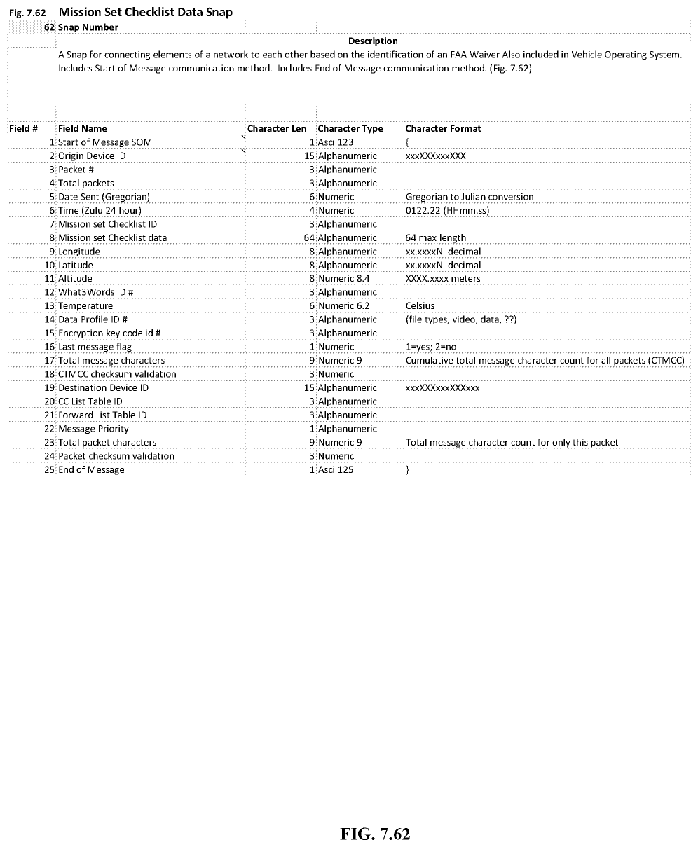

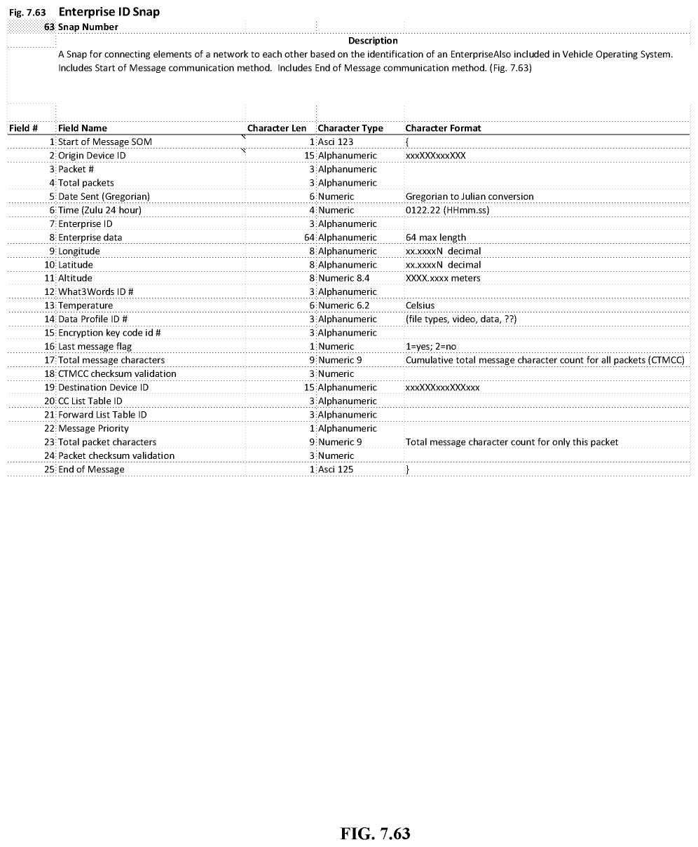

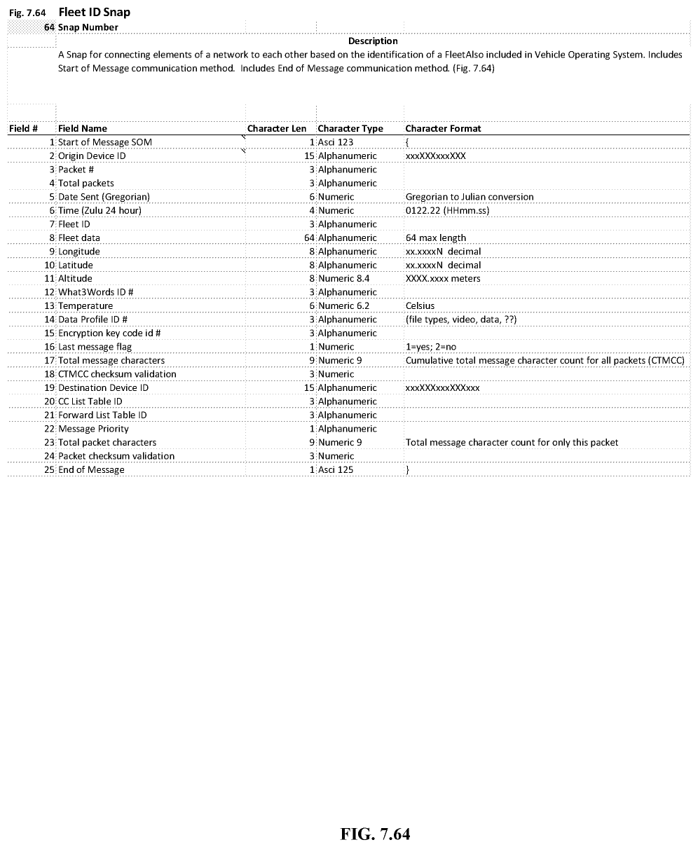

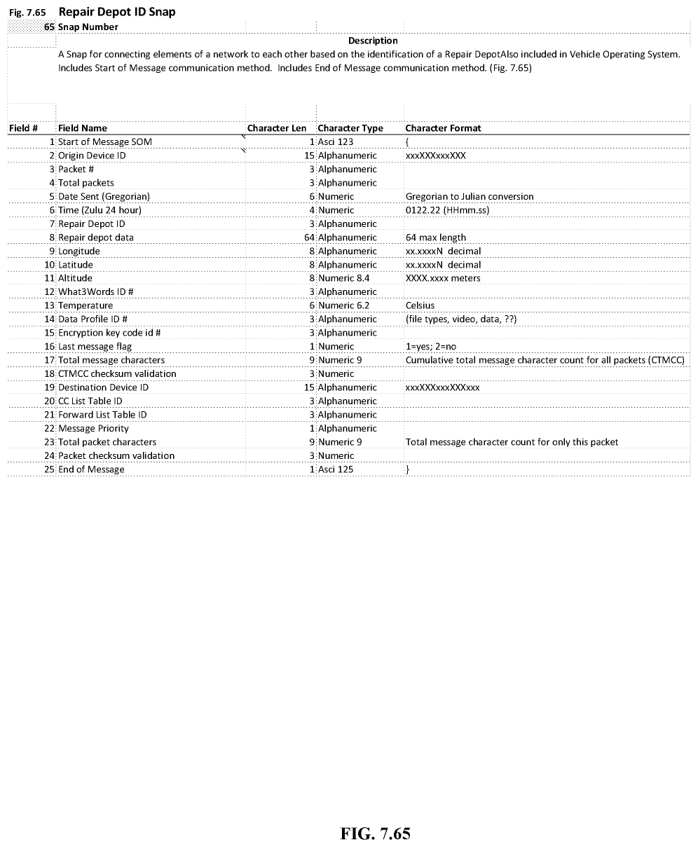

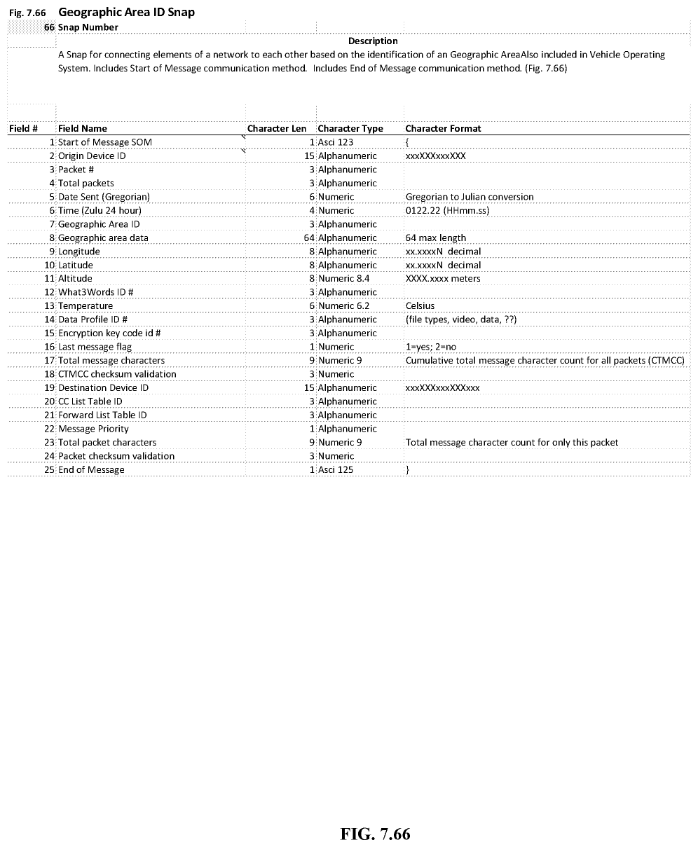

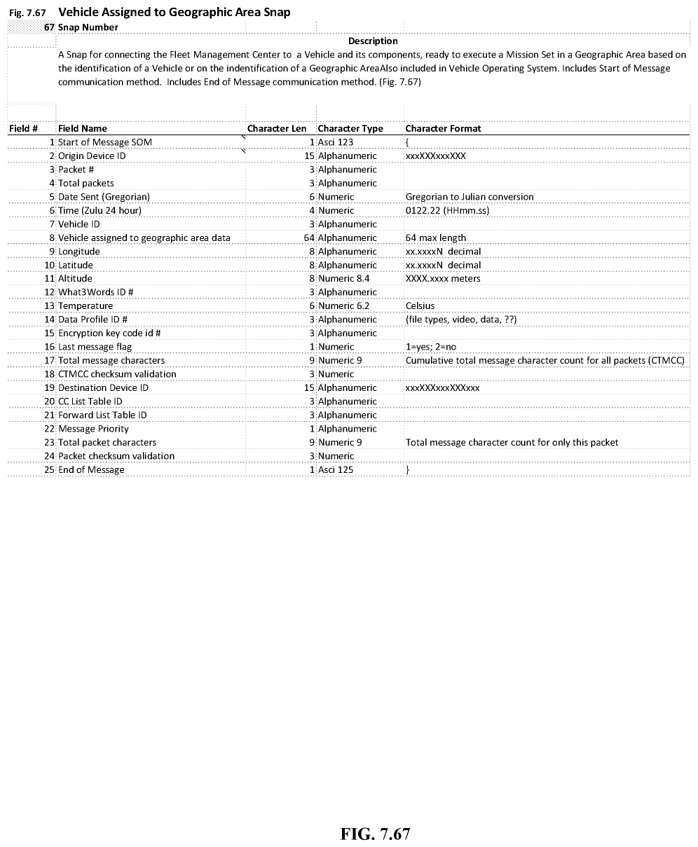

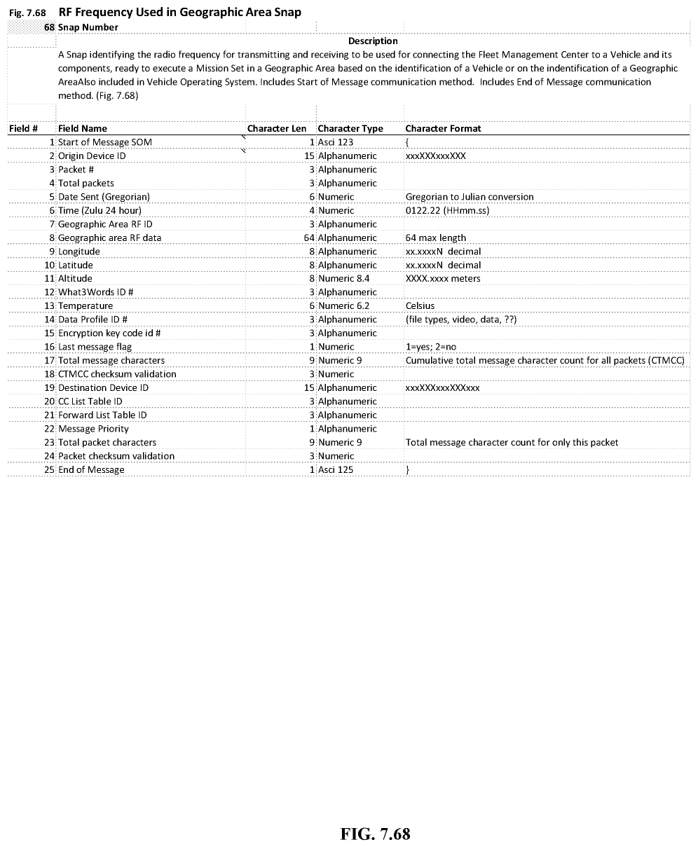

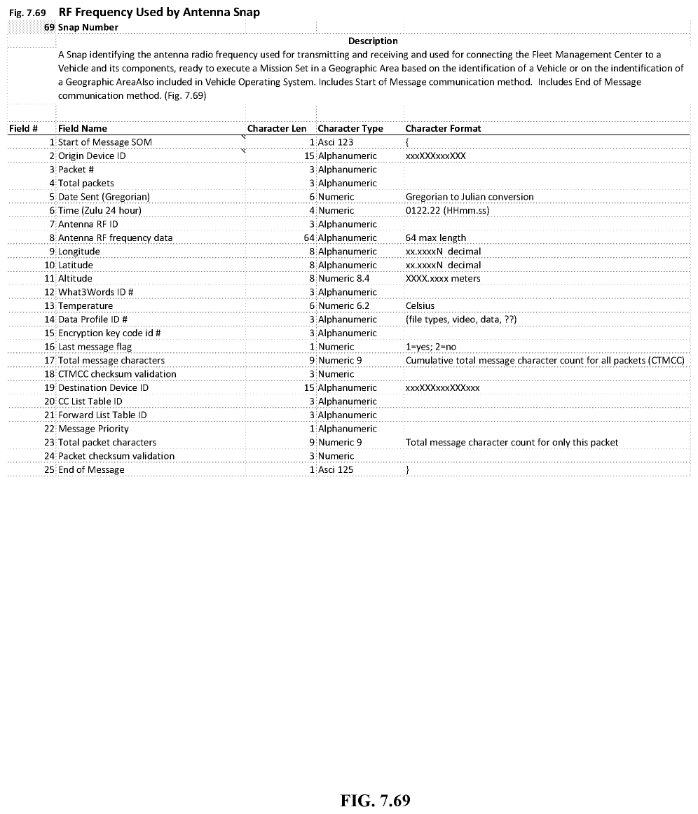

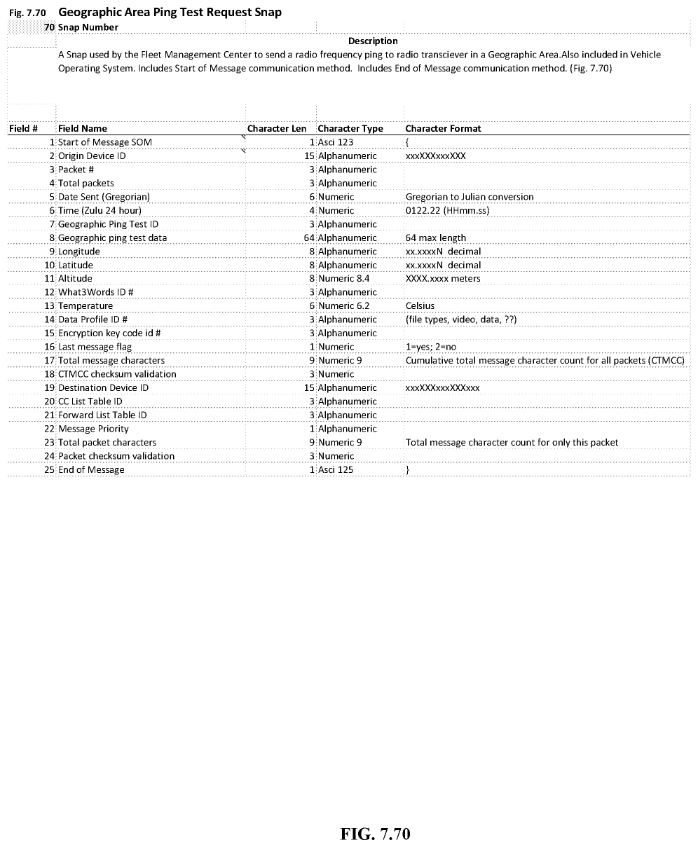

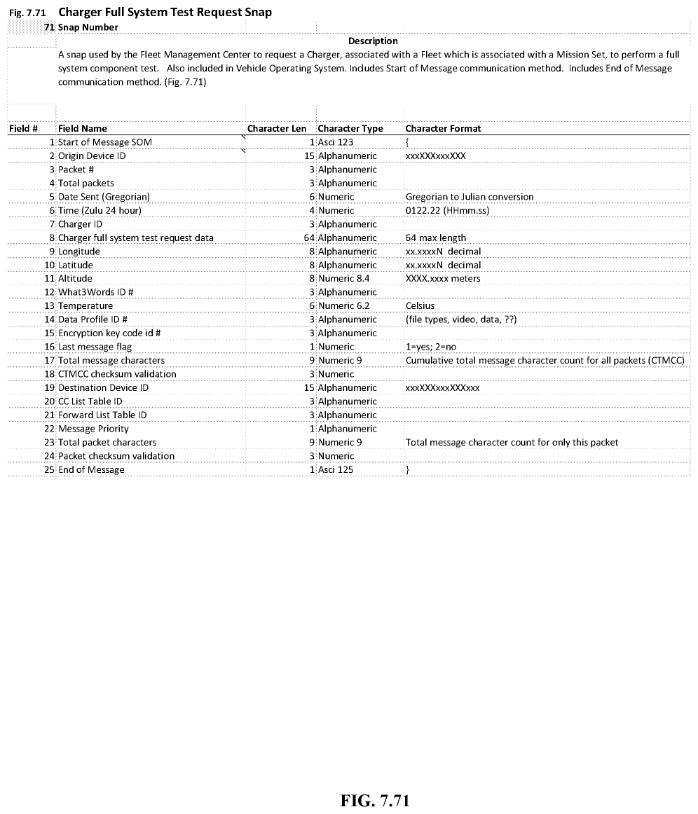

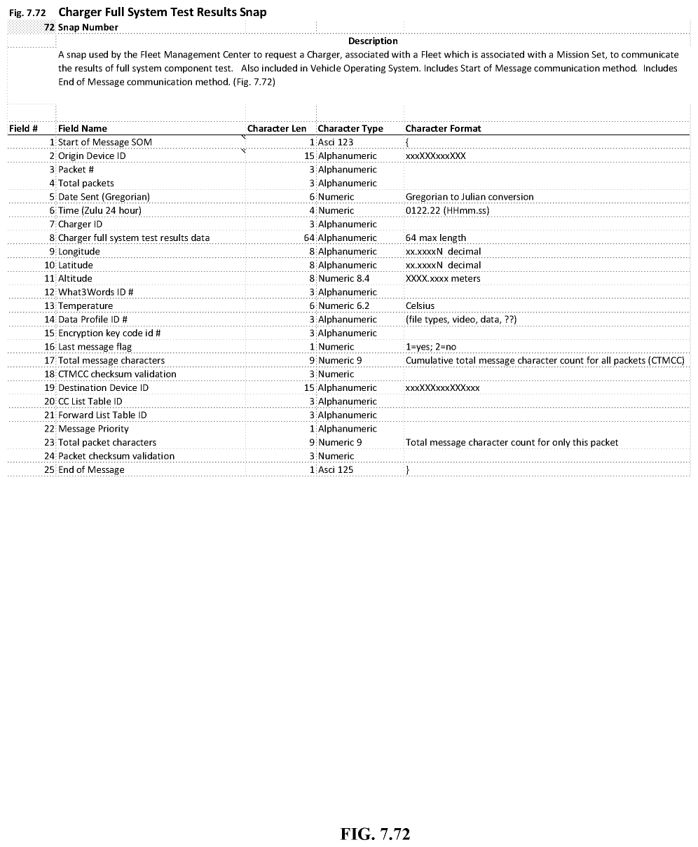

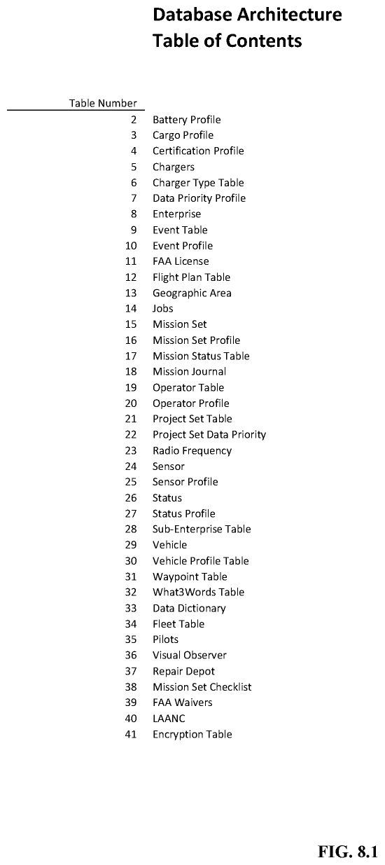

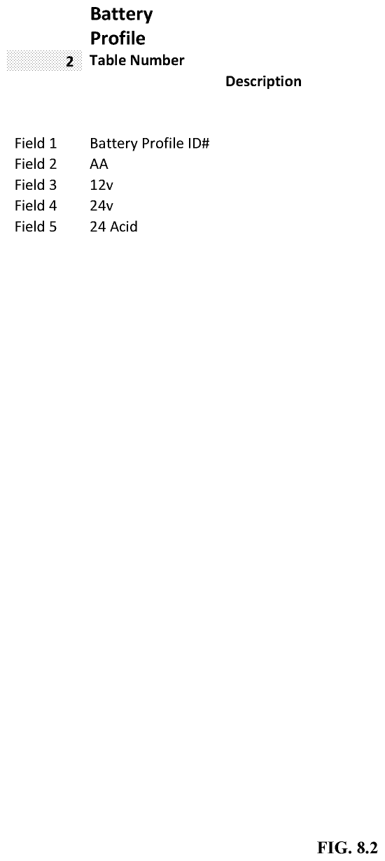

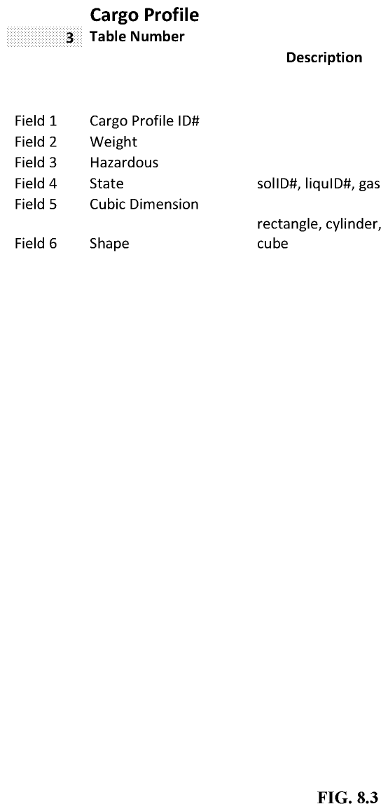

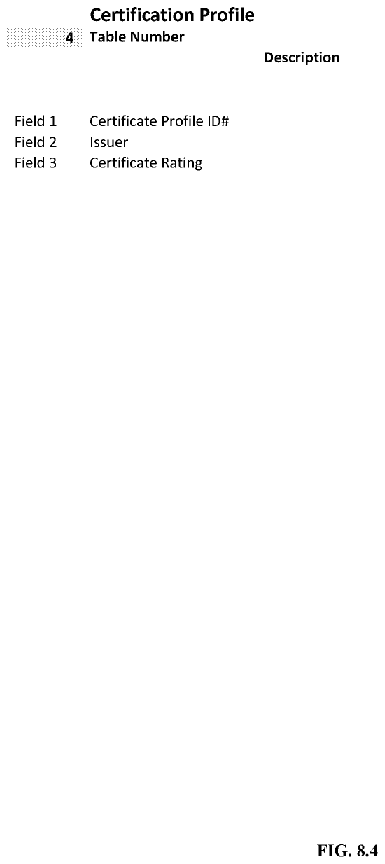

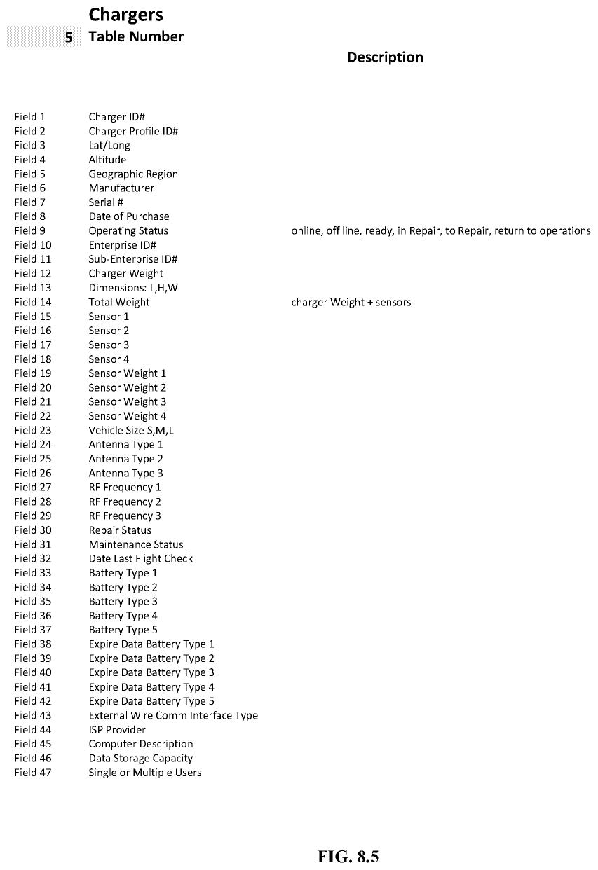

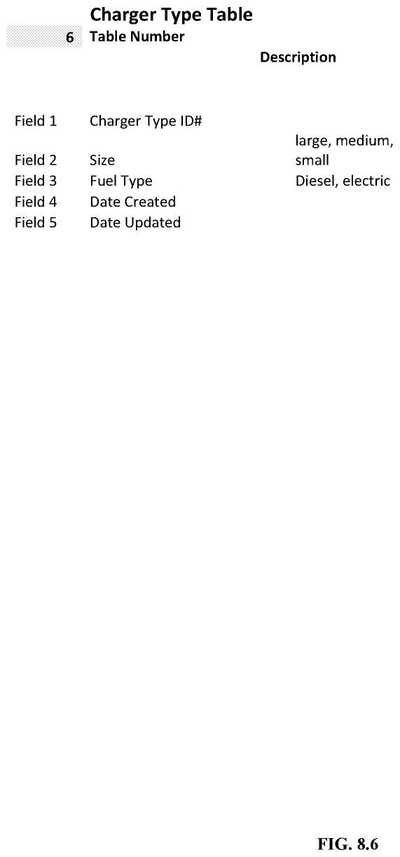

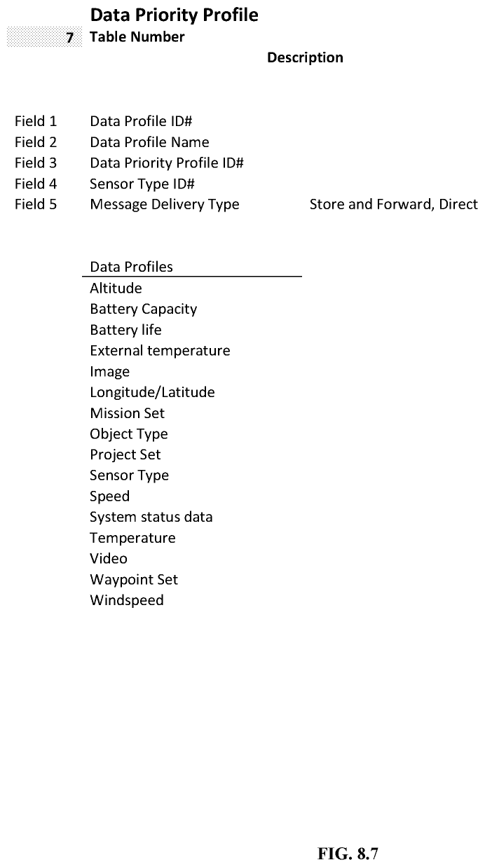

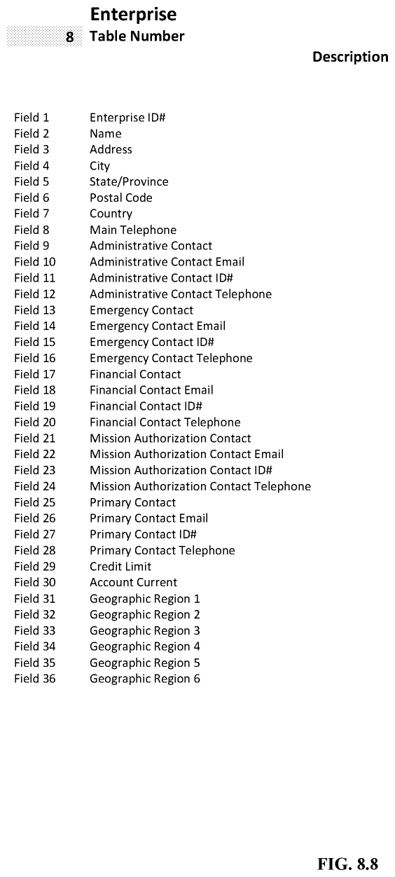

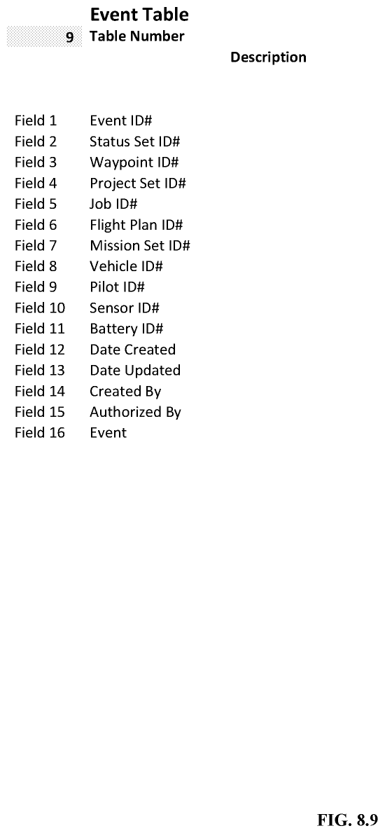

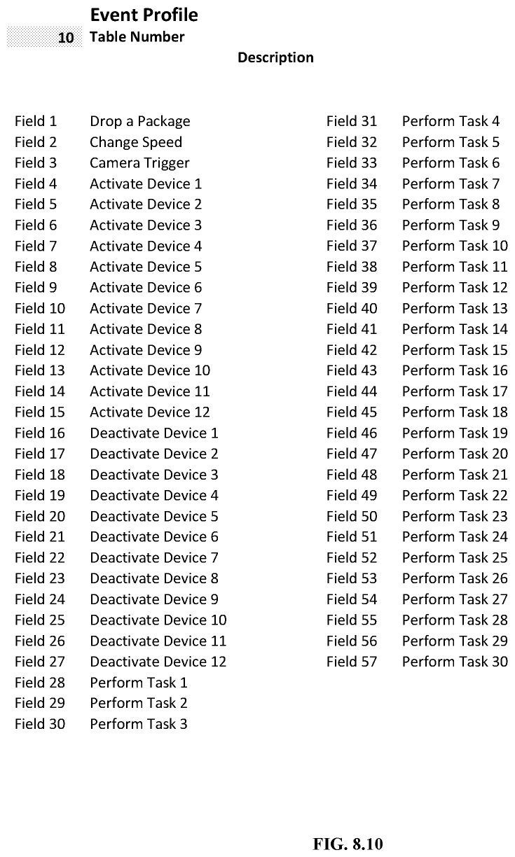

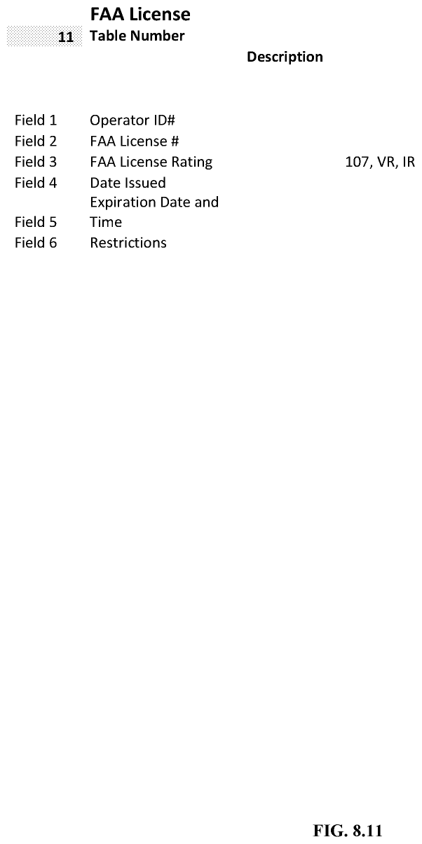

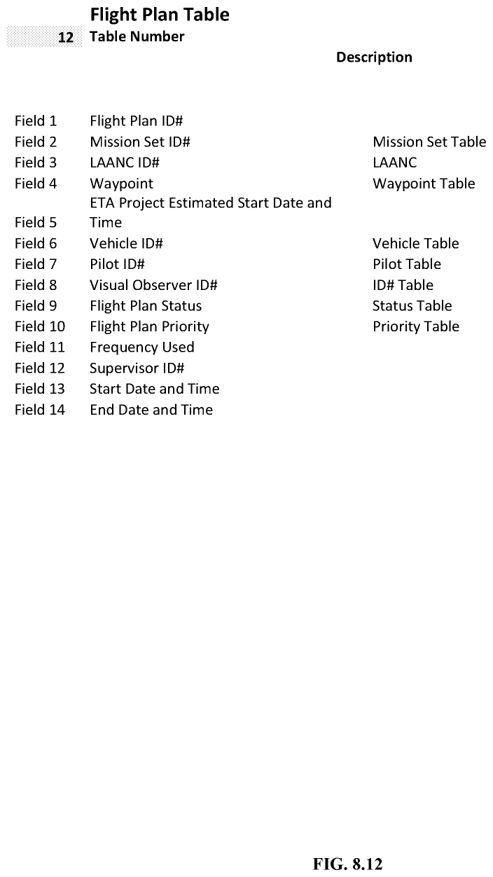

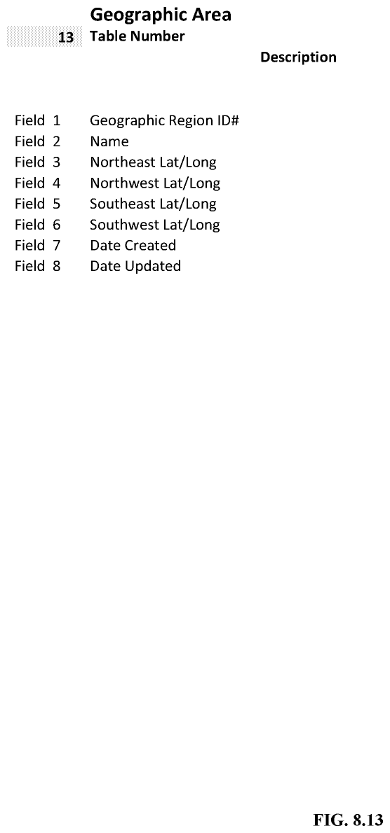

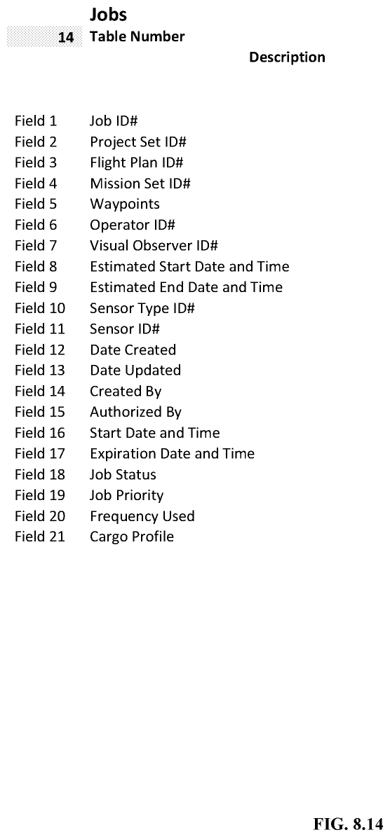

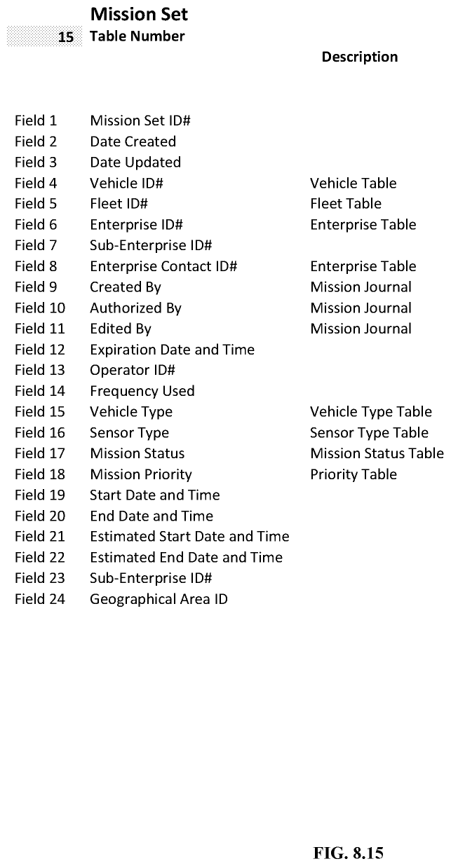

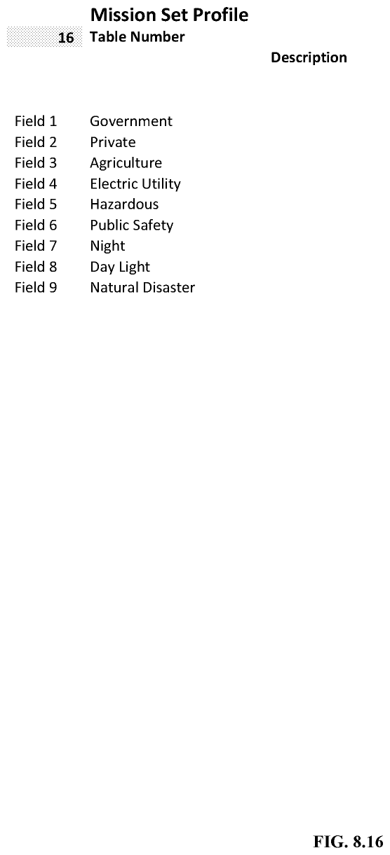

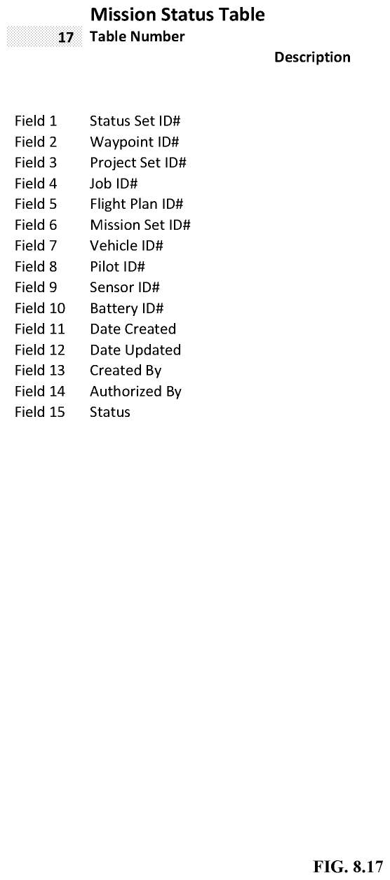

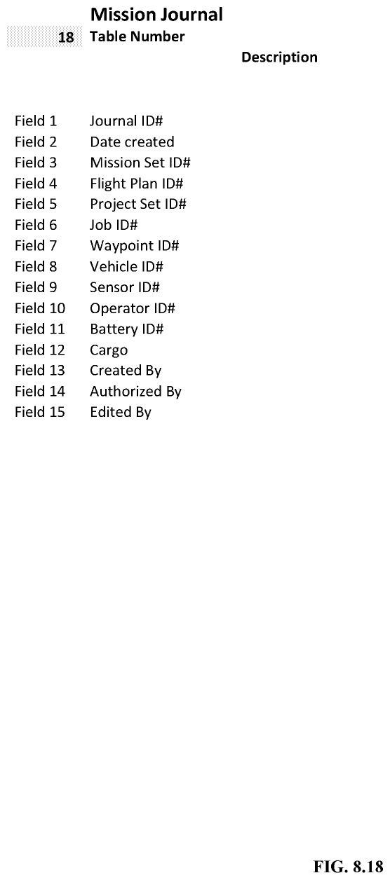

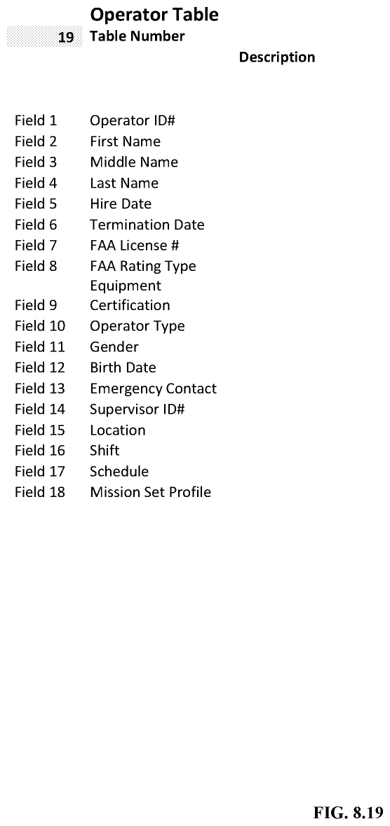

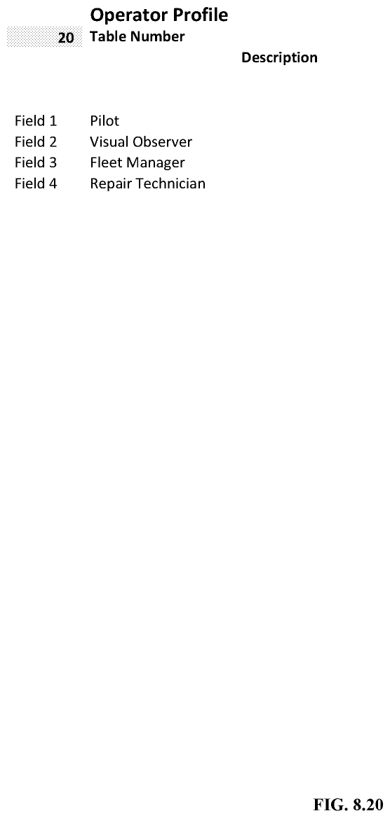

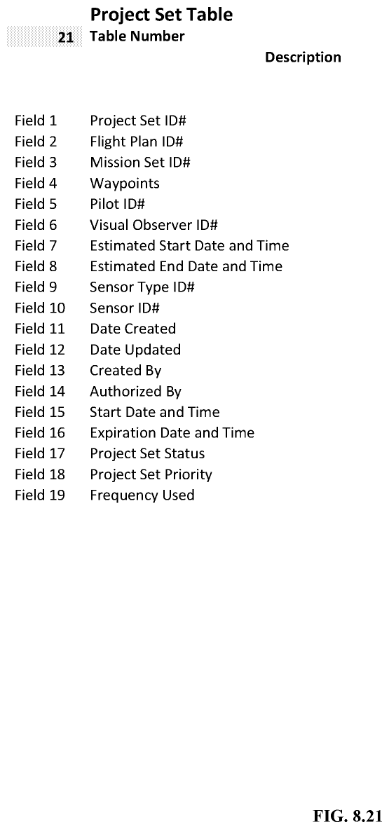

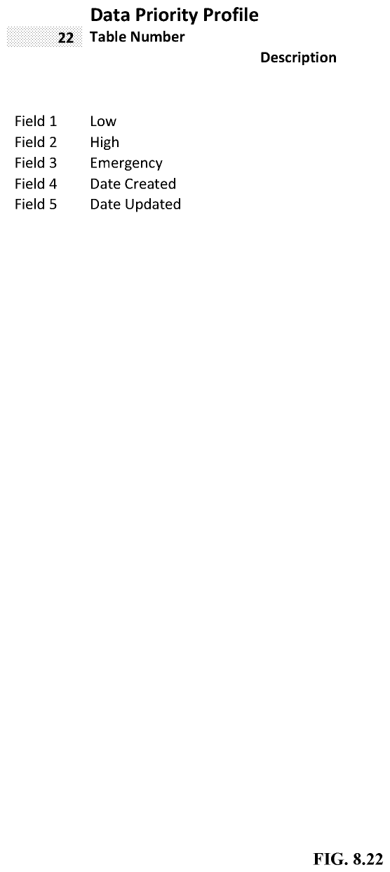

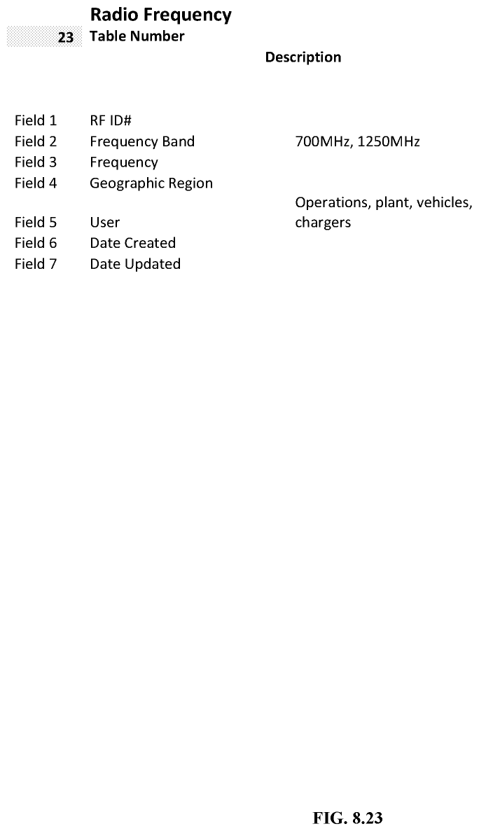

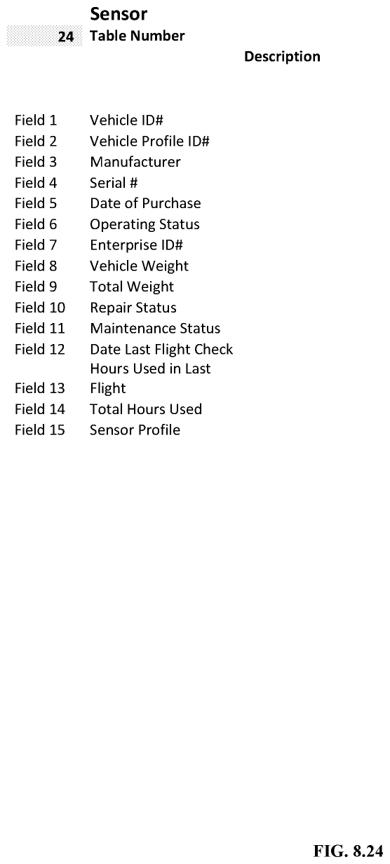

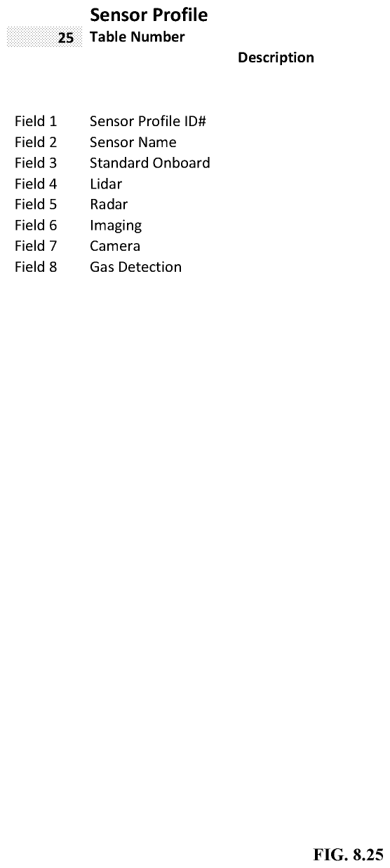

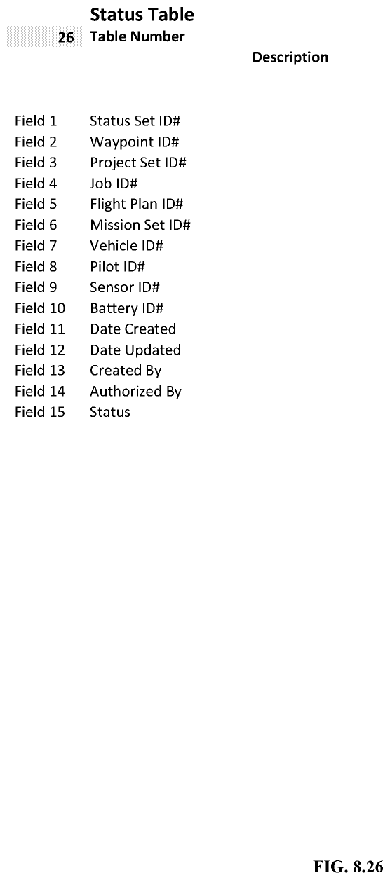

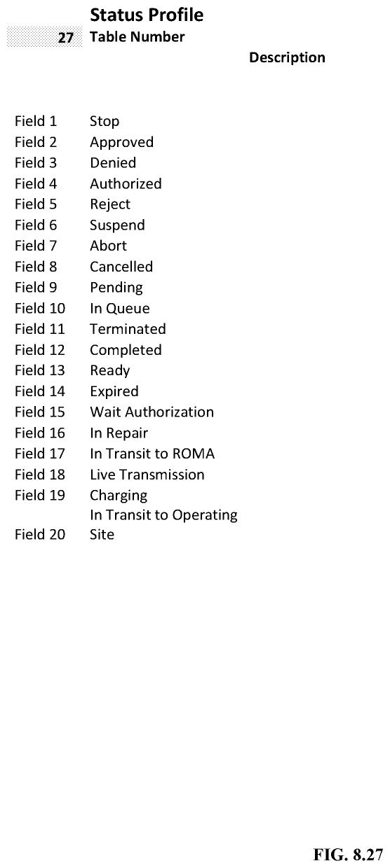

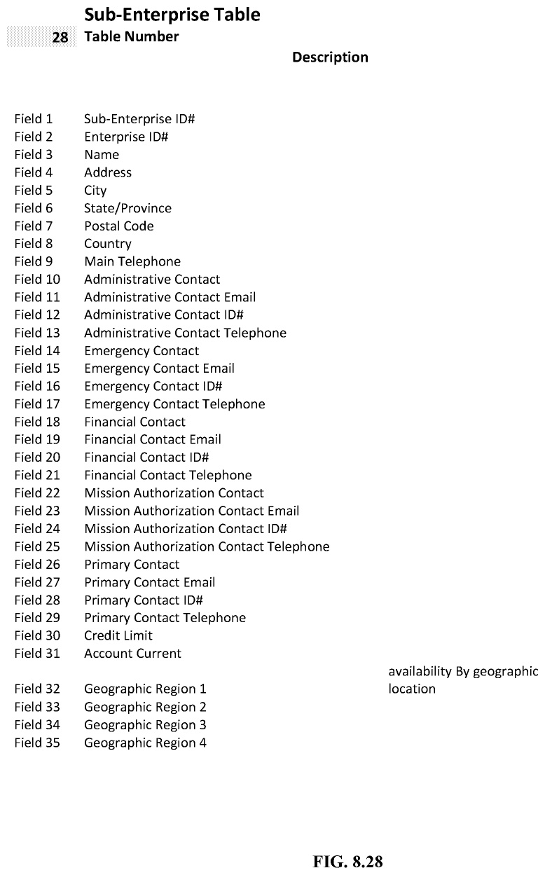

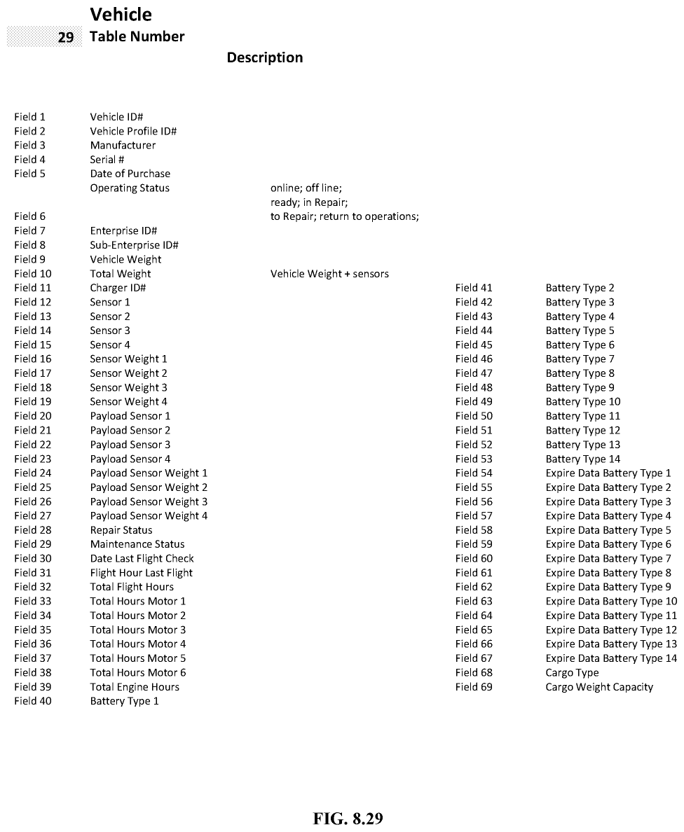

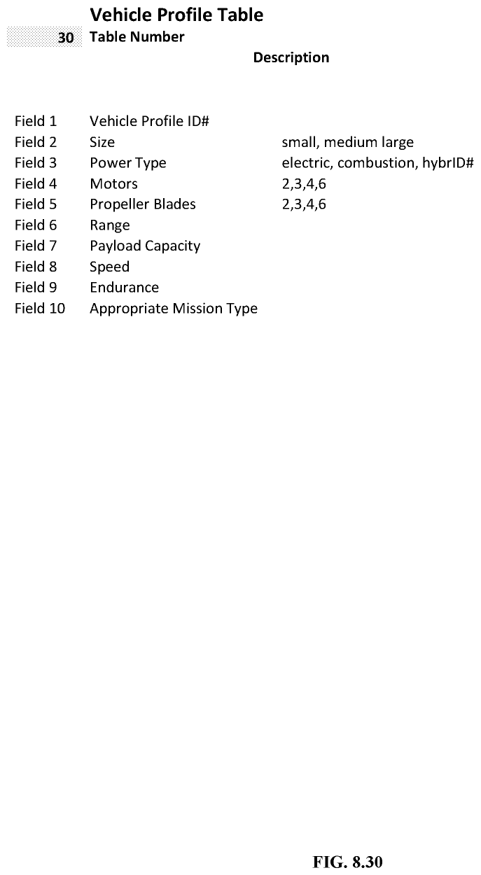

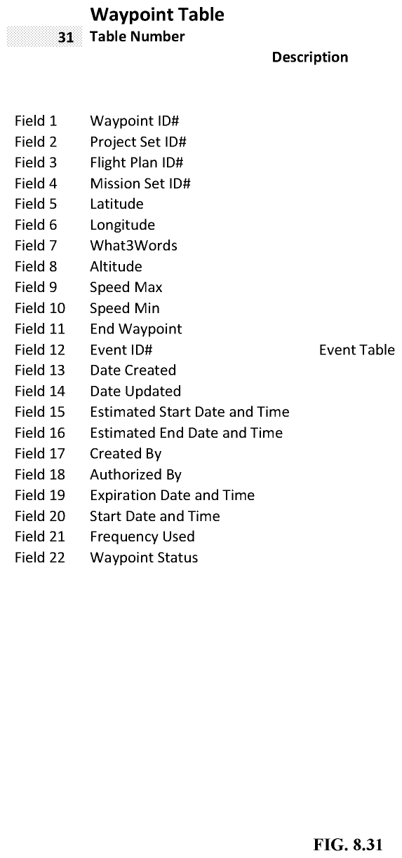

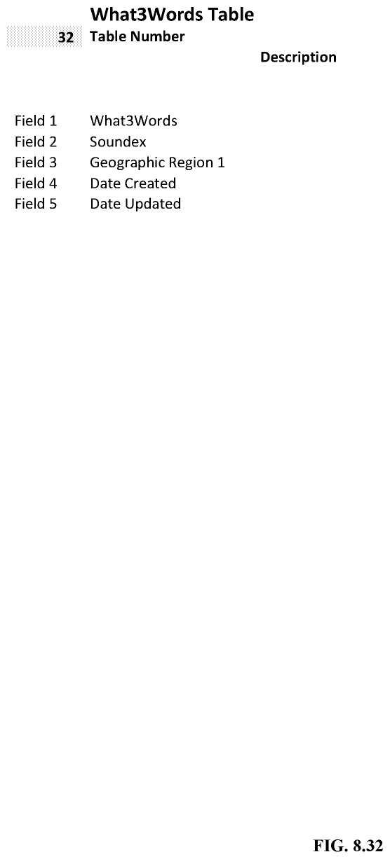

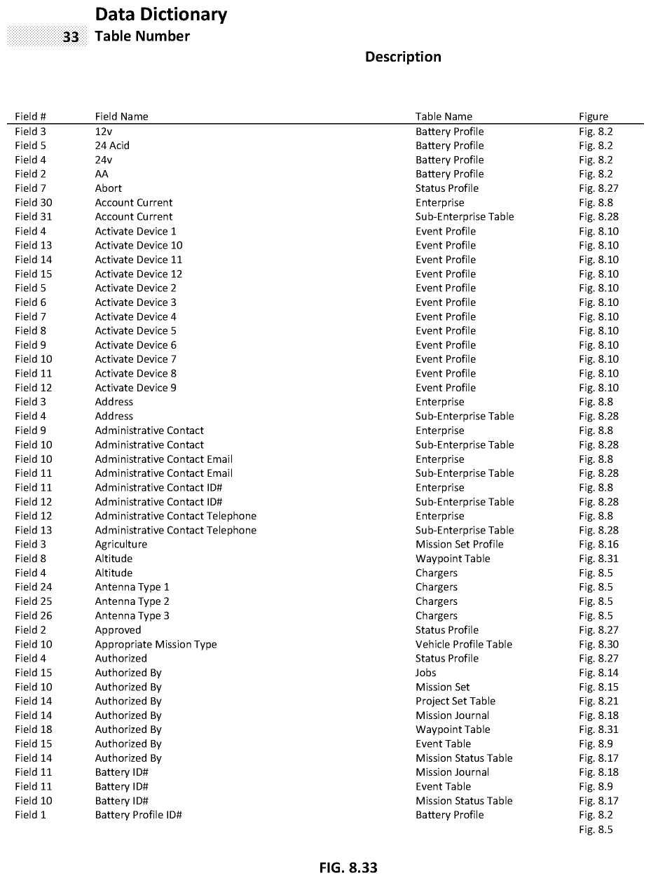

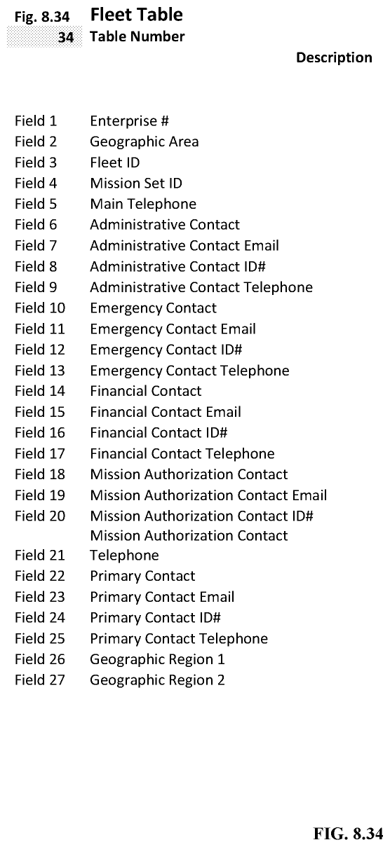

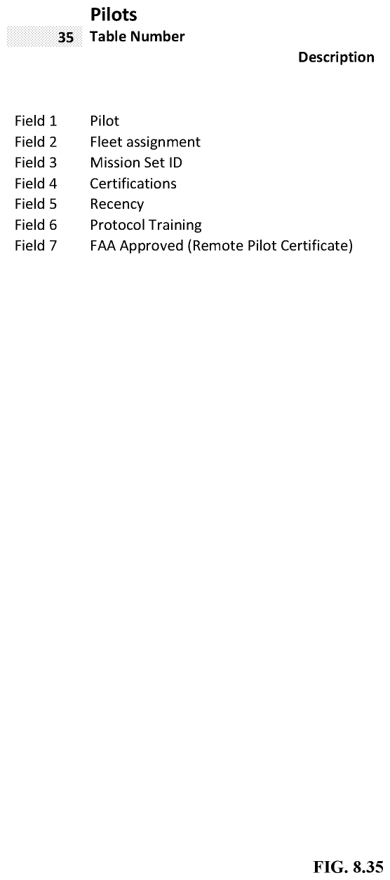

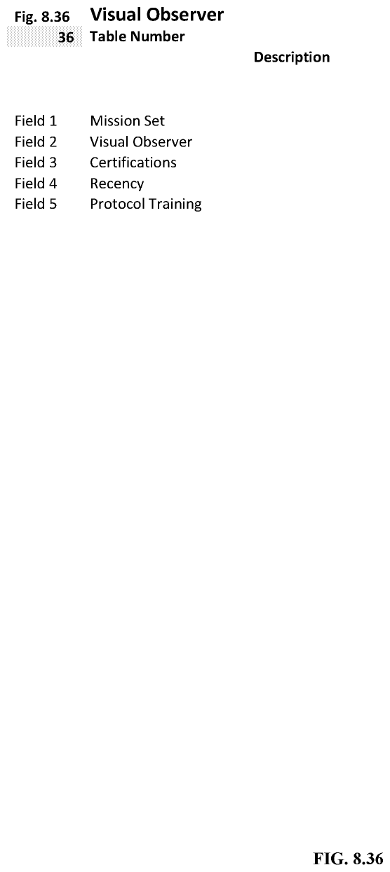

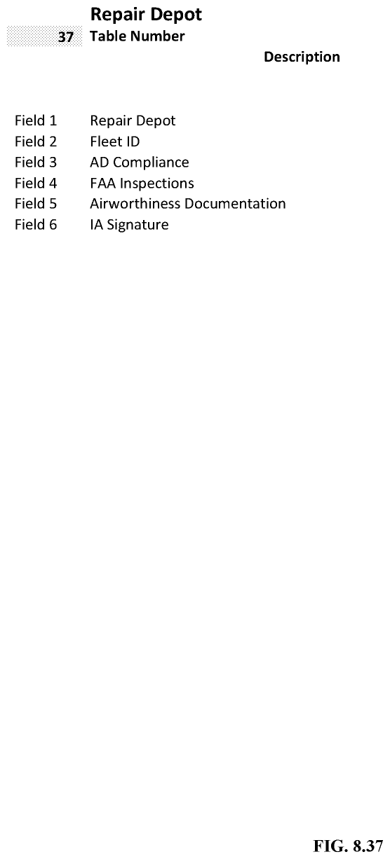

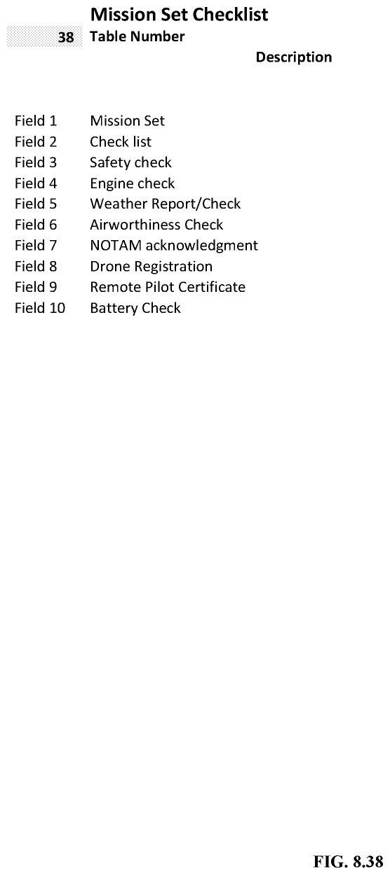

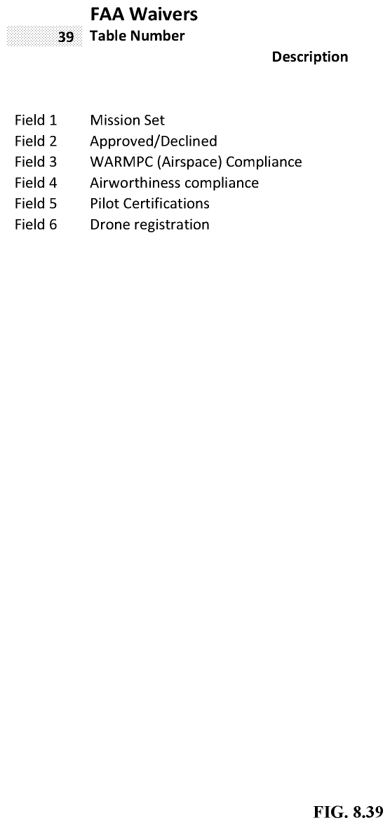

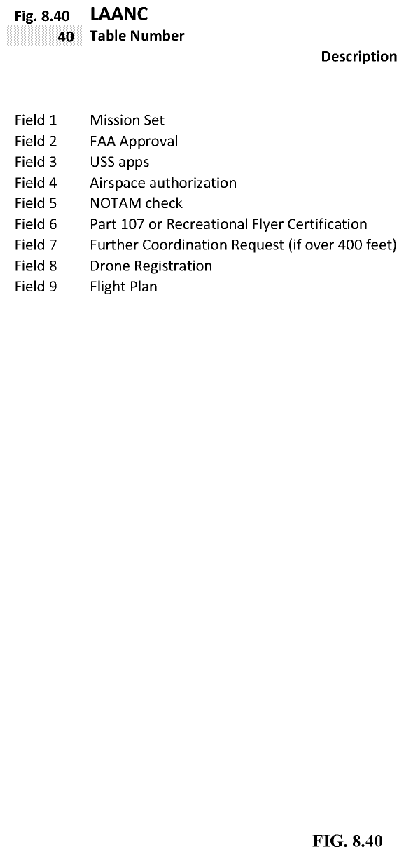

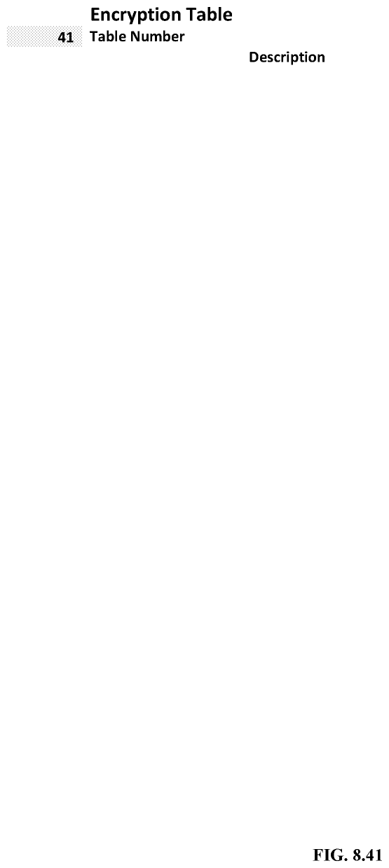

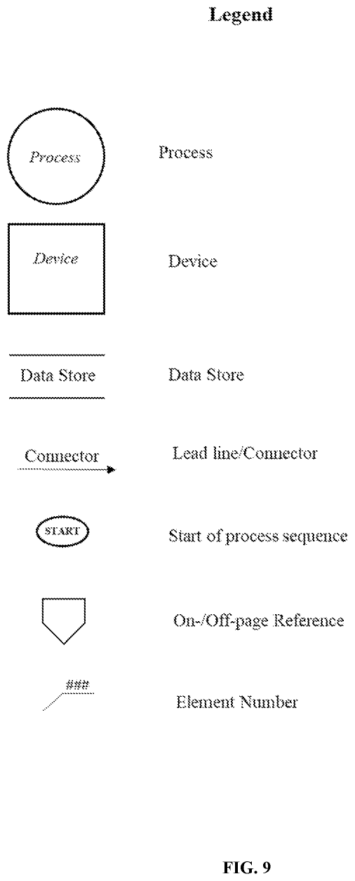

According to the process, Assign Fleet ID to Enterprise, illustrated in (1.1), a Fleet Identification Number (ID) is assigned to an Enterprise from the Fleet Management Control Center. As shown in FIG. 1, the Fleet Management Control Center interacts with an associated Fleet Table Date Store by inputting the Geographic Area ID number, and the Enterprise ID Number, and a Fleet ID Number is provided by the Data Store. The Fleet Management Control Center also interacts with an associated Enterprise Data Store that provides a Fleet ID Number and a Geographic Area Data Store that provides the Geo Area Number. The process Assign Fleet ID to Enterprise (1.1) uses the Snap described in FIG. 7.14, FIG. 7.15, FIG. 7.16, FIG. 7.39, FIG. 7.40, FIG. 7.63, FIG. 7.64, and FIG. 7.66.

According to the process Assign Vehicles to Fleet (1.9), the Fleet Management Control Center assigns vehicles to a Fleet by interacting with an associated Vehicle Data Store. by inputting a Fleet ID Number. The Vehicle Data Store responds with corresponding Vehicle ID Numbers and also returns the Fleet ID Number. The process Assign Vehicles to Fleet (1.9) uses the Snap described in FIG. 7.8, FIG. 7.9, FIG. 7.10, FIG. 7.11, FIG. 7.12, FIG. 7.13, FIG. 7.14, and FIG. 7.15.

According to the process, Assign Pilot to Fleet, (1.15), the Fleet Management Control Center assigns a Pilot to a Fleet. The method, 1.15 interacts with an associated Pilots Data Store, inputting the associated Fleet ID Number and the Pilot ID number is then provided by the Pilots Data Store. The process Assign Pilot to Fleet (1.15) uses the Snap described in FIG. 7.15, FIG. 7.40, FIG. 7.41, FIG. 7.51, and FIG. 7.64.

In the process, Assign VO (Visual Observer) to a Fleet, (1.17) the Fleet Management Control Center assigns a Visual Observer (VO) to a Fleet. The process 1.17 interacts with an associated VO Data Store by inputting the Fleet ID Number and the VO is then provided by the VO Data Store. The process Assign VO to Fleet (1.17) uses the Snap described in FIG. 7.15, FIG. 7.43, FIG. 7.44, FIG. 7.50, and FIG. 7.64.

In the process, Assign Repair & Depot to Fleet (1.23), the Fleet Management Control Center assigns a Repair Depot to a Fleet. The process 1.23 interacts with an associated Repair Depot Data Store by inputting the Fleet ID number and the Repair Depot ID number is then provided by the Repair Depot Data Store. The process Assign Repair & Depot to Fleet (1.23) uses the Snap described in FIG. 7.38, FIG. 7.64, and FIG. 7.65.

In the process, Assign Fleet to Charger (1.25), the Fleet Management Control Center assigns a Fleet to a Charger. In the process (1.25), the Fleet Management Center interacts with an associated Charger Data Store by inputting the Fleet ID Number, and the Charger ID Number is then provided by the Charger Data Store. The process Assign Fleet to Charger (1.25) uses the Snap described in FIG. 7.11, FIG. 7.15, and FIG. 7.64.

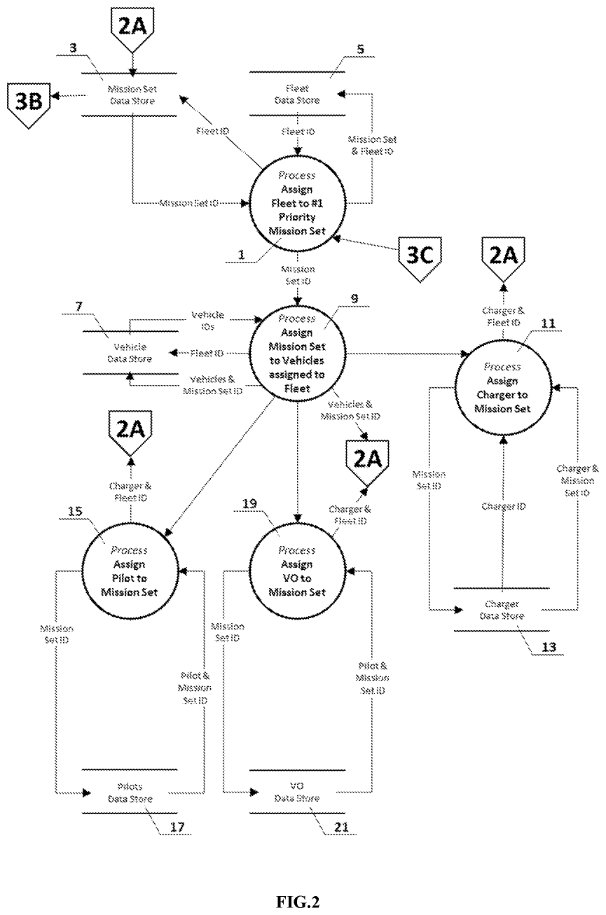

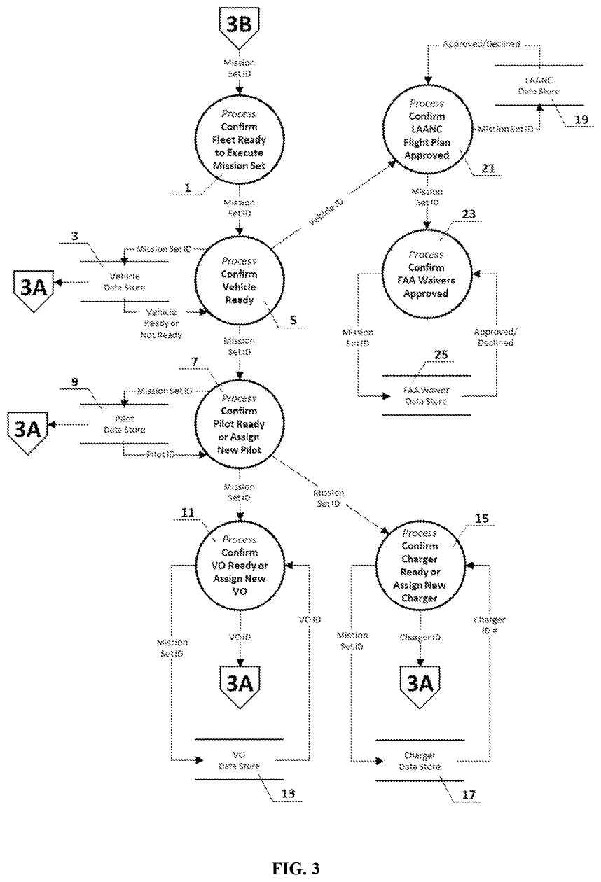

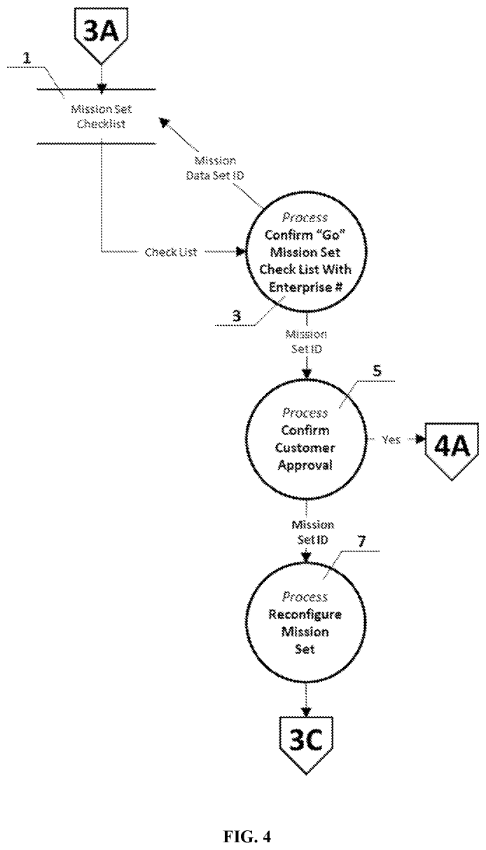

FIG. 2 illustrates an exemplary Fleet Management System to Assign a Fleet to a Mission Set and the related process of the present invention.

According to the process, Assign Fleet to #1 Priority Mission Set, illustrated in (2.1), a fleet is assigned to a #1 Priority Mission Set by the Fleet Management Control Center. According to the process (2.1), a Fleet ID is input to a Mission Set Data Store, which returns a Mission Set ID and the Fleet ID. The process, (2.1) also interacts with an associated Fleet Data Store by inputting the Mission Set and the Fleet ID Number and a Fleet ID Number is then provided by the Fleet Data Store. The process Assign Fleet to #1 Priority Mission Set (2.1) uses the Snap described in FIG. 7.31, FIG. 7.40, FIG. 7.45, FIG. 7.46, FIG. 7.47, and FIG. 7.64.

In the process, Assign Mission Set to Vehicles Assigned to Fleet, (2.9), the Fleet Management Control Center assigns vehicles to a mission set. The process, (2.9), interacts with an associated Vehicle Data Store by inputting the Fleet ID Number; the Vehicles assigned to the Fleet are then provided with the Mission Set ID number by the Data Store. The process Assign Mission Set to Vehicles Assigned to Fleet (2.9) uses the Snap described in FIG. 7.8, FIG. 7.9, FIG. 7.10, FIG. 7.12, FIG. 7.14, FIG. 7.45, and FIG. 7.46. In the process, Assign Charger to Mission Set, (2.11), the Fleet Management Control Center assigns a Charger to a Mission Set. The process, (2.11), interacts with an associated Charger Data Store by inputting the Mission Set ID Number; the Charger ID Number and Mission Set ID Number are then provided by the Charger Data Store. The process Assign Charger to Mission Set (2.11) uses the Snap described in FIG. 7.11, FIG. 7.24, FIG. 7.46, FIG. 7.48, FIG. 7.49, and FIG. 7.64.

In the process, Assign Pilot to Mission Set, (2.15), the Fleet Management Control Center assigns a Pilot to a Mission Set. The process, (2.15), interacts with an associated Pilots Data Store by inputting the Mission Set ID Number; the Pilot is then provided by the Pilot Data Store. The process Assign Pilot to Mission Set (2.15) uses the Snap described in FIG. 7.46, FIG. 7.51, FIG. 7.57, and FIG. 7.64.

In the process, Assign VO to Mission Set, (2.19), the Fleet Management Control Center assigns a VO to a Mission Set. The process, (2.19), interacts with an associated VO Data Store by inputting the VO, then the Mission Set ID Number and the VO are provided by the VO Data Store. The process Assign VO to Mission Set (2.19) uses the Snap described in FIG. 7.46, FIG. 7.50, and FIG. 7.53.

FIG. 3 illustrates an exemplary Fleet Management System process to Confirm a Fleet Ready to Execute and related processes, according to the present invention.

According to the process, Confirm Fleet Ready to Execute Mission Set, as illustrated in (3.1), the Fleet Management Control Center confirms that a Fleet is ready to execute a Mission Set. The process Confirm Fleet Ready to Execute Mission Set (3.1) uses the Snap described in FIG. 7.40, FIG. 7.44, FIG. 7.46, and FIG. 7.56.

The process, Confirm Vehicle Ready, (3.5), requires the Fleet Management Control Center to confirm that a Vehicle is ready to execute the Mission Set. The process, (3.5), interacts with an associated Vehicle Data Store by inputting the Missions Set ID Number and in response a Vehicle Ready or Vehicle Not Ready status is provided by the Vehicle Data Store. The process Confirm Vehicle Ready (3.5) uses the Snap described in FIG. 7.12, FIG. 7.46, and FIG. 7.59.

In the process, Confirm Pilot Ready or Assign New Pilot, (3.7). the fleet Management Control Center confirms Pilot ready or assigns a new Pilot. The process, (3.7), interacts with an associated Pilot Data Store by inputting the Mission Set ID Number, then a Pilot ID is provided by the Data Store. The process Confirm Pilot Ready or Assign New Pilot (3.7) uses the Snap described in FIG. 7.46, FIG. 7.51, and FIG. 7.60.

According to the process, Confirm VO Ready or Assign New VO, (3.11), the Fleet Management Control Center confirms VO Ready or assigns a New VO. The process, (3.11), interacts with an associated VO Data Store by inputting the Mission Set ID Number, and in response a VO is provided by the VO Data Store. The process Confirm VO Ready or Assign New VO (3.11) uses the Snap described in FIG. 7.45, FIG. 7.50, and FIG. 7.61.

In the process, Confirm Charger Ready or Assign New Charger, (3.15), the Fleet Management Control Center confirms Charger Ready or assigns a new Charger. The process, (3.15), interacts with an associated Charger Data Store by inputting the Mission Set ID Number; the Charger ID Number is provided by the Charger Data Store in response. The process Confirm Charger Ready or Assign New Charger (3.15) uses the Snap described in FIG. 7.46, FIG. 7.48, and FIG. 7.49.

The process, Confirm LAANC Flight Plan Approved, (3.21), requires the Fleet Management Control Center to confirm LAANC Flight Plan Approved. The process, (3.21), interacts with an associated LAANC Data Store by inputting the Mission Set ID Number; an Approved or Declined status is then provided by the LAANC Data Store. The process Confirm LAANC Flight Plan Approved (3.21) uses the Snap described in FIG. 7.12, FIG. 7.18, FIG. 7.25, FIG. 7.31, and FIG. 7.46.

The process, Confirm FAA Waivers Approved, (3.23), requires the Fleet Management Control Center to confirm FAA Waivers Approved. The process, (3.23), interacts with an associated FAA Waiver Data Store by inputting the Mission Set ID Number, then an Approved or Declined status is provided by the FAA Waiver Data Store. The process Confirm FAA Waivers Approved (3.23) uses the Snap described in FIG. 7.46, FIG. 7.57, and FIG. 7.59.

FIG. 4 illustrates an exemplary Fleet Management System to Confirm Customer Approval to Execute and the related process to the present invention.

According to the process, Confirm “Go” Mission Set Check List with Enterprise ID number, illustrated in (4.3) the Fleet Management Control Center confirms with the Enterprise the Mission Set Checklist is complete and the Enterprise authorizes the Mission Set to “Go” forward. The process Confirm “Go” Mission Set Check List with Enterprise ID (4.3) uses the Snap described in FIG. 7.46, FIG. 7.62, and FIG. 7.63.

For the process, Confirm Customer Approval, (4.5), the Fleet Management Control Center confirms customer approval for executing the mission by the Enterprise Mission authorization agent and informing the agent that the Mission Set is ready to be executed. The process Confirm Customer Approval (4.5) uses the Snap described in FIG. 7.46 and FIG. 7.63.

In the process, Reconfigure Mission Set, (4.7), the Fleet Management Control Center reconfigures Mission Set if the customer had not previously approved or confirmed the Mission Set. The process Reconfigure Mission Set (4.7) uses the Snap described in FIG. 7.46 and FIG. 7.63.

FIGS. 5A and 5B illustrate an exemplary Fleet Management System to Transmit Radio Signals from the Management Center to a Fleet of Vehicles and the related process according to the present invention.

According to the process, Interface Management Center Data Store with Transmitter, illustrated in (5B.1), the Management Center Data Store is interfaced with the Transmitter. The process, (5B.1), interacts with an associated Mission Set Data Store which provides a Vehicle ID Number, GEO Area ID Number, and Fleet ID Number. The process Interface Management Center Data Store with Transmitter (5B.1) uses the Snap described in FIG. 7.46.

The process, Determine the Frequency in GEO Area to Use, (5B.3) is to determine the frequency in a GEO Area to use. The process, (5B.3), interacts with an associated Geographical Area Data Store by inputting a GEO Area ID Number, and a Radio Frequency is then provided by the Data Store. The process Determine the Frequency in GEO Area to Use (5B.3) uses the Snap described in FIG. 7.66 and FIG. 7.68.

The process, Select 700 MHz or 1250 MHz Transmitter and Antenna, (5B.7) is to select either a 700 MHz or 1250 MHz Transmitter and Antenna. The process Select 700 MHz or 1250 MHz Transmitter and Antenna (5B.7) uses the Snap described in FIG. 7.68 and FIG. 7.69.

The Frequency Selector Switch (5B.17) is used for the process (5B.7) and is responsive to the selection of either 700 MHz or 1250 MHz.

The process, Ping GEO Area, (5B.11) pings a GEO Area. The process, Ping GEO Area (5B.11), uses the Snap described in FIG. 7.66 and FIG. 7.70. The reply to the Ping confirms the validity of the frequency choice.

The process, Format Data for Transmit, (5B.13), formats data for transmission. The process Format Data for Transmit (5B.13) uses the Snap described in FIG. 7.1, FIG. 7.8, FIG. 7.9, FIG. 7.12, FIG. 7.14, FIG. 7.15, FIG. 7.16, FIG. 7.18, FIG. 7.22, FIG. 7.25, FIG. 7.28, FIG. 7.31, FIG. 7.32, FIG. 7.34, FIG. 7.35, FIG. 7.38, FIG. 7.41, FIG. 7.42, FIG. 7.45, FIG. 7.46, FIG. 7.47, FIG. 7.48, FIG. 7.49, FIG. 7.50, FIG. 7.51, FIG. 7.52, FIG. 7.53, FIG. 7.57, FIG. 7.58, FIG. 7.59, FIG. 7.60, FIG. 7.61, FIG. 7.62, FIG. 7.63, FIG. 7.64, FIG. 7.67, FIG. 7.68, and FIG. 7.69.

The process, Convert Digital Data to Analog RF, (5B.15) converts digital data to analog data. The process Convert Digital Data to Analog Data (5B.15) uses the Snap described in FIG. 7.69.

The process, Identify Vehicle in Fleet Mission Set, (5B.35) identifies a Vehicle in a Fleet Mission Set. The process, (5B.35) interacts with an associated Mission Set Data Store that provides the Mission Set ID Number and Vehicle ID Number and links the Vehicle with the Mission Set. The process, Identify Vehicle in Fleet Mission Set (5B.35), uses the Snap described in FIG. 7.46 and FIG. 7.64.

The process, Transmit Message to Vehicle to Perform Full System Test, (5B.37) transmits a message from the Fleet Management Center to the Vehicle to perform a Full System Test. The process Transmit Message to Vehicle to Perform Full System Test (5B.37) uses the Snap described in FIG. 7.12 and FIG. 7.20.

The process, Identify Sensors on Vehicle, (5B.39) identifies Sensors on a Vehicle for use in collecting data according to the Mission Set. The process 5B.39 interacts with an associated Vehicle Data Store by inputting the Vehicle ID Number and Sensor ID Number. The process Identify Sensors on Vehicle (5B.39) uses the Snap described in FIG. 7.1, FIG. 7.12, FIG. 7.28 and FIG. 7.64.

The process, Transmit Message to Sensor to Perform Full Test, (5B.43) transmits a message to a Sensor to perform a Full Test. The process Transmit Message to Sensor to Perform Full Test (5B.43) uses the Snap described in FIG. 7.1 and FIG. 7.22.

The process, Identify Chargers Assigned to Vehicles, (5B.45) to identify Chargers assigned to Vehicles. The process, (5B.45), interacts with an associated Charger Data Store by inputting the Vehicle ID Number, and a Charger ID Number is then provided by the Data Store. The process Identify Chargers Assigned to Vehicles (5B.45) uses the Snap described in FIG. 7.11 and FIG. 7.1.

The process, Transmit Message to Charger to Perform Full Test, (5B.49) transmits a message to a Charger to perform a Full Test. The process Transmit Message to Charger to Perform Full Test (5B.49) uses the Snap described in FIG. 7.49 and FIG. 7.71.

FIG. 5A begins at an off-page connector 4C that extends from device 5B.17 of FIG. 5B. FIG. 5A depicts components at the Fleet Management Center for transmitting signals to one or more Vehicles.

The device (5A.19) is a 700 MHz Modem, which accepts digital data from the Fleet Management Center and converts the digital data into analog signals that will be sent to one or more vehicles.

The device (5A.21) is a 700 MHz Multiplexor TD/FD, which accepts analog signals from the 700 MHz modem, performs Time division and Frequency division/multiplexing, and inputs the analog signals into the 700 MHz Transmitter.

The device (5A.23) is a 700 MHz Transmitter, which accepts analog signals from the Multiplexor TD/FD, and then generates and supplies analog radio signals to the 700 MHz Antenna.

The device (5A.25) is a 700 MHZ Antenna, which accepts analog radio signals from the 700 MHz Transmitter, and then emits the analog radio frequency signals in the 700 MHz band for receiving by the one or more vehicles.

The device (5A.27) is a 1250 MHz Modem, which accepts digital data from the Fleet Management Center and converts the digital data into analog signals that will be transmitted to one or more vehicles.

The device (5A.29) is a 1250 MHz Multiplexor TD/FD, which accepts analog signals from the 1250 MHz modem, performs Time division and Frequency division/multiplexing, and inputs the analog signals into the 1250 MHz Transmitter.

The device (5A.31) is a 1250 MHz Transmitter, which accepts analog signals from the Multiplexor TD/FD, and then generates and supplies analog radio signals to the 1250 MHz Antenna.

The device (5A.33) is a 1250 MHZ Antenna, which accepts analog radio frequency signals from the 1250 MHz Transmitter, and then emits the analog radio signals in the 1250 MHz band for receiving by one or more vehicles.

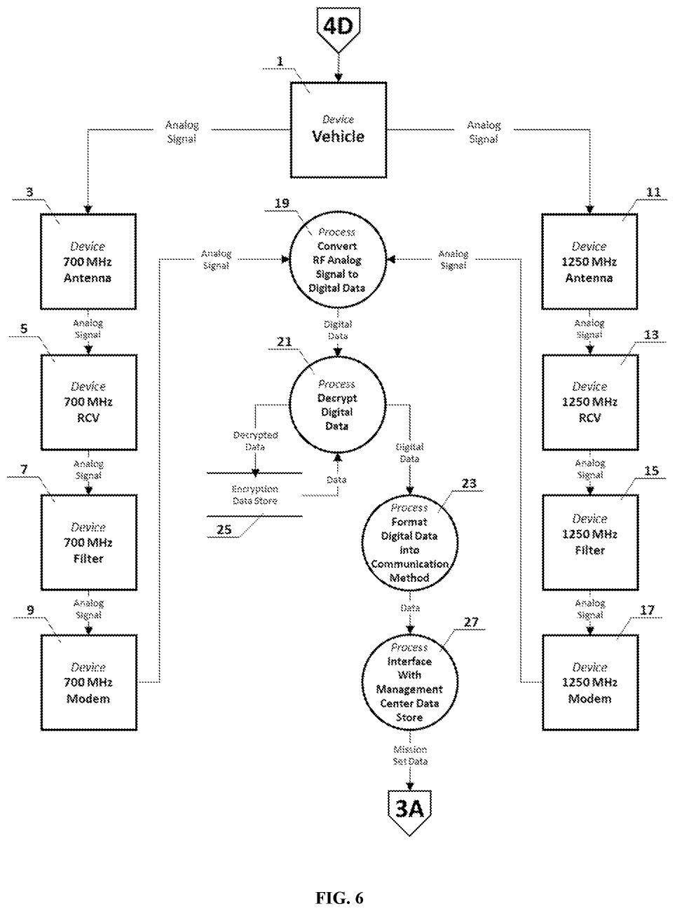

FIGS. 6 illustrates an exemplary Fleet Management System to Receive Radio Signals from vehicles in a Fleet and related process according to the present invention.

The device (6.1) is a Vehicle for transmitting radio frequency signals.

The device (6.3) is a 700 MHz Antenna, which receives the analog radio frequency signals in the 700 MHz band from the Vehicle

The device (6.5) is a 700 MHz RCV (Receiver), which accepts analog radio frequency signals from the 700 MHz Antenna.

The device (6.7) is a 700 MHz Filter, which passes the analog radio frequency signals to the 700 MHz Modem.

The device (6.9) is a 700 MHz Modem, which accepts analog radio frequency signals in the 700 MHz band, filtered by the 700 MHz filter, and down converts from 700 MHz to baseband.

The device (6.11) is a 1250 MHz Antenna, which receives the analog radio frequency signals in the 1250 MHz band from the Vehicle

The device (6.13) is a 1250 MHz RCV (receiver), which accepts analog radio frequency signals from the 1250 MHz Antenna

The device (6.15) is a 1250 MHz Filter, which passes the analog radio frequency signals to the 1250 MHz Modem.

The device (6.17) is a 1250 MHz Modem, which accepts analog radio frequency signals in the 1250 MHz band, filtered by the 1250 MHz filter, and down converts from 1250 MHz to baseband.

According to the process, Convert RF Analog Signal to Digital Data, illustrated in (6.19) the RF Analog Signal is converted to Digital Data for processing within the Fleet Management Center.

The process, Decrypt Digital Data, (6.21) decrypts Digital Data if the data had been encrypted by a data sending device. The process, 6.21, interacts with an associated Decryption Data Store by inputting encrypted data and the decrypted data is then provided by the Data Store.

The process, Format Digital Data into Communication Method, (6.23) formats the Digital Data into a Communication Method.

The process, Interface with Management Center Data Store, (6.27) interfaces with the Management Center Data Store. The process Interface with Management Center Data Store (6.27) uses the Snap described in FIG. 7.1, FIG. 7.8, FIG. 7.9, FIG. 7.10, FIG. 7.12, FIG. 7.16, FIG. 7.21, FIG. 7.22, FIG. 7.27, FIG. 7.28, FIG. 7.29, FIG. 7.37, FIG. 7.39, FIG. 7.40, FIG. 7.42, FIG. 7.44, FIG. 7.46, FIG. 7.47, FIG. 7.50, FIG. 7.51, FIG. 7.57, FIG. 7.58, FIG. 7.62, FIG. 7.63, FIG. 7.64, FIG. 7.65, FIG. 7.66, FIG. 7.68, and FIG. 7.69.

This disclosure is not intended to limit the invention to the described Vehicles, devices, and processes as is more fully described herein. As should be recognized by those skilled in the art, other claims and processes may be integrated and managed using similar methods and are intended to be included under this disclosure. Furthermore, while this invention has been described in conjunction with the exemplary embodiments outlined above, various alternatives, modifications, variations, improvements, and/or substantial equivalents, whether known or that are or may be presently unforeseen, may become apparent to those having at least ordinary skill in the art. Accordingly, the exemplary embodiments of the invention, as set forth above, are intended to be illustrative, not limiting. Various changes may be made without departing from the spirit and scope of the invention. Therefore, the invention is intended to embrace all known or later-developed alternatives, modifications, variations, improvements, and/or substantial equivalents.

What is claimed is:

1. A method for creating and managing a Fleet of unmanned Vehicles, comprising:
assigning unmanned Vehicles to the Fleet;
assigning a Fleet identification number to the Fleet and associating the Fleet identification number to an enterprise and to an enterprise identification number;
assigning a repair depot identification number to the Fleet;
assigning at least one licensed FAA (Federal Aviation Administration) part 107 pilot to the Fleet;
assigning at least one certified FAA Visual Observer to the Fleet; and
assigning the Fleet to at least one power charging station.

2. The method of claim 1, further comprising identifying sensors on the unmanned Vehicles assigned to the unmanned Fleet.

3. The method of claim 2, further comprising transmitting to the sensors instructions for performing a sensor test.

4. The method of claim 1, further comprising identifying the at least one power charging station assigned to the Fleet.

5. The method of claim 1, further comprising transmitting to the at least one power charging station instructions for performing a Charger test.

6. The method of claim 1, further comprising transmitting to the unmanned Vehicles instructions and requirements for performing a system component test.

7. The method of claim 1, further comprising a Fleet Management Center for:
assigning unmanned Vehicles to the Fleet;
assigning the Fleet identification number;
assigning the repair depot identification number;
assigning the at least one licensed FAA part 107 pilot;
assigning the at least one certified FAA Visual Observer; and
assigning the Fleet to at least one power charging station.

8. The method of claim 1, further comprising creating a Mission Set for the Fleet.

9. The method of claim 8, further comprising assigning the Mission Set to the Fleet.

10. The method of claim 8, further comprising identifying the unmanned Vehicles assigned to the Mission Set.

11. The method of claim 8, further comprising reconfiguring the Mission Set.

12. The method of claim 8, wherein after a step of creating the Mission Set for the Fleet, the method further comprising assigning the Fleet to a number one priority Mission Set.

13. The method of claim 8, further comprising assigning a power charging station to the Mission Set.

14. The method of claim 8, further comprising assigning an operator to the Mission Set.

15. The method of claim 8, further comprising assigning a Visual Observer to the Mission Set.

16. The method of claim 8, further comprising:
associating the Mission Set with the Fleet identification number;
confirming each one of the unmanned Vehicles assigned to the Fleet is ready to execute the Mission Set;
confirming a plurality of FAA LAANC flight plans have been approved by the FAA for each unmanned Vehicle assigned to the Fleet;
confirming each unmanned Vehicle assigned to the Fleet is ready to execute the Mission Set;
confirming a plurality of FAA flight plan waivers associated with flight plans for the unmanned Vehicles assigned to the Fleet have been approved by the FAA, thereby permitting the Fleet to execute the Mission Set;
confirming the at least one licensed FAA Part 107 pilot assigned to the Fleet is ready to execute the Mission Set;
confirming the at least one certified FAA Visual Observer assigned to the Fleet is ready to execute the Mission Set; and
confirming the at least one power Charger station assigned to the Fleet is ready to execute the Mission Set.

17. The method of claim 8, further comprising a Fleet Management Center:
confirming each one of the unmanned Vehicles assigned to the Fleet is ready to execute the Mission Set;
confirming a plurality of FAA LAANC flight plans have been approved by the FAA for each unmanned Vehicle assigned to the Fleet;
confirming each unmanned Vehicle assigned to the Fleet is ready to execute the Mission Set;
confirming a plurality of FAA flight plan waivers as related to the Mission Set have been approved by the FAA;
confirming the at least one licensed FAA Part 107 pilot assigned to the Fleet is ready to execute the Mission Set;
confirming the at least one certified FAA Visual Observer assigned to the Fleet is ready to execute the Mission Set;
confirming the at least one Charger assigned to the Fleet is ready to execute the Mission Set.

18. The method of claim 1, further comprising:
confirming the enterprise has approved execution of the Mission Set;
confirming completion of a Mission checklist for the Mission Set; and
confirming the enterprise has approved execution of a reconfigured Mission Set if the reconfigured Mission Set has been assigned to the Fleet.

19. The method of claim 1, further comprising assigning a radio frequency signal transmitting system for carrying communications between the unmanned Vehicles and a Fleet Management Center, the signal transmitting system for converting between digital and analog signals.

20. The method of claim 1, further comprising assigning a radio frequency signal receiving system for carrying communications between the unmanned Vehicles and a Fleet Management Center, the signal receiving system for converting between digital and analog signals.

21. The method of claim 1, wherein communications between two or more unmanned Vehicles or between an unmanned Vehicle and a Fleet Management Center, comprises one or more of a/an:
accessory data Vehicle Snap, autonomous aerial communications coupler Snap, connect/disconnect Vehicle & Charger Snap, start of message Snap, remote connect/disconnect Vehicle & Charger Snap, sensor data Snap, end of message Snap, Vehicle data Snap, Vehicle image data Snap, Vehicle or component id Snap, Vehicle to Charger communications method, Vehicle id to Management Center Snap, mate Vehicle with Fleet Snap, Vehicle authorized in geographic area Snap, cc or frwd msg Snap, mate Vehicle with Vehicle Snap, resend images from Vehicle Snap, flight plan approved Snap, 4d environment communication Snap, Vehicle full system test request Snap, request Vehicle type and frequency data Snap, full system component test results from Vehicle Snap, landing zone identification Snap, Vehicle or Charger communication with electrical connector Snap, LAANC authorization number Snap, submit flight plan request to Management Center Snap, flight time spent in geographic area Snap, data type to be sent from Vehicle Snap, exit geographic area Snap, hand-off Vehicle from Management Center to another Snap, flight plan restrictions Snap, geographic lockout Snap, request Vehicle to resend images Snap, Vehicle grounded by repair depot Snap, Vehicle grounded status removed Snap, return to active service Snap, acknowledgment images received Snap, repair depot assignment Snap, enterprise data Snap, Fleet data communication method, pilot assigned to Fleet Snap, pilot assigned to Vehicle Snap, Visual Observer assigned to Fleet Snap, Visual Observer assigned to Vehicle Snap, Fleet assigned to Mission Set Snap, Mission Set identification Snap, Project Set assigned to Fleet Snap, Charger id assigned to Fleet Snap, Charger id Snap, Visual Observer id Snap, pilot id Snap, pilot assigned to Mission Set Snap, Visual Observer assigned to Mission Set Snap, left blank, left blank, Fleet ready to execute Mission Set Snap, FAA waiver approved data Snap, waiver id Snap, Vehicle ready to execute Mission Set data Snap, pilot ready to execute Mission Set Snap, Visual Observer ready to execute Mission Set Snap, Mission Set checklist data Snap, enterprise id Snap, Fleet id Snap, repair depot id Snap, geographic area id Snap, Vehicle assigned to geographic area Snap, RF frequency used in geographic area Snap, RF frequency used by antenna Snap, geographic area Ping test request Snap, Charger full system test request Snap, and Charger full system test results Snap.

22. The method of claim 1, wherein information related to the unmanned Vehicles or to a Fleet Management Center is stored in a data table, the data table comprising one or more of:
a battery profile, a cargo profile, a certification profile, Chargers, a Charger type table, a data priority profile, an enterprise, an event table, an event profile, an FAA license, a flight plan table, a geographic area, jobs, a Mission Set, a Mission Set profile, a Mission status table, a Mission journal, an operator table, an operator profile, a Project Set table, a Project Set data priority, a radio frequency, sensor, a sensor profile, status, status profile, sub-enterprise table, Vehicle, Vehicle profile table, waypoint table, what3words table, data dictionary, Fleet table, pilots, Visual Observer, repair depot, Mission Set checklist, FAA waivers, LAANC, and encryption table.

23. The method of claim 1, further comprising interfacing a transmitter with a Management Center data store.
